(19) United States
(12) Patent Application Publication
(10) Pub. No.: US 2026/0090653 A1
(43) Pub. Date: Apr. 2, 2026

(54) Climate Control System for a Bed

(71) Applicant: Sleep Number Corporation, Minneapolis, MN (US)

(72) Inventors: Kody Lee Karschnik, Plymouth, MN (US); Daniel VerBockel, St. Louis Park, MN (US); Eric Rose, Piedmont, SC (US); Fletcher Ephraim Carlson-Sanchez, Minneapolis, MN (US)

(21) Appl. No.: 19/347,390

(22) Filed: Oct. 1, 2025

Related U.S. Application Data
(60) Provisional application No. 63/701,671, filed on Oct. 1, 2024.
(60) Provisional application No. 63/840,732, filed on Jul. 9, 2025.

(51) Int. Cl. A47C 21/04; H05B 3/56

(52) U.S. Cl. CPC A47C 21/048; H05B 3/56; H05B 2203/015

(57) ABSTRACT

The present document relates to climate control features for a bed system, such as a bed system that includes multiple independently controlled temperature zones. In some examples, heating and/or cooling is applied to a user on a mattress through one or more of the multiple independently controlled temperature zones.

### INCORPORATION BY REFERENCE

This application claims priority to U.S. Provisional Application Ser. No. 63/840,732, filed Jul. 9, 2025, and U.S. Provisional Application Ser. No. 63/701,671, filed Oct. 1, 2024, the disclosures of which are incorporated by reference in their entireties.

### TECHNICAL FIELD

The present document relates to a bed system that includes temperature controlled zones.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

This document generally relates to climate control features for a bed system, for example, a bed system that includes multiple temperature controlled zones.

Some embodiments described herein include a heating element. The heating element can be configured to be installed in a bed. The heating element includes a resistive wire sealed in a semi-rigid material, where the resistive wire shaped within the semi-rigid material to include multiple parallel segments each attached by a curved segment. The heating element can also include a connector configured to attach the resistive wire to a power source, wherein the resistive wire is configured to generate heat when power from the power source is applied to the resistive wire.

Embodiments described herein can include one or more optional features. For example, the semi-rigid material can include at least one open slot between a first parallel segment of the resistive wire and an adjacent second parallel segment of the resistive wire. The at least one open slot can include two or more open slots and one or more parallel segments of the resistive wire are positioned between each of the two or more open slots. In some examples, the resistive wire forms substantially an accordion shape. The heating element can be flat and flexible. The semi-rigid material can define a rectangular shape. The heating element can include one or more open slots and the heating element is configured to be installed between two layers of foam in a mattress with an adhesive applied to provide a foam to foam bond between the two layers of foam within the one or more open slots. The heating element can include a first open slot and a second open slot, the first open slot being adjacent to the second open slot, wherein two parallel segments of resistive wire are positioned between the first open slot and the second open slot.

In some examples, the heating element also includes a current detector configured to detect a current in the resistive wire. The heating element can be configured to stop applying power to the resistive wire when the current detected in the resistive wire exceeds a shutdown current threshold.

In some examples, the heating element also includes a voltage detector configured to detect a voltage across at least a portion of the resistive wire. The heating element can be configured to stop applying power to the resistive wire when the voltage detected across the at least the portion the resistive wire exceeds a shutdown voltage threshold.

In some examples, the heating element also includes a temperature sensor. The power to the heating element can be controlled to stop applying power to the resistive wire when a temperature detected at the temperature sensor exceeds a shutdown temperature threshold. In some examples, the power to the heating element can be controlled to maintain a desired temperature at the temperature sensor.

Some embodiments described herein include a heating element configured to be installed in a bed. The heating element can include a conductive heating element and a connector configured to attach conductive heating element to a power source, wherein the conductive heating element is configured to generate heat when power from the power source is applied to the conductive heating element.

Some embodiments described herein include a bed comprising an accordion-shaped resistive heating element.

Some embodiments described herein include a mattress cover. The mattress cover can include a fabric and a plurality of heating wires embedded in the fabric of the mattress cover. Each heating wire of the plurality of heating wires can be configured to be individually activated by applying power to the heating wire to generate heat.

Embodiments described herein can include one or more optional features. For example, the plurality of heating wires can be ultrasonically welded to the mattress cover. In some examples, any combination of the plurality of heating wires can be activated at a given time.

Some embodiments described herein include a mattress cover. The mattress cover can include a fabric and a plurality of heating wires embedded in the fabric of the mattress cover.

Embodiments described herein can include one or more optional features. For example, a heating element can be configured to be installed in a bed. The heating element can include a fabric and a plurality of heating wires embedded in the fabric. Each heating wire of the plurality of heating wires can be configured to be individually activated by applying power to the heating wire to generate heat. The heating element can be configured to be attached to a top surface of a comfort layer of a mattress. The heating element can be configured to be attached to a mattress cover. the heating element can be configured to be embedded in a mattress cover. The plurality of heating wires can be configured to provide two or more individually controllable temperature zones. The heating element can be configured to positioned below a comfort layer of a mattress.

Some embodiments described herein include a system. The system can include a mattress. The mattress can include a first side for a first sleeper user. In some examples, the first side includes two or more first side heating elements. The mattress can also include a second side for a second sleeper user. In some examples, the second side includes two or more second side heating elements. The system can also include a climate controller configured to individually control the two or more first side heating elements and the two or more second side heating elements. The two or more first side heating elements and the two or more second side heating elements can be positioned under a comfort layer in the mattress. The two or more first side heating elements and the two or more second side heating elements can be attached to the comfort layer. The two or more first side heating elements and the two or more second side heating elements can be integrated within a cover of the mattress. The cover can enclose multiple foam layers of the mattress and the two or more first side heating elements and the two or more second side heating elements. The climate controller can limit heating of the two or more first side heating elements and the two or more second side heating elements to 106 degrees Celsius. The climate controller can be configured to individually target one or more of the two or more first side heating elements to provide a therapeutic treatment to the first sleeper user on the first side of the mattress. The climate controller can be configured to individually target one or more of the two or more second side heating elements to provide a therapeutic treatment to the second sleeper user. The therapeutic treatment can include heating and cooling a region of the mattress. The system can include an adjustable base and wherein the therapeutic treatment includes making at least one adjustment to the adjustable base. Each of the two or more first side heating elements and the two or more second side heating elements are conductive heat units. The conductive heat unit can include a resistive wire embedded in a semi-rigid material that maintains a shape of the resistive wire. The conductive heat unit includes one or more open slots. The conductive heat unit is positioned between two layers of foam in the mattress and an adhesive is applied to provide a foam to foam bond within the one or more open slots. The two or more first side heating elements and the two or more second side heating elements are controllable from a mobile device application. The two or more first side heating elements and the two or more second side heating elements are controllable from one or more remote controllers.

Some embodiments described herein include a mattress having first and second zones. The mattress can include a first layer comprising a first cushioning material in a first zone and a first heater in a second zone and a second layer comprising a second heater in the first zone and a second cushioning material in the second zone, wherein the second layer is positioned below the first layer.

Embodiments described herein can include one or more optional features. For example, the mattress can define a first sleep area sized to support a first user, wherein the first and second zones are both positioned in the first sleep area. The mattress can define a first sleep area sized to support a first user and a second sleep area sized to support a second user, wherein the first and second zones are both positioned in the first sleep area and not in the second sleep area. The first heater can be positioned vertically higher than the second heater and offset from the second heater such that the first heater is not directly above the second heater.

Some embodiments described herein include a mattress having first and second zones. The mattress can include a foam tub including a first comfort layer and one or more perimeter rails attached to a bottom of the first comfort layer. A second comfort layer can be removably positioned above a top of the first comfort layer. A first heater can be in the first zone between the first comfort layer and the second comfort layer. A second heater can be in the second zone between the first comfort layer and the second comfort layer.

Embodiments described herein can optionally include a mattress cover enclosing the foam tub, the second comfort layer, and the first and second heaters.

Some embodiments described herein include a mattress having first and second zones. The mattress can include a foam tub comprising a first comfort layer and one or more perimeter rails attached to a bottom of the first comfort layer. A second comfort layer can be removably positioned below the bottom of the first comfort layer and inside of the perimeter rails. A first heater can be positioned in the first zone between the first comfort layer and the second comfort layer. A second heater can be positioned in the second zone between the first comfort layer and the second comfort layer.

Some embodiments described herein include a system comprising a bed having a mattress and a climate controller. The mattress can include a first side for a first sleeper user, the first side including two or more first side temperature modulating elements, and a second side for a second sleeper user, the second side including two or more second side temperature modulating elements. The climate controller can be configured to individually control the two or more first side temperature modulating elements and the two or more second side temperature modulating elements.

Embodiments described herein can include one or more optional features. For example, the two or more first side temperature modulating elements and the two or more second side temperature modulating elements can include at least one conductive heating element and at least one forced air unit. The at least one forced air unit can be configured to cool at least a portion of a sleep surface of the mattress. The at least one forced air unit can include a heater to heat air the at least one forced air unit distributes to a sleep surface of the mattress.

Some embodiments described herein include a system comprising a mattress. The mattress can include two or more heating elements and a climate controller configured to individually control the two or more heating elements. The two or more heating elements can be configured to be inserted and removed from the mattress to customize arrangement of the two or more heating elements.

Some embodiments described herein include a mattress. The mattress can include one or more layers, a cover encapsulating the one or more layers and one or more resistive heating elements attached to the cover and configured to generate heat.

Embodiments described herein can include one or more optional features. For example, the mattress can include a fan to draw air from a top surface of the mattress. The mattress can include a fan to push air to a top surface of the mattress. The mattress can include means for providing conditioned air to a top surface of the mattress. One or more air chambers can be used to adjust a firmness of the mattress. Perimeter rails can be included and at least one of the one or more layers is attached to the perimeter rails. A top layer of the one or more layers can be able to be separated from at least one other layer of the one or more layers that are attached to the perimeter rails. A top layer of the one or more layers can be attached to the perimeter rails and at least one other layer of the one or more layers can be able to be separated from the top layer. The mattress can include means for cooling a top surface of the mattress.

Some embodiments described herein include a mattress. The mattress can include one or more layers including a comfort layer and one or more resistive heating elements attached to a top surface of the comfort layer.

Embodiments described herein can include one or more optional features. For example, the mattress can include a fan to draw air from a top surface of the mattress. The mattress can include a fan to push air to a top surface of the mattress. The mattress can include means for providing conditioned air to a top surface of the mattress. The comfort layer can be able to be separated from at least one other layer of the one or more layers. One or more air chambers can be used to adjust a firmness of the mattress. At least one of the one or more layers can be attached to the perimeter rails. A top layer of the one or more layers can be able to be separated from at least one other layer of the one or more layers that are attached to the perimeter rails. Atop layer of the one or more layers can be attached to the perimeter rails and at least one other layer of the one or more layers is able to be separated from the top layer. The mattress further includes means for cooling a top surface of the mattress.

Some embodiments described herein include a mattress. The mattress can include one or more layers including a comfort layer and one or more resistive heating elements embedded within the comfort layer.

Embodiments described herein can include one or more optional features. For example, the mattress can include a fan to draw air from a top surface of the mattress. The mattress can include a fan to push air to a top surface of the mattress. The mattress can include means for providing conditioned air to a top surface of the mattress. The comfort layer can be able to be separated from at least one other layer of the one or more layers. One or more air chambers can be used to adjust a firmness of the mattress. At least one of the one or more layers is attached to the perimeter rails. A top layer of the one or more layers is able to be separated from at least one other layer of the one or more layers that are attached to the perimeter rails. A top layer of the one or more layers can be attached to the perimeter rails and at least one other layer of the one or more layers is able to be separated from the top layer. The mattress further includes means for cooling a top surface of the mattress.

Some embodiments described herein include a mattress. The mattress can include one or more layers, a cover encapsulating the one or more layers, and one or more resistive heating elements within a fan assembly used to generate forced conduction of heat to a sleeper surface of the mattress.

Embodiments described herein can include one or more optional features. For example, the fan assembly is contained within the mattress. The fan assembly is contained within perimeter rails of the mattress. The fan assembly is contained within at least one of the one or more layers. The fan assembly is attached to a base of the mattress. The fan assembly is configured to be positioned separate from the mattress. The mattress further comprises resistive heating elements. The one or more layers include a comfort layer and the resistive heating elements are positioned on a surface of a comfort layer. The one or more layers include a comfort layer and the resistive heating elements are positioned underneath the comfort layer. The fan assembly is configured to provide airflow through the resistive heating elements to provide forced convective heating and conductive heating to the sleeper surface. The one or more layers include a thermal airflow layer. The thermal airflow layer uses high CFM materials that allow for warm air to pass from the fan assembly to the sleeper surface. The mattress further includes means for cooling a top surface of the mattress. The mattress includes a fan to draw air from a top surface of the mattress. The mattress includes a fan to push air to a top surface of the mattress. The mattress includes means for providing conditioned air to a top surface of the mattress.

Some embodiments described herein include a method of operating a bed. The method can include providing therapeutic heating to a user's shoulders and/or back and cooling a microclimate of the user that includes the user's shoulders and back by drawing air at a location proximate the user's hips and/or thighs.

Embodiments described herein can include one or more optional features. For example, the microclimate can be cooled at the same time as providing therapeutic heating. The therapeutic heating can be provided by resistive heaters and the cooling is provided by a cooling system with a pad connected to a fan. Therapeutic heating can be provided to the user's shoulders and the user's lower back simultaneously. The method can include selecting between locations of the user's back to heat. The method can include selecting only the user's lower back to heat. The method can include selecting only a location at the user's shoulders to heat. The method can include cooling the microclimate by flowing air from a location outside of a blanket, across shoulders of the user, across a torso of the user, across hips of the user, and through a cooling pad in the mattress. The air can be uncooled ambient air.

Some embodiments described herein include a bed comprising a sleep surface configured to support a user, a heating system, and a cooling system. The heating system can be positioned at locations configured to align with the user's shoulders and/or back. The cooling system can include a pad positioned at locations configured to align with the user's hips and/or thighs and a fan connected to the pad and configured to draw air. One or more controllers can be configured to operate the heating system to heat the user's shoulders and/or back while simultaneously operating the cooling system to cool a microclimate configured to align with the user's shoulders, back, hips, and thighs.

Embodiments described herein can include one or more optional features. For example, the heating system can include a first heater positioned at a first location configured to align with the user's shoulders and a second heater positioned at a second location configured to align with the user's lower back. The heating system can be configured to operate the first and second heaters independently. There can be no cooling system positioned under the heating system. The heating system can include resistive wire. The sleep surface can include a mattress, wherein the heating system is positioned in the mattress, and wherein the cooling system is positioned in the mattress. The cooling system can be placed only at a location configured to align with the user's hips/and/or thighs. The heating system and the cooling system can be positioned on a first side of the mattress and the bed can further include a second heating system positioned at second locations configured to align with a second user's shoulders and/or back and a second cooling system. The second cooling system can include a second pad positioned at second locations configured to align with the second user's hips and/or thighs and a second fan connected to the second pad and configured to draw air, wherein the one or more controllers is configured to operate the second heating system to heat the second user's shoulders and/or back while simultaneously operating the second cooling system to cool a microclimate of the second user. The pad of the cooling system can include a thermal insert having a breathable layer and an impermeable layer.

Some embodiments described herein include a bed system configured to provide therapeutic heating at a first area via a heater positioned at the first area and to simultaneously cool both the first area and a second area via a cooler positioned away from the first area. The heater can include means for heating and the cooler can include means for cooling.

Some embodiments described herein include a bed comprising a sleep surface configured to support a user, a heating system with therapeutic heaters positioned at first and second locations of the sleep surface, and a cooling system. The cooling system includes a pad positioned at a third location of the sleep surface different than the first and second locations and a fan connected to the pad and configured to draw air. One or more controllers can be configured to operate the heating system to heat the first and/or second locations while simultaneously operating the cooling system to cool a microclimate that includes the first, second, and third locations via the pad positioned only at the third location.

Embodiments described herein can include one or more optional features. For example, the therapeutic heaters can include first and second conductive heating elements configured to be placed at locations on the sleep surface configured to align with shoulder and spine portions of the user. The therapeutic heaters can include a conductive heating element configured to be placed at a location on the sleep surface configured to align with feet the user. The third location can be configured to align with hips or thigh of the user.

Some embodiments described herein include a bed configured to therapeutically heat one or more locations of a user while simultaneously cooling portions of the user. This can include cooling the one or more locations of the user that are therapeutically heated and doing so via a cooling system positioned at another location of the user that is away from the one or more locations of the user that are therapeutically heated. For example, the bed can heat a back of the user and cool via a cooler positioned away from the back of the user, such as at the hips or thighs of the user.

Embodiments described herein can include a mattress having a mattress core, a foam-laminated flame resistant (FR) cap enclosing the mattress core, and a mattress cover enclosing the foam-laminated FR cap. In some examples, the foam-laminated FR cap can include an FR cap and a comfort layer of foam laminated to a bottom surface of the FR cap. In some examples, the mattress can further include a heater attached to a top of the mattress and enclosed under the foam-laminated FR cap. In some examples, the mattress can further include a heater attached to a bottom of the foam-laminated FR cap. In some examples, the foam-laminated FR cap can be attached to a top of the mattress core.

The devices, system, and techniques described herein may provide one or more of the following advantages. Multiple zones can be heated and/or cooled independently, alternatively, and/or simultaneously. A bed can provide heating to one or more body parts of a user for therapeutic effect while simultaneously cooling a microclimate of the user for comfort. A heating element can have a shape and structure to suitably heat while improving durability and/or comfort for a user.

The details of one or more implementations are set forth in the accompanying drawings and the description below. Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 shows an example environment including a bed in communication with devices located in and around a home.

FIGS. 4A and 4B are block diagrams of example data processing systems that can be associated with a bed.

FIGS. 5 and 6 are block diagrams of examples of motherboards that can be used in a data processing system associated with a bed.

FIG. 7 is a block diagram of an example of a daughterboard that can be used in a data processing system associated with a bed.

FIG. 8 is a block diagram of an example of a motherboard with no daughterboard that can be used in a data processing system associated with a bed.

FIG. 9A is a block diagram of an example of a sensory array that can be used in a data processing system associated with a bed.

FIG. 9B is a schematic top view of a bed having an example of a sensor strip with one or more sensors that can be used in a data processing system associated with the bed.

FIG. 9C is a schematic diagram of an example bed with force sensors located at the bottom of legs of the bed.

FIG. 10 is a block diagram of an example of a control array that can be used in a data processing system associated with a bed.

FIG. 11 is a block diagram of an example of a computing device that can be used in a data processing system associated with a bed.

FIGS. 12-16 are block diagrams of example cloud services that can be used in a data processing system associated with a bed.

FIG. 17 is a block diagram of an example of using a data processing system that can be associated with a bed to automate peripherals around the bed.

FIG. 18 is a schematic diagram that shows an example of a computing device and a mobile computing device.

FIG. 19 illustrates an example bed with multiple temperature zones.

FIG. 20 illustrates a cross section view of an example bed with multiple temperature zones.

FIG. 21 illustrates an example heating element.

FIG. 22 illustrates an example bed with multiple heating elements.

FIG. 23 illustrates the example of the bed shown in FIG. 22 assembled.

FIG. 24 illustrates an example bed with multiple heating elements.

FIG. 25 illustrates an example bed with multiple heating elements.

FIG. 26 illustrates the example of the bed shown in FIG. 25 assembled.

FIG. 27 illustrates a cross section view of an example bed with multiple temperature zones.

FIG. 28 illustrates an example bed with multiple heating elements.

FIG. 29 illustrates an example bed with a heating device configured to activate individual heating elements at different regions of a sleep surface.

FIG. 30A illustrates an example thermal insert.

FIG. 30B illustrates a cross section view of the example thermal insert shown in FIG. 30A.

FIG. 31A illustrates an example fan sub-assembly.

FIG. 31B illustrates a cross section view of the example fan sub-assembly shown in FIG. 31A.

FIG. 32 illustrates airflow through the fan sub-assembly of FIGS. 31A-B.

FIG. 33 illustrates a cross section view of an example bed with multiple temperature zones.

FIG. 34 illustrates the fan sub-assembly mounted to a mattress.

FIG. 35 illustrates an adhesive applied to a foam layer of a mattress to form pockets to receive multiple heating elements.

FIG. 36 illustrates a heating element installed in a foam layer of a mattress.

FIG. 37 illustrates heating elements installed in between a first foam sub-layer and a second foam sub-layer.

FIG. 38 illustrates a heating element with a hook and loop connector to attach to a first foam layer.

FIG. 39 illustrates a heating element with a hook and loop connector to attach to a first foam layer.

FIG. 40A illustrates a heating element attached to a first foam sub-layer using an adhesive.

FIG. 40B illustrates a heating element attached between a first foam sub-layer and a second foam sub-layer.

FIG. 41 illustrates an example bed with multiple heating elements each assembled in individual heater sub-assemblies.

FIG. 42 illustrates the example of the bed shown in FIG. 41 assembled.

FIG. 43A illustrates an example individual heater sub-assembly.

FIG. 43B illustrates the example individual heater sub-assembly of FIG. 43A.

FIG. 44A illustrates a top side of an example heating element.

FIG. 44B illustrates a bottom side of the example heating element of FIG. 44A.

FIG. 45 illustrates an example bed with multiple heating elements.

FIG. 46A illustrates an example heating element embedded within an example mattress cover.

FIG. 46B illustrates the example mattress cover of FIG. 46A.

FIG. 47 illustrates an example bed with a heating element configured to provide multiple independently controlled temperature zones.

FIG. 48 illustrates an example bed with a heating element providing multiple independently controlled temperature zones.

FIG. 49 illustrates an example bed with multiple temperature zones.

FIGS. 50A-50B and 51A-51B show thermal imaging testing of the mattress of FIG. 49.

FIG. 52 illustrates an example bed with a first heating element and a second heating element.

FIG. 53 illustrates an example bed with a number of heating elements.

Like reference symbols in the various drawings indicate like elements.

### DETAILED DESCRIPTION

The present document relates to climate control features for a bed system, such as a bed system that includes multiple independently controllable temperature zones. In some examples, heating and/or cooling is applied to a user on a mattress at the one or more of the multiple independently controlled temperature zones. In some implementations, a bed includes one or more accordion-shaped resistive heating elements. In some implementations, a mattress cover includes heating wires embedded in the fabric of the mattress cover. In some implementations, the heating wires are attached to an underside of a mattress cover. In some implementations, heating elements are attached to a top surface of a comfort layer of the mattress. In some implementations, first and second heaters are positioned in a mattress in different zones (horizontally) and/or at different levels in the zones (vertically). In some implementations, a mattress has an upside-down foam tub with a heater positioned between a top layer of the foam tub and a second comfort layer positioned above or below the top layer of the foam tub. In some implementations, two or more heating elements are configured to be inserted and removed from a mattress to customize arrangement of the two or more heating elements. In some implementations, a foam-laminated flame resistant (FR) cap can be used to enclose a core and heating elements of a mattress. In other embodiments, a bed can have a variety of multi-zoned climate control configurations as described further below.

### Example Airbed Hardware

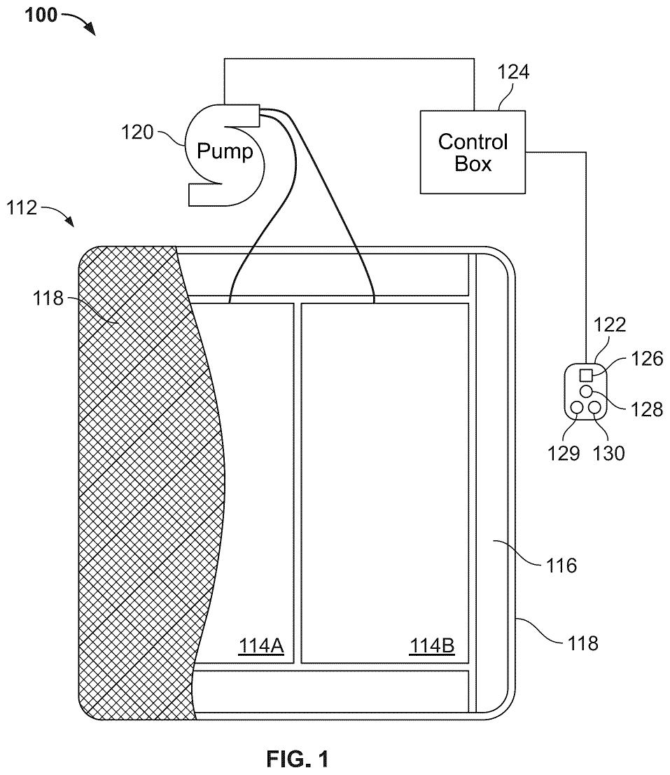

FIG. 1 shows an example air bed system 100 that includes a bed 112. The bed 112 can be a mattress that includes at least one air chamber 114 surrounded by a resilient border 116 and encapsulated by bed ticking 118. The resilient border 116 can comprise any suitable material, such as foam. In some embodiments, the resilient border 116 can combine with a top layer or layers of foam (not shown in FIG. 1) to form an upside down foam tub. In other embodiments, mattress structure can be varied as suitable for the application.

As illustrated in FIG. 1, the bed 112 can be a two chamber design having first and second fluid chambers, such as a first air chamber 114A and a second air chamber 114B. Sometimes, the bed 112 can include chambers for use with fluids other than air that are suitable for the application. For example, the fluids can include liquid. In some embodiments, such as single beds or kids' beds, the bed 112 can include a single air chamber 114A or 114B or multiple air chambers 114A and 114B. Although not depicted, sometimes, the bed 112 can include additional air chambers.

The first and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120. Moreover, sometimes, the pump 120 can be in wireless communication (e.g., via a home network, WiFi, Bluetooth, or other wireless network) with a mobile device via the control box 124. The mobile device can include but is not limited to the user's smartphone, cell phone, laptop, tablet, computer, wearable device, home automation device, or other computing device. A mobile application can be presented at the mobile device and provide functionality for the user to control the bed 112 and view information about the bed 112. The user can input commands in the mobile application presented at the mobile device. The inputted commands can be transmitted to the control box 124, which can operate the pump 120 based upon the commands.

The remote control 122 can include a display 126, an output selecting mechanism 128, a pressure increase button 129, and a pressure decrease button 130. The remote control 122 can include one or more additional output selecting mechanisms and/or buttons. The display 126 can present information to the user about settings of the bed 112. For example, the display 126 can present pressure settings of both the first and second air chambers 114A and 114B or one of the first and second air chambers 114A and 114B. Sometimes, the display 126 can be a touch screen, and can receive input from the user indicating one or more commands to control pressure in the first and second air chambers 114A and 114B and/or other settings of the bed 112.

The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can be a physical control (e.g., switch or button) or an input control presented on the display 126. Alternatively, separate remote control units can be provided for each air chamber 114A and 114B and can each include the ability to control multiple air chambers. Pressure increase and decrease buttons 129 and 130 can allow the user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application.

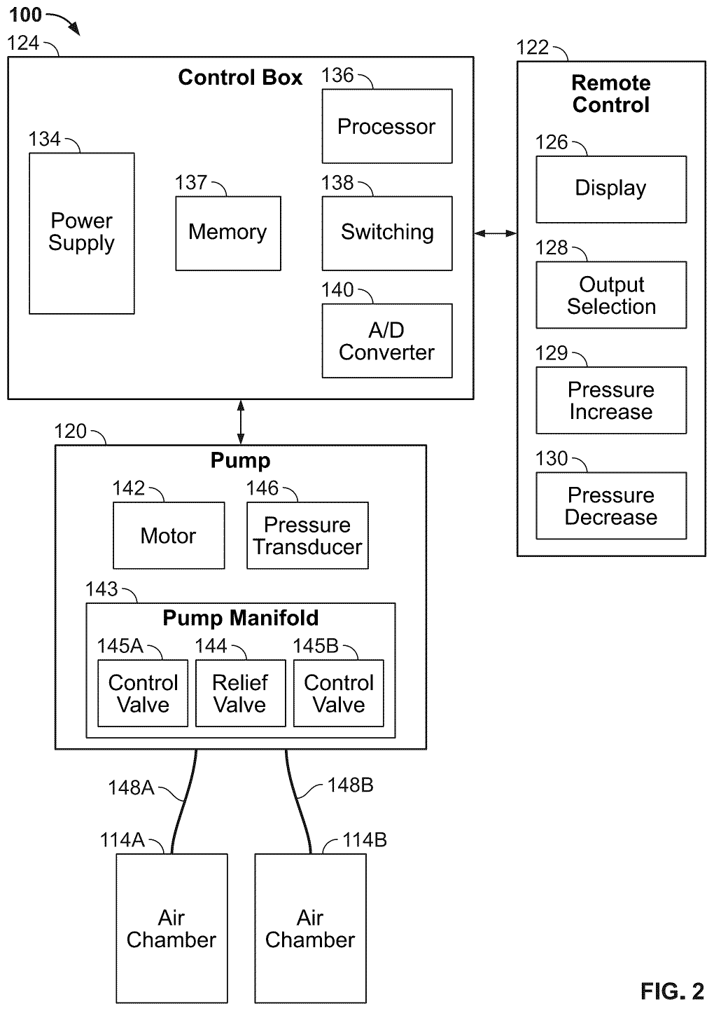

FIG. 2 is a block diagram of an example of various components of an air bed system. These components can be used in the example air bed system 100. The control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124. The pump 120 and the remote control 122 can be in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some implementations, the pump 120 and the control box 124 can be provided as physically separate units. The control box 124, the pump 120, or both can be integrated within or otherwise contained within a bed frame, foundation, or bed support structure that supports the bed 112. Sometimes, the control box 124, the pump 120, or both can be located outside of a bed frame, foundation, or bed support structure (as shown in the example in FIG. 1).

The air bed system 100 in FIG. 2 includes the two air chambers 114A and 114B and the single pump 120 of the bed 112 depicted in FIG. 1. However, other implementations can include an air bed system having two or more air chambers and one or more pumps incorporated into the air bed system to control the air chambers. For example, a separate pump can be associated with each air chamber. As another example, a pump can be associated with multiple chambers. A first pump can be associated with air chambers that extend longitudinally from a left side to a midpoint of the air bed system 100 and a second pump can be associated with air chambers that extend longitudinally from a right side to the midpoint of the air bed system 100. Separate pumps can allow each air chamber to be inflated or deflated independently and/or simultaneously. Additional pressure transducers can also be incorporated into the air bed system 100 such that a separate pressure transducer can be associated with each air chamber.

As an illustrative example, in use, the processor 136 can send a decrease pressure command to one of air chambers 114A or 114B, and the switching mechanism 138 can convert the low voltage command signals sent by the processor 136 to higher operating voltages sufficient to operate the relief valve 144 of the pump 120 and open the respective control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information usable by the processor 136. The processor 136 can send the digital signal to the remote control 122 to update the display 126 to convey the pressure information to the user. The processor 136 can also send the digital signal to other devices in wired or wireless communication with the air bed system, including but not limited to mobile devices described herein. The user can then view pressure information associated with the air bed system at their device instead of at, or in addition to, the remote control 122.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B to increase the chamber firmness, the pressure transducer 146 can sense pressure within the pump manifold 143. The pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126.

Generally speaking, during an inflation or deflation process, the pressure sensed within the pump manifold 143 can provide an approximation of the actual pressure within the respective air chamber that is in fluid communication with the pump manifold 143. An example method includes turning off the pump 120, allowing the pressure within the air chamber 114A or 114B and the pump manifold 143 to equalize, then sensing the pressure within the pump manifold 143 with the pressure transducer 146. Providing a sufficient amount of time to allow the pressures within the pump manifold 143 and chamber 114A or 114B to equalize can result in pressure readings that are accurate approximations of actual pressure within air chamber 114A or 114B. In some implementations, the pressure of the air chambers 114A and/or 114B can be continuously monitored using multiple pressure sensors (not shown). The pressure sensors can be positioned within the air chambers. The pressure sensors can also be fluidly connected to the air chambers, such as along the air tubes 148A and 148B.

In some implementations, information collected by the pressure transducer 146 can be analyzed to determine various states of a user laying on the bed 112. For example, the processor 136 can use information collected by the pressure transducer 146 to determine a heart rate or a respiration rate for the user. As an illustrative example, the user can be laying on a side of the bed 112 that includes the chamber 114A. The pressure transducer 146 can monitor fluctuations in pressure of the chamber 114A, and this information can be used to determine the user's heart rate and/or respiration rate. As another example, additional processing can be performed using the collected data to determine a sleep state of the user (e.g., awake, light sleep, deep sleep). For example, the processor 136 can determine when the user falls asleep and, while asleep, the various sleep states (e.g., sleep stages) of the user. Based on the determined heart rate, respiration rate, and/or sleep states of the user, the processor 136 can determine information about the user's sleep quality. The processor 136 can, for example, determine how well the user slept during a particular sleep cycle. The processor 136 can also determine user sleep cycle trends. Accordingly, the processor 136 can generate recommendations to improve the user's sleep quality and overall sleep cycle. Information that is determined about the user's sleep cycle (e.g., heart rate, respiration rate, sleep states, sleep quality, recommendations to improve sleep quality, etc.) can be transmitted to the user's mobile device and presented in a mobile application, as described above.

Additional information associated with the user of the air bed system 100 that can be determined using information collected by the pressure transducer 146 includes user motion, presence on a surface of the bed 112, weight, heart arrhythmia, snoring, partner snore, and apnea. One or more other health conditions of the user can also be determined based on the information collected by the pressure transducer 146. Taking user presence detection for example, the pressure transducer 146 can be used to detect the user's presence on the bed 112, e.g., via a gross pressure change determination and/or via one or more of a respiration rate signal, heart rate signal, and/or other biometric signals. Detection of the user's presence can be beneficial to determine, by the processor 136, adjustment(s) to make to settings of the bed 112 (e.g., adjusting a firmness when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present. As another example, the processor 136 can determine that the user is present if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed thereon.

In some implementations, pressure fluctuations can be measured at the pump 120. For example, one or more pressure sensors can be located within one or more internal cavities of the pump 120 to detect pressure fluctuations within the pump 120. The fluctuations detected at the pump 120 can indicate pressure fluctuations in the chambers 114A and/or 114B. One or more sensors located at the pump 120 can be in fluid communication with the chambers 114A and/or 114B, and the sensors can be operative to determine pressure within the chambers 114A and/or 114B. The control box 124 can be configured to determine at least one vital sign (e.g., heart rate, respiratory rate) based on the pressure within the chamber 114A or the chamber 114B.

The control box 124 can also analyze a pressure signal detected by one or more pressure sensors to determine a heart rate, respiration rate, and/or other vital signs of the user lying or sitting on the chamber 114A and/or 114B. More specifically, when a user lies on the bed 112 and is positioned over the chamber 114A, each of the user's heart beats, breaths, and other movements (e.g., hand, arm, leg, foot, or other gross body movements) can create a force on the bed 112 that is transmitted to the chamber 114A. As a result of this force input, a wave can propagate through the chamber 114A and into the pump 120. A pressure sensor located at the pump 120 can detect the wave, and thus the pressure signal outputted by the sensor can indicate a heart rate, respiratory rate, or other information regarding the user.

With regard to sleep state, the air bed system 100 can determine the user's sleep state by using various biometric signals such as heart rate, respiration, and/or movement of the user. While the user is sleeping, the processor 136 can receive one or more of the user's biometric signals (e.g., heart rate, respiration, motion, etc.) and can determine the user's present sleep state based on the received biometric signals. In some implementations, signals indicating fluctuations in pressure in one or both of the chambers 114A and 114B can be amplified and/or filtered to allow for more precise detection of heart rate and respiratory rate.

Sometimes, the processor 136 can receive additional biometric signals of the user from one or more other sensors or sensor arrays positioned on or otherwise integrated into the air bed system 100. For example, one or more sensors can be attached or removably attached to a top surface of the air bed system 100 and configured to detect signals such as heart rate, respiration rate, and/or motion. The processor 136 can combine biometric signals received from pressure sensors located at the pump 120, the pressure transducer 146, and/or the sensors positioned throughout the air bed system 100 to generate accurate and more precise information about the user and their sleep quality.

Sometimes, the control box 124 can perform a pattern recognition algorithm or other calculation based on the amplified and filtered pressure signal(s) to determine the user's heart rate and/or respiratory rate. For example, the algorithm or calculation can be based on assumptions that a heart rate portion of the signal has a frequency in a range of 0.5-4.0 Hz and that a respiration rate portion of the signal has a frequency in a range of less than 1 Hz. Sometimes, the control box 124 can use one or more machine learning models to determine the user's health information. The models can be trained using training data that includes training pressure signals and expected heart rates and/or respiratory rates. Sometimes, the control box 124 can determine user health information by using a lookup table that corresponds to sensed pressure signals.

The control box 124 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. The pressure signals generated by the pressure transducer 146 and received by the processor 136 can be filtered and indicated as corresponding to motion, heartbeat, or respiration. The processor 136 can attribute such fluctuations in air pressure to the user's sleep quality. Such attributions can be determined based on applying one or more machine learning models and/or algorithms to the pressure signals. For example, if the user shifts and turns a lot during a sleep cycle (for example, in comparison to historic trends of the user's sleep cycles), the processor 136 can determine that the user experienced poor sleep during that particular sleep cycle.

In some implementations, rather than performing the data analysis in the control box 124 with the processor 136, a digital signal processor (DSP) can be provided to analyze the data collected by the pressure transducer 146. Alternatively, the collected data can be sent to a cloud-based computing system for remote analysis.

In some implementations, the example air bed system 100 further includes a temperature controller configured to increase, decrease, or maintain a temperature of the bed 112, for example for the comfort of the user. For example, a pad (e.g., mat, layer, etc.) can be placed on top of or be part of the bed 112, or can be placed on top of or be part of one or both of the chambers 114A and 114B. Air can be pushed through the pad and vented to cool off the user on the bed 112. Additionally or alternatively, the pad can include a heating element used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or activate the heating element. In some implementations, separate pads are used for different sides of the bed 112 (e.g., corresponding to the locations of the chambers 114A and 114B) to provide for differing temperature control for the different sides of the bed 112. Each pad can be selectively controlled by the temperature controller to provide cooling or heating preferred by each user on the different sides of the bed 112. For example, a first user on a left side of the bed 112 can prefer to have their side of the bed 112 cooled during the night while a second user on a right side of the bed 112 can prefer to have their side of the bed 112 warmed during the night.

In some implementations, the user of the air bed system 100 can use an input device, such as the remote control 122 or a mobile device as described above, to input a desired temperature for a surface of the bed 112 (or for a portion of the surface of the bed 112, for example at a foot region, a lumbar or waist region, a shoulder region, and/or a head region of the bed 112). The desired temperature can be encapsulated in a command data structure that includes the desired temperature and also identifies the temperature controller as the desired component to be controlled. The command data structure can then be transmitted via Bluetooth or another suitable communication protocol (e.g., WiFi, a local network, etc.) to the processor 136. In various examples, the command data structure is encrypted before being transmitted. The temperature controller can then configure its elements to increase or decrease the temperature of the pad depending on the temperature input provided at the remote control 122 by the user.

In some implementations, data can be transmitted from a component back to the processor 136 or to one or more display devices, such as the display 126 of the remote controller 122. For example, the current temperature as determined by a sensor element of a temperature controller, the pressure of the bed, the current position of the foundation or other information can be transmitted to control box 124. The control box 124 can transmit this information to the remote control 122 to be displayed to the user (e.g., on the display 126). As described above, the control box 124 can also transmit the received information to a mobile device to be displayed in a mobile application or other graphical user interface (GUI) to the user.

In some implementations, the example air bed system 100 further includes an adjustable foundation and an articulation controller configured to adjust the position of the bed 112 by adjusting the adjustable foundation supporting the bed. For example, the articulation controller can adjust the bed 112 from a flat position to a position in which a head portion of a mattress of the bed is inclined upward (e.g., to facilitate a user sitting up in bed and/or watching television). The bed 112 can also include multiple separately articulable sections. As an illustrative example, the bed 112 can include one or more of a head portion, a lumbar/waist portion, a leg portion, and/or a foot portion, all of which can be separately articulable. As another example, portions of the bed 112 corresponding to the locations of the chambers 114A and 114B can be articulated independently from each other, to allow one user positioned on the bed 112 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 112 can include more than one zone that can be independently adjusted.

Sometimes, the bed 112 can be adjusted to one or more user-defined positions based on user input and/or user preferences. For example, the bed 112 can automatically adjust, by the articulation controller, to one or more user-defined settings. As another example, the user can control the articulation controller to adjust the bed 112 to one or more user-defined positions. Sometimes, the bed 112 can be adjusted to one or more positions that may provide the user with improved or otherwise improve sleep and sleep quality. For example, a head portion on one side of the bed 112 can be automatically articulated, by the articulation controller, when one or more sensors of the air bed system 100 detect that a user sleeping on that side of the bed 112 is snoring. As a result, the user's snoring can be mitigated so that the snoring does not wake up another user sleeping in the bed 112.

In some implementations, the bed 112 can be adjusted using one or more devices in communication with the articulation controller or instead of the articulation controller. For example, the user can change positions of one or more portions of the bed 112 using the remote control 122 described above. The user can also adjust the bed 112 using a mobile application or other graphical user interface presented at a mobile computing device of the user.

The articulation controller can also provide different levels of massage to one or more portions of the bed 112 for one or more users. The user(s) can adjust one or more massage settings for the portions of the bed 112 using the remote control 122 and/or a mobile device in communication with the air bed system 100.

### Example of a Bed in a Bedroom Environment

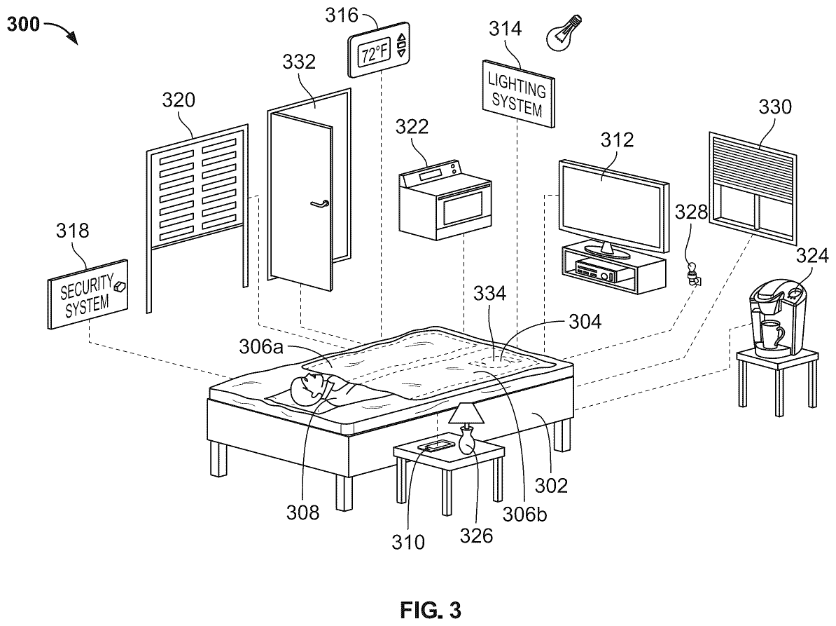

FIG. 3 shows an example environment 300 including a bed 302 in communication with devices located in and around a home. In the example shown, the bed 302 includes pump 304 for controlling air pressure within two air chambers 306a and 306b (as described above). The pump 304 additionally includes circuitry 334 for controlling inflation and deflation functionality performed by the pump 304. The circuitry 334 is programmed to detect fluctuations in air pressure of the air chambers 306a-b and use the detected fluctuations to identify bed presence of a user 308, the user's sleep state, movement, and biometric signals (e.g., heart rate, respiration rate). The detected fluctuations can also be used to detect when the user 308 is snoring and whether the user 308 has sleep apnea or other health conditions. The detected fluctuations can also be used to determine an overall sleep quality of the user 308.

In the example shown, the pump 304 is located within a support structure of the bed 302 and the control circuitry 334 for controlling the pump 304 is integrated with the pump 304. In some implementations, the control circuitry 334 is physically separate from the pump 304 and is in wireless or wired communication with the pump 304. In some implementations, the pump 304 and/or control circuitry 334 are located outside of the bed 302. In some implementations, various control functions can be performed by systems located in different physical locations. For example, circuitry for controlling actions of the pump 304 can be located within a pump casing of the pump 304 while control circuitry 334 for performing other functions associated with the bed 302 can be located in another portion of the bed 302, or external to the bed 302. The control circuitry 334 located within the pump 304 can also communicate with control circuitry 334 at a remote location through a LAN or WAN (e.g., the internet). The control circuitry 334 can also be included in the control box 124 of FIGS. 1 and 2.

In some implementations, one or more devices other than, or in addition to, the pump 304 and control circuitry 334 can be utilized to identify user bed presence, sleep state, movement, biometric signals, and other information (e.g., sleep quality, health related) about the user 308. For example, the bed 302 can include a second pump, with each pump connected to a respective one of the air chambers 306a-b. For example, the pump 304 can be in fluid communication with the air chamber 306b to control inflation and deflation of the air chamber 306b as well as detect user signals for a user located over the air chamber 306b. The second pump can be in fluid communication with the air chamber 306a and used to control inflation and deflation of the air chamber 306a as well as detect user signals for a user located over the air chamber 306a.

As another example, the bed 302 can include one or more pressure sensitive pads or surface portions operable to detect movement, including user presence, motion, respiration, and heart rate. A first pressure sensitive pad can be incorporated into a surface of the bed 302 over a left portion of the bed 302, where a first user would normally be located during sleep, and a second pressure sensitive pad can be incorporated into the surface of the bed 302 over a right portion of the bed 302, where a second user would normally be located. The movement detected by the pressure sensitive pad(s) or surface portion(s) can be used by control circuitry 334 to identify user sleep state, bed presence, or biometric signals for each user. The pressure sensitive pads can also be removable rather than incorporated into the surface of the bed 302.

The bed 302 can also include one or more temperature sensors and/or array of sensors operable to detect temperatures in microclimates of the bed 302. Detected temperatures in different microclimates of the bed 302 can be used by the control circuitry 334 to determine one or more modifications to the user 308's sleep environment. For example, a temperature sensor located near a core region of the bed 302 where the user 308 rests can detect high temperature values. Such high temperature values can indicate that the user 308 is warm. To lower the user's body temperature in this microclimate, the control circuitry 334 can determine that a cooling element of the bed 302 can be activated. As another example, the control circuitry 334 can determine that a cooling unit in the home can be automatically activated to cool an ambient temperature in the environment 300.

The control circuitry 334 can also process a combination of signals sensed by different sensors that are integrated into, positioned on, or otherwise in communication with the bed 112. For example, pressure and temperature signals can be processed by the control circuitry 334 to more accurately determine one or more health conditions of the user 308 and/or sleep quality of the user 308. Acoustic signals detected by one or more microphones or other audio sensors can also be used in combination with pressure or motion sensors in order to determine when the user 308 snores, whether the user 308 has sleep apnea, and/or overall sleep quality of the user 308. Combinations of one or more other sensed signals are also possible for the control circuitry 334 to more accurately determine one or more health and/or sleep conditions of the user 308.

Accordingly, information detected by one or more sensors or other components of the bed 112 (e.g., motion information) can be processed by the control circuitry 334 and provided to one or more user devices, such as a user device 310 for presentation to the user 308 or to other users. The information can be presented in a mobile application or other graphical user interface at the user device 310. The user 308 can view different information that is processed and/or determined by the control circuitry 334 and based the signals that are detected by components of the bed 302. For example, the user 308 can view their overall sleep quality for a particular sleep cycle (e.g., the previous night), historic trends of their sleep quality, and health information. The user 308 can also adjust one or more settings of the bed 302 (e.g., increase or decrease pressure in one or more regions of the bed 302, incline or decline different regions of the bed 302, turn on or off massage features of the bed 302, etc.) using the mobile application that is presented at the user device 310.

In the example depicted in FIG. 3, the user device 310 is a mobile phone; however, the user device 310 can also be any one of a tablet, personal computer, laptop, a smartphone, a smart television (e.g., a television 312), a home automation device, or other user device capable of wired or wireless communication with the control circuitry 334, one or more other components of the bed 302, and/or one or more devices in the environment 300. The user device 310 can be in communication with the control circuitry 334 of the bed 302 through a network or through direct point-to-point communication. For example, the control circuitry 334 can be connected to a LAN (e.g., through a WiFi router) and communicate with the user device 310 through the LAN. As another example, the control circuitry 334 and the user device 310 can both connect to the Internet and communicate through the Internet. For example, the control circuitry 334 can connect to the Internet through a WiFi router and the user device 310 can connect to the Internet through communication with a cellular communication system. As another example, the control circuitry 334 can communicate directly with the user device 310 through a wireless communication protocol, such as Bluetooth. As yet another example, the control circuitry 334 can communicate with the user device 310 through a wireless communication protocol, such as ZigBee, Z-Wave, infrared, or another wireless communication protocol suitable for the application. As another example, the control circuitry 334 can communicate with the user device 310 through a wired connection such as, for example, a USB connector, serial/RS232, or another wired connection suitable for the application.

As mentioned above, the user device 310 can display a variety of information and statistics related to sleep, or user 308's interaction with the bed 302. For example, a user interface displayed by the user device 310 can present information including amount of sleep for the user 308 over a period of time (e.g., a single evening, a week, a month, etc.), amount of deep sleep, ratio of deep sleep to restless sleep, time lapse between the user 308 getting into bed and falling asleep, total amount of time spent in the bed 302 for a given period of time, heart rate over a period of time, respiration rate over a period of time, or other information related to user interaction with the bed 302 by the user 308 or one or more other users. In some implementations, information for multiple users can be presented on the user device 310, for example information for a first user positioned over the air chamber 306a can be presented along with information for a second user positioned over the air chamber 306b. In some implementations, the information presented on the user device 310 can vary according to the age of the user 308 so that the information presented evolves with the age of the user 308.

The user device 310 can also be used as an interface for the control circuitry 334 of the bed 302 to allow the user 308 to enter information and/or adjust one or more settings of the bed 302. The information entered by the user 308 can be used by the control circuitry 334 to provide better information to the user 308 or to various control signals for controlling functions of the bed 302 or other devices. For example, the user 308 can enter information such as weight, height, and age of the user 308. The control circuitry 334 can use this information to provide the user 308 with a comparison of the user 308's tracked sleep information to sleep information of other people having similar weights, heights, and/or ages as the user 308. The control circuitry can also use this information to accurately determine overall sleep quality and/or health of the user 308 based on information detected by components (e.g., sensors) of the bed 302.

The user 308 may also use the user device 310 as an interface for controlling air pressure of the air chambers 306a and 306b, various recline or incline positions of the bed 302, temperature of one or more surface temperature control devices of the bed 302, or for allowing the control circuitry 334 to generate control signals for other devices (as described below).

The control circuitry 334 may also communicate with other devices or systems, including but not limited to the television 312, a lighting system 314, a thermostat 316, a security system 318, home automation devices, and/or other household devices (e.g., an oven 322, a coffee maker 324, a lamp 326, a nightlight 328). Other examples of devices and/or systems include a system for controlling window blinds 330, devices for detecting or controlling states of one or more doors 332 (such as detecting if a door is open, detecting if a door is locked, or automatically locking a door), and a system for controlling a garage door 320 (e.g., control circuitry 334 integrated with a garage door opener for identifying an open or closed state of the garage door 320 and for causing the garage door opener to open or close the garage door 320). Communications between the control circuitry 334 and other devices can occur through a network (e.g., a LAN or the Internet) or as point-to-point communication (e.g., Bluetooth, radio communication, or a wired connection). Control circuitry 334 of different beds 302 can also communicate with different sets of devices. For example, a kid's bed may not communicate with and/or control the same devices as an adult bed. In some embodiments, the bed 302 can evolve with the age of the user such that the control circuitry 334 of the bed 302 communicates with different devices as a function of age of the user of that bed 302.

The control circuitry 334 can receive information and inputs from other devices/systems and use the received information and inputs to control actions of the bed 302 and/or other devices. For example, the control circuitry 334 can receive information from the thermostat 316 indicating a current environmental temperature for a house or room in which the bed 302 is located. The control circuitry 334 can use the received information (along with other information, such as signals detected from one or more sensors of the bed 302) to determine if a temperature of all or a portion of the surface of the bed 302 should be raised or lowered. The control circuitry 334 can then cause a heating or cooling mechanism of the bed 302 to raise or lower the temperature of the surface of the bed 302. The control circuitry 334 can also cause a heating or cooling unit of the house or room in which the bed 302 is located to raise or lower the ambient temperature surrounding the bed 302. Thus, by adjusting the temperature of the bed 302 and/or the room in which the bed 302 is located, the user 308 can experience more improved sleep quality and comfort.

As an example, the user 308 can indicate a desired sleeping temperature of 74 degrees while a second user of the bed 302 indicates a desired sleeping temperature of 72 degrees. The thermostat 316 can transmit signals indicating room temperature at predetermined times to the control circuitry 334. The thermostat 316 can also send a continuous stream of detected temperature values of the room to the control circuitry 334. The transmitted signal(s) can indicate to the control circuitry 334 that the current temperature of the bedroom is 72 degrees. The control circuitry 334 can identify that the user 308 has indicated a desired sleeping temperature of 74 degrees, and can accordingly send control signals to a heating pad located on the user 308's side of the bed to raise the temperature of the portion of the surface of the bed 302 where the user 308 is located until the user 308's desired temperature is achieved. Moreover, the control circuitry 334 can send control signals to the thermostat 316 and/or a heating unit in the house to raise the temperature in the room in which the bed 302 is located.

The control circuitry 334 can generate control signals to control other devices and propagate the control signals to the other devices. The control signals can be generated based on information collected by the control circuitry 334, including information related to user interaction with the bed 302 by the user 308 and/or one or more other users. Information collected from other devices other than the bed 302 can also be used when generating the control signals. For example, information relating to environmental occurrences (e.g., environmental temperature, environmental noise level, and environmental light level), time of day, time of year, day of the week, or other information can be used when generating control signals for various devices in communication with the control circuitry 334 of the bed 302.

For example, information on the time of day can be combined with information relating to movement and bed presence of the user 308 to generate control signals for the lighting system 314. The control circuitry 334 can, based on detected pressure signals of the user 308 on the bed 302, determine when the user 308 is presently in the bed 302 and when the user 308 falls asleep. Once the control circuitry 334 determines that the user has fallen asleep, the control circuitry 334 can transmit control signals to the lighting system 314 to turn off lights in the room in which the bed 302 is located, to lower the window blinds 330 in the room, and/or to activate the nightlight 328. Moreover, the control circuitry 334 can receive input from the user 308 (e.g., via the user device 310) that indicates a time at which the user 308 would like to wake up. When that time approaches, the control circuitry 334 can transmit control signals to one or more devices in the environment 300 to control devices that may cause the user 308 to wake up. For example, the control signals can be sent to a home automation device that controls multiple devices in the home. The home automation device can be instructed, by the control circuitry 334, to raise the window blinds 330, turn off the nightlight 328, turn on lighting beneath the bed 302, start the coffee maker 324, change a temperature in the house via the thermostat 316, or perform some other home automation. The home automation device can also be instructed to activate an alarm that can cause the user 308 to wake up. Sometimes, the user 308 can input information at the user device 310 that indicates what actions can be taken by the home automation device or other devices in the environment 300.

In some implementations, rather than or in addition to providing control signals for other devices, the control circuitry 334 can provide collected information (e.g., information related to user movement, bed presence, sleep state, or biometric signals) to one or more other devices to allow the one or more other devices to utilize the collected information when generating control signals. For example, the control circuitry 334 of the bed 302 can provide information relating to user interactions with the bed 302 by the user 308 to a central controller (not shown) that can use the provided information to generate control signals for various devices, including the bed 302.

The central controller can, for example, be a hub device that provides a variety of information about the user 308 and control information associated with the bed 302 and other devices in the house. The central controller can include sensors that detect signals that can be used by the control circuitry 334 and/or the central controller to determine information about the user 308 (e.g., biometric or other health data, sleep quality). The sensors can detect signals including such as ambient light, temperature, humidity, volatile organic compound(s), pulse, motion, and audio. These signals can be combined with signals detected by sensors of the bed 302 to determine accurate information about the user 308's health and sleep quality. The central controller can provide controls (e.g., user-defined, presets, automated, user initiated) for the bed 302, determining and viewing sleep quality and health information, a smart alarm clock, a speaker or other home automation device, a smart picture frame, a nightlight, and one or more mobile applications that the user 308 can install and use at the central controller. The central controller can include a display screen that outputs information and receives user input. The display can output information such as the user 308's health, sleep quality, weather, security integration features, lighting integration features, heating and cooling integration features, and other controls to automate devices in the house. The central controller can operate to provide the user 308 with functionality and control of multiple different types of devices in the house as well as the user 308's bed 302.

As an illustrative example of FIG. 3, the control circuitry 334 integrated with the pump 304 can detect a feature of a mattress of the bed 302, such as an increase in pressure in the air chamber 306b, and use this detected increase to determine that the user 308 is present on the bed 302. The control circuitry 334 may also identify a heart rate or respiratory rate for the user 308 to identify that the increased pressure is due to a person sitting, laying, or resting on the bed 302, rather than an inanimate object (e.g., a suitcase) having been placed on the bed 302. In some implementations, the information indicating user bed presence can be combined with other information to identify a current or future likely state for the user 308. For example, a detected user bed presence at 11:00 am can indicate that the user is sitting on the bed (e.g., to tie her shoes, or to read a book) and does not intend to go to sleep, while a detected user bed presence at 10:00 pm can indicate that the user 308 is in bed for the evening and is intending to fall asleep soon. As another example, if the control circuitry 334 detects that the user 308 has left the bed 302 at 6:30 am (e.g., indicating that the user 308 has woken up for the day), and then later detects presence of the user 308 at 7:30 am on the bed 302, the control circuitry 334 can use this information that the newly detected presence is likely temporary (e.g., while the user 308 ties her shoes before heading to work) rather than an indication that the user 308 is intending to stay on the bed 302 for an extended period of time.

If the control circuitry 334 determines that the user 308 is likely to remain on the bed 302 for an extended period of time, the control circuitry 334 can determine one or more home automation controls that can aid the user 308 in falling asleep and experience improved sleep quality throughout the user 308's sleep cycle. For example, the control circuitry 334 can communicate with security system 318 to ensure that doors are locked. The control circuitry 334 can communicate with the oven 322 to ensure that the oven 322 is turned off. The control circuitry 334 can also communicate with the lighting system 314 to dim or otherwise turn off lights in the room in which the bed 302 is located and/or throughout the house, and the control circuitry 334 can communicate with the thermostat 316 to ensure that the house is at a desired temperature of the user 308. The control circuitry 334 can also determine one or more adjustments that can be made to the bed 302 to facilitate the user 308 falling asleep and staying asleep (e.g., changing a position of one or more regions of the bed 302, foot warming, massage features, pressure/firmness in one or more regions of the bed 302, etc.).

In some implementations, the control circuitry 334 may use collected information (including information related to user interaction with the bed 302 by the user 308, environmental information, time information, and user input) to identify use patterns for the user 308. For example, the control circuitry 334 can use information indicating bed presence and sleep states for the user 308 collected over a period of time to identify a sleep pattern for the user. The control circuitry 334 can identify that the user 308 generally goes to bed between 9:30 pm and 10:00 pm, generally falls asleep between 10:00 pm and 11:00 pm, and generally wakes up between 6:30 am and 6:45 am, based on information indicating user presence and biometrics for the user 308 collected over a week or a different time period. The control circuitry 334 can use identified patterns of the user 308 to better process and identify user interactions with the bed 302.

Given the above example user bed presence, sleep, and wake patterns for the user 308, if the user 308 is detected as being on the bed 302 at 3:00 pm, the control circuitry 334 can determine that the user 308's presence on the bed 302 is temporary, and use this determination to generate different control signals than if the control circuitry 334 determined the user 308 was in bed for the evening (e.g., at 3:00 pm, a head region of the bed 302 can be raised to facilitate reading or watching TV while in the bed 302, whereas in the evening, the bed 302 can be adjusted to a flat position to facilitate falling asleep). As another example, if the control circuitry 334 detects that the user 308 got out of bed at 3:00 am, the control circuitry 334 can use identified patterns for the user 308 to determine the user has gotten up temporarily (e.g., to use the bathroom, get a glass of water). The control circuitry 334 can turn on underbed lighting to assist the user 308 in carefully moving around the bed 302 and room. By contrast, if the control circuitry 334 identifies that the user 308 got out of the bed 302 at 6:40 am, the control circuitry 334 can determine the user 308 is up for the day and generate a different set of control signals (e.g., the control circuitry 334 can turn on lamp 326 near the bed 302 and/or raise the window blinds 330). For other users, getting out of the bed 302 at 3:00 am can be a normal wake-up time, which the control circuitry 334 can learn and respond to accordingly. Moreover, if the bed 302 is occupied by two users, the control circuitry 334 can learn and respond to the patterns of each of the users.

The bed 302 can also generate control signals based on communication with one or more devices. As an illustrative example, the control circuitry 334 can receive an indication from the television 312 that the television 312 is turned on. If the television 312 is located in a different room than the bed 302, the control circuitry 334 can generate a control signal to turn the television 312 off upon making a determination that the user 308 has gone to bed for the evening or otherwise is remaining in the room with the bed 302. If presence of the user 308 is detected on the bed 302 during a particular time range (e.g., between 8:00 pm and 7:00 am) and persists for longer than a threshold period of time (e.g., 10 minutes), the control circuitry 334 can determine the user 308 is in bed for the evening. If the television 312 is on, as described above, the control circuitry 334 can generate a control signal to turn the television 312 off. The control signals can be transmitted to the television (e.g., through a directed communication link or through a network, such as WiFi). As another example, rather than turning off the television 312 in response to detection of user bed presence, the control circuitry 334 can generate a control signal that causes the volume of the television 312 to be lowered by a pre-specified amount.

As another example, upon detecting that the user 308 has left the bed 302 during a specified time range (e.g., between 6:00 am and 8:00 am), the control circuitry 334 can generate control signals to cause the television 312 to turn on and tune to a pre-specified channel (e.g., the user 308 indicated a preference for watching morning news upon getting out of bed). The control circuitry 334 can accordingly generate and transmit the control signal to the television 312 (which can be stored at the control circuitry 334, the television 312, or another location). As another example, upon detecting that the user 308 has gotten up for the day, the control circuitry 334 can generate and transmit control signals to cause the television 312 to turn on and begin playing a previously recorded program from a digital video recorder (DVR) in communication with the television 312.

As another example, if the television 312 is in the same room as the bed 302, the control circuitry 334 may not cause the television 312 to turn off in response to detection of user bed presence. Rather, the control circuitry 334 can generate and transmit control signals to cause the television 312 to turn off in response to determining that the user 308 is asleep. For example, the control circuitry 334 can monitor biometric signals of the user 308 (e.g., motion, heart rate, respiration rate) to determine that the user 308 has fallen asleep. Upon detecting that the user 308 is sleeping, the control circuitry 334 generates and transmits a control signal to turn the television 312 off. As another example, the control circuitry 334 can generate the control signal to turn off the television 312 after a threshold period of time has passed since the user 308 has fallen asleep (e.g., 10 minutes after the user has fallen asleep). As another example, the control circuitry 334 generates control signals to lower the volume of the television 312 after determining that the user 308 is asleep. As yet another example, the control circuitry 334 generates and transmits a control signal to cause the television to gradually lower in volume over a period of time and then turn off in response to determining that the user 308 is asleep. Any of the control signals described above in reference to the television 312 can also be determined by the central controller previously described.

In some implementations, the control circuitry 334 can similarly interact with other media devices, such as computers, tablets, mobile phones, smart phones, wearable devices, stereo systems, etc. For example, upon detecting that the user 308 is asleep, the control circuitry 334 can generate and transmit a control signal to the user device 310 to cause the user device 310 to turn off, or turn down the volume on a video or audio file being played by the user device 310.

The control circuitry 334 can additionally communicate with the lighting system 314, receive information from the lighting system 314, and generate control signals for controlling functions of the lighting system 314. For example, upon detecting user bed presence on the bed 302 during a certain time frame (e.g., between 8:00 pm and 7:00 am) that lasts for longer than a threshold period of time (e.g., 10 minutes), the control circuitry 334 of the bed 302 can determine that the user 308 is in bed for the evening and generate control signals to cause lights in one or more rooms other than the room in which the bed 302 is located to switch off. The control circuitry 334 can generate and transmit control signals to turn off lights in all common rooms, but not in other bedrooms. As another example, the control signals can indicate that lights in all rooms other than the room in which the bed 302 is located are to be turned off, while one or more lights located outside of the house containing the bed 302 are to be turned on. The control circuitry 334 can generate and transmit control signals to cause the nightlight 328 to turn on in response to determining user bed presence or that the user 308 is asleep. The control circuitry 334 can also generate first control signals for turning off a first set of lights (e.g., lights in common rooms) in response to detecting user bed presence, and second control signals for turning off a second set of lights (e.g., lights in the room where the bed 302 is located) when detecting that the user 308 is asleep.

In some implementations, in response to determining that the user 308 is in bed for the evening, the control circuitry 334 of the bed 302 can generate control signals to cause the lighting system 314 to implement a sunset lighting scheme in the room in which the bed 302 is located. A sunset lighting scheme can include, for example, dimming the lights (either gradually over time, or all at once) in combination with changing the color of the light in the bedroom environment, such as adding an amber hue to the lighting in the bedroom. The sunset lighting scheme can help to put the user 308 to sleep when the control circuitry 334 has determined that the user 308 is in bed for the evening. Sometimes, the control signals can cause the lighting system 314 to dim the lights or change color of the lighting in the bedroom environment, but not both.

The control circuitry 334 can also implement a sunrise lighting scheme when the user 308 wakes up in the morning. The control circuitry 334 can determine that the user 308 is awake for the day, for example, by detecting that the user 308 has gotten off the bed 302 (e.g., is no longer present on the bed 302) during a specified time frame (e.g., between 6:00 am and 8:00 am). The control circuitry 334 can also monitor movement, heart rate, respiratory rate, or other biometric signals of the user 308 to determine that the user 308 is awake or is waking up, even though the user 308 has not gotten out of bed. If the control circuitry 334 detects that the user is awake or waking up during a specified timeframe, the control circuitry 334 can determine that the user 308 is awake for the day. The specified timeframe can be, for example, based on previously recorded user bed presence information collected over a period of time (e.g., two weeks) that indicates that the user 308 usually wakes up for the day between 6:30 am and 7:30 am. In response to the control circuitry 334 determining that the user 308 is awake, the control circuitry 334 can generate control signals to cause the lighting system 314 to implement the sunrise lighting scheme in the bedroom in which the bed 302 is located. The sunrise lighting scheme can include, for example, turning on lights (e.g., the lamp 326, or other lights in the bedroom). The sunrise lighting scheme can further include gradually increasing the level of light in the room where the bed 302 is located (or in one or more other rooms). The sunrise lighting scheme can also include only turning on lights of specified colors. The sunrise lighting scheme can include lighting the bedroom with blue light to gently assist the user 308 in waking up and becoming active.

The control circuitry 334 may also generate different control signals for controlling actions of components depending on a time of day that user interactions with the bed 302 are detected. For example, the control circuitry 334 can use historical user interaction information to determine that the user 308 usually falls asleep between 10:00 pm and 11:00 pm and usually wakes up between 6:30 am and 7:30 am on weekdays. The control circuitry 334 can use this information to generate a first set of control signals for controlling the lighting system 314 if the user 308 is detected as getting out of bed at 3:00 am (e.g., turn on lights that guide the user 308 to a bathroom or kitchen) and to generate a second set of control signals for controlling the lighting system 314 if the user 308 is detected as getting out of bed after 6:30 am.

In some implementations, if the user 308 is detected as getting out of bed prior to a specified morning rise time for the user 308, the control circuitry 334 can cause the lighting system 314 to turn on lights that are dimmer than lights that are turned on by the lighting system 314 if the user 308 is detected as getting out of bed after the specified morning rise time. Causing the lighting system 314 to only turn on dim lights when the user 308 gets out of bed during the night (e.g., prior to normal rise time for the user 308) can prevent other occupants of the house from being woken up by the lights while still allowing the user 308 to see in order to reach their destination in the house.

The historical user interaction information for interactions between the user 308 and the bed 302 can be used to identify user sleep and awake timeframes. For example, user bed presence times and sleep times can be determined for a set period of time (e.g., two weeks, a month, etc.). The control circuitry 334 can identify a typical time range or timeframe in which the user 308 goes to bed, a typical timeframe for when the user 308 falls asleep, and a typical timeframe for when the user 308 wakes up (and in some cases, different timeframes for when the user 308 wakes up and when the user 308 actually gets out of bed). Buffer time may be added to these timeframes. For example, if the user is identified as typically going to bed between 10:00 pm and 10:30 pm, a buffer of a half hour in each direction can be added to the timeframe such that any detection of the user getting in bed between 9:30 pm and 11:00 pm is interpreted as the user 308 going to bed for the evening. As another example, detection of bed presence of the user 308 starting from a half hour before the earliest typical time that the user 308 goes to bed extending until the typical wake up time (e.g., 6:30 am) for the user 308 can be interpreted as the user 308 going to bed for the evening. For example, if the user 308 typically goes to bed between 10:00 pm and 10:30 pm, if the user 308's bed presence is sensed at 12:30 am one night, that can be interpreted as the user 308 getting into bed for the evening even though this is outside of the user 308's typical timeframe for going to bed because it has occurred prior to the user 308's normal wake up time. In some implementations, different timeframes are identified for different times of year (e.g., earlier bed time during winter vs. summer) or at different times of the week (e.g., user 308 wakes up earlier on weekdays than on weekends).

The control circuitry 334 can distinguish between the user 308 going to bed for an extended period (e.g., for the night) as opposed to being present on the bed 302 for a shorter period (e.g., for a nap) by sensing duration of presence of the user 308 (e.g., by detecting pressure and/or temperature signals of the user 308 on the bed 302 by sensors integrated into the bed 302). In some examples, the control circuitry 334 can distinguish between the user 308 going to bed for an extended period (e.g., for the night) versus going to bed for a shorter period (e.g., for a nap) by sensing duration of the user 308's sleep. The control circuitry 334 can set a time threshold whereby if the user 308 is sensed on the bed 302 for longer than the threshold, the user 308 is considered to have gone to bed for the night. In some examples, the threshold can be about 2 hours, whereby if the user 308 is sensed on the bed 302 for greater than 2 hours, the control circuitry 334 registers that as an extended sleep event. In other examples, the threshold can be greater than or less than two hours. The threshold can be determined based on historic trends indicating how long the user usually sleeps or otherwise stays on the bed 302.

The control circuitry 334 can detect repeated extended sleep events to automatically determine a typical bed time range of the user 308, without requiring the user 308 to enter a bed time range. This can allow the control circuitry 334 to accurately estimate when the user 308 is likely to go to bed for an extended sleep event, regardless of whether the user 308 typically goes to bed using a traditional sleep schedule or a non-traditional sleep schedule. The control circuitry 334 can then use knowledge of the bed time range of the user 308 to control one or more components (including components of the bed 302 and/or non-bed peripherals) based on sensing bed presence during the bed time range or outside of the bed time range.

The control circuitry 334 can automatically determine the bed time range of the user 308 without requiring user inputs. The control circuitry 334 may also determine the bed time range automatically and in combination with user inputs (e.g., using signals sensed by sensors of the bed 302 and/or the central controller). The control circuitry 334 can set the bed time range directly according to user inputs. The control circuitry 334 can associate different bed times with different days of the week. In each of these examples, the control circuitry 334 can control components (e.g., the lighting system 314, thermostat 316, security system 318, oven 322, coffee maker 324, lamp 326, nightlight 328), as a function of sensed bed presence and the bed time range.

The control circuitry 334 can also determine control signals to be transmitted to the thermostat 316 based on user-inputted preferences and/or maintaining improved or preferred sleep quality of the user 308. For example, the control circuitry 334 can determine, based on historic sleep patterns and quality of the user 308 and by applying machine learning models, that the user 308 experiences their best sleep when the bedroom is at 74 degrees. The control circuitry 334 can receive temperature signals from devices and/or sensors in the bedroom indicating a bedroom temperature. When the temperature is below 74 degrees, the control circuitry 334 can determine control signals that cause the thermostat 316 to activate a heating unit to raise the temperature to 74 degrees in the bedroom. When the temperature is above 74 degrees, the control circuitry 334 can determine control signals that cause the thermostat 316 to activate a cooling unit to lower the temperature back to 74 degrees. Sometimes, the control circuitry 334 can determine control signals that cause the thermostat 316 to maintain the bedroom within a temperature range intended to keep the user 308 in particular sleep states and/or transition to next preferred sleep states.

Similarly, the control circuitry 334 can generate control signals to cause heating or cooling elements on the surface of the bed 302 to change temperature at various times, either in response to user interaction with the bed 302, at various pre-programmed times, based on user preference, and/or in response to detecting microclimate temperatures of the user 308 on the bed 302. For example, the control circuitry 334 can activate a heating element to raise the temperature of one side of the surface of the bed 302 to 73 degrees when it is detected that the user 308 has fallen asleep. As another example, upon determining that the user 308 is up for the day, the control circuitry 334 can turn off a heating or cooling element. The user 308 can pre-program various times at which the temperature at the bed surface should be raised or lowered. As another example, temperature sensors on the bed surface can detect microclimates of the user 308. When a detected microclimate drops below a predetermined threshold temperature, the control circuitry 334 can activate a heating element to raise the user 308's body temperature, thereby improving the user 308's comfort, maintaining their sleep cycle, transitioning the user 308 to a next preferred sleep state, and/or maintaining or improving the user 308's sleep quality.

In response to detecting user bed presence and/or that the user 308 is asleep, the control circuitry 334 can also cause the thermostat 316 to change the temperature in different rooms to different values. Other control signals are also possible, and can be based on user preference and user input. Moreover, the control circuitry 334 can receive temperature information from the thermostat 316 and use this information to control functions of the bed 302 or other devices (e.g., adjusting temperatures of heating elements of the bed 302, such as a foot warming pad). The control circuitry 334 may also generate and transmit control signals for controlling other temperature control systems, such as floor heating elements in the bedroom or other rooms.

The control circuitry 334 can communicate with the security system 318, receive information from the security system 318, and generate control signals for controlling functions of the security system 318. For example, in response to detecting that the user 308 is in bed for the evening, the control circuitry 334 can generate control signals to cause the security system 318 to engage or disengage security functions. As another example, the control circuitry 334 can generate and transmit control signals to cause the security system 318 to disable in response to determining that the user 308 is awake for the day (e.g., user 308 is no longer present on the bed 302).

The control circuitry 334 can also receive alerts from the security system 318 and indicate the alert to the user 308. For example, the security system can detect a security breach (e.g., someone opened the door 332 without entering the security code, someone opened a window when the security system 318 is engaged) and communicate the security breach to the control circuitry 334. The control circuitry 334 can then generate control signals to alert the user 308, such as causing the bed 302 to vibrate, causing portions of the bed 302 to articulate (e.g., the head section to raise or lower), causing the lamp 326 to flash on and off at regular intervals, etc. The control circuitry 334 can also alert the user 308 of one bed 302 about a security breach in another bedroom, such as an open window in a kid's bedroom. The control circuitry 334 can send an alert to a garage door controller (e.g., to close and lock the door). The control circuitry 334 can send an alert for the security to be disengaged. The control circuitry 334 can also set off a smart alarm or other alarm device/clock near the bed 302. The control circuitry 334 can transmit a push notification, text message, or other indication of the security breach to the user device 310. Also, the control circuitry 334 can transmit a notification of the security breach to the central controller, which can then determine one or more responses to the security breach.

The control circuitry 334 can additionally generate and transmit control signals for controlling the garage door 320 and receive information indicating a state of the garage door 320 (e.g., open or closed). The control circuitry 334 can also request information on a current state of the garage door 320. If the control circuitry 334 receives a response (e.g., from the garage door opener) that the garage door 320 is open, the control circuitry 334 can notify the user 308 that the garage door is open (e.g., by displaying a notification or other message at the user device 310, outputting a notification at the central controller), and/or generate a control signal to cause the garage door opener to close the door. The control circuitry 334 can also cause the bed 302 to vibrate, cause the lighting system 314 to flash lights in the bedroom, etc. Control signals can also vary depending on the age of the user 308. Similarly, the control circuitry 334 can similarly send and receive communications for controlling or receiving state information associated with the door 332 or the oven 322.

In some implementations, different alerts can be generated for different events. For example, the control circuitry 334 can cause the lamp 326 (or other lights, via the lighting system 314) to flash in a first pattern if the security system 318 has detected a breach, flash in a second pattern if garage door 320 is on, flash in a third pattern if the door 332 is open, flash in a fourth pattern if the oven 322 is on, and flash in a fifth pattern if another bed has detected that a user 308 of that bed has gotten up (e.g., a child has gotten out of bed in the middle of the night as sensed by a sensor in the child's bed). Other examples of alerts include a smoke detector detecting smoke (and communicating this detection to the control circuitry 334), a carbon monoxide tester, a heater malfunctioning, or an alert from another device capable of communicating with the control circuitry 334 and detecting an occurrence to bring to the user 308's attention.

The control circuitry 334 can also communicate with a system or device for controlling a state of the window blinds 330. For example, in response to determining that the user 308 is up for the day or that the user 308 set an alarm to wake up at a particular time, the control circuitry 334 can generate and transmit control signals to cause the window blinds 330 to open. By contrast, if the user 308 gets out of bed prior to a normal rise time for the user 308, the control circuitry 334 can determine that the user 308 is not awake for the day and may not generate control signals that cause the window blinds 330 to open. The control circuitry 334 can also generate and transmit control signals that cause a first set of blinds to close in response to detecting user bed presence and a second set of blinds to close in response to detecting that the user 308 is asleep.

As other examples, in response to determining that the user 308 is awake for the day, the control circuitry 334 can generate and transmit control signals to the coffee maker 324 to cause the coffee maker 324 to brew coffee. The control circuitry 334 can generate and transmit control signals to the oven 322 to cause the oven 322 to begin preheating. The control circuitry 334 can use information indicating that the user 308 is awake for the day along with information indicating that the time of year is currently winter and/or that the outside temperature is below a threshold value to generate and transmit control signals to cause a car engine block heater to turn on. The control circuitry 334 can generate and transmit control signals to cause devices to enter a sleep mode in response to detecting user bed presence, or in response to detecting that the user 308 is asleep (e.g., causing a mobile phone of the user 308 to switch into sleep or night mode so that notifications are muted to not disturb the user 308's sleep). Later, upon determining that the user 308 is up for the day, the control circuitry 334 can generate and transmit control signals to cause the mobile phone to switch out of sleep/night mode.

The control circuitry 334 can also communicate with one or more noise control devices. For example, upon determining that the user 308 is in bed for the evening, or that the user 308 is asleep (e.g., based on pressure signals received from the bed 302, audio/decibel signals received from audio sensors positioned on or around the bed 302), the control circuitry 334 can generate and transmit control signals to cause noise cancelation devices to activate. The noise cancelation devices can be part of the bed 302 or located in the bedroom. Upon determining that the user 308 is in bed for the evening or that the user 308 is asleep, the control circuitry 334 can generate and transmit control signals to turn the volume on, off, up, or down, for one or more sound generating devices, such as a stereo system radio, television, computer, tablet, mobile phone, etc.

Additionally, functions of the bed 302 can be controlled by the control circuitry 334 in response to user interactions. For example, the articulation controller can adjust the bed 302 from a flat position to a position in which a head portion of a mattress of the bed 302 is inclined upward (e.g., to facilitate a user sitting up in bed, reading, and/or watching television). Sometimes, the bed 302 includes multiple separately articulable sections. Portions of the bed corresponding to the locations of the air chambers 306a and 306b can be articulated independently from each other, to allow one person to rest in a first position (e.g., a flat position) while a second person rests in a second position (e.g., a reclining position with the head raised at an angle from the waist). Separate positions can be set for two different beds (e.g., two twin beds placed next to each other). The foundation of the bed 302 can include more than one zone that can be independently adjusted. The articulation controller can also provide different levels of massage to one or more users on the bed 302 or cause the bed to vibrate to communicate alerts to the user 308 as described above.

The control circuitry 334 can adjust positions (e.g., incline and decline positions for the user 308 and/or an additional user) in response to user interactions with the bed 302 (e.g., causing the articulation controller to adjust to a first recline position in response to sensing user bed presence). The control circuitry 334 can cause the articulation controller to adjust the bed 302 to a second recline position (e.g., a less reclined, or flat position) in response to determining that the user 308 is asleep. As another example, the control circuitry 334 can receive a communication from the television 312 indicating that the user 308 has turned off the television 312, and in response, the control circuitry 334 can cause the articulation controller to adjust the bed position to a preferred user sleeping position (e.g., due to the user turning off the television 312 while the user 308 is in bed indicating the user 308 wishes to go to sleep).

In some implementations, the control circuitry 334 can control the articulation controller to wake up one user without waking another user of the bed 302. For example, the user 308 and a second user can each set distinct wakeup times (e.g., 6:30 am and 7:15 am respectively). When the wakeup time for the user 308 is reached, the control circuitry 334 can cause the articulation controller to vibrate or change the position of only a side of the bed on which the user 308 is located. When the wakeup time for the second user is reached, the control circuitry 334 can cause the articulation controller to vibrate or change the position of only the side of the bed on which the second user is located. Alternatively, when the second wakeup time occurs, the control circuitry 334 can utilize other methods (such as audio alarms, or turning on the lights) to wake the second user since the user 308 is already awake and therefore will not be disturbed when the control circuitry 334 attempts to wake the second user.

Still referring to FIG. 3, the control circuitry 334 for the bed 302 can utilize information for interactions with the bed 302 by multiple users to generate control signals for controlling functions of various other devices. For example, the control circuitry 334 can wait to generate control signals for devices until both the user 308 and a second user are detected in the bed 302. The control circuitry 334 can generate a first set of control signals to cause the lighting system 314 to turn off a first set of lights upon detecting bed presence of the user 308 and generate a second set of control signals for turning off a second set of lights in response to detecting bed presence of a second user. The control circuitry 334 can also wait until it has been determined that both users are awake for the day before generating control signals to open the window blinds 330. One or more other home automation control signals can be determined and generated by the control circuitry 334, the user device 310, and/or the central controller.

### Examples of Data Processing Systems Associated With a Bed

Described are example systems and components for data processing tasks that are, for example, associated with a bed. In some cases, multiple examples of a particular component or group of components are presented. Some examples are redundant and/or mutually exclusive alternatives. Connections between components are shown as examples to illustrate possible network configurations for allowing communication between components. Different formats of connections can be used as technically needed/desired. The connections generally indicate a logical connection that can be created with any technologically feasible format. For example, a network on a motherboard can be created with a printed circuit board, wireless data connections, and/or other types of network connections. Some logical connections are not shown for clarity (e.g., connections with power supplies and/or computer readable memory).

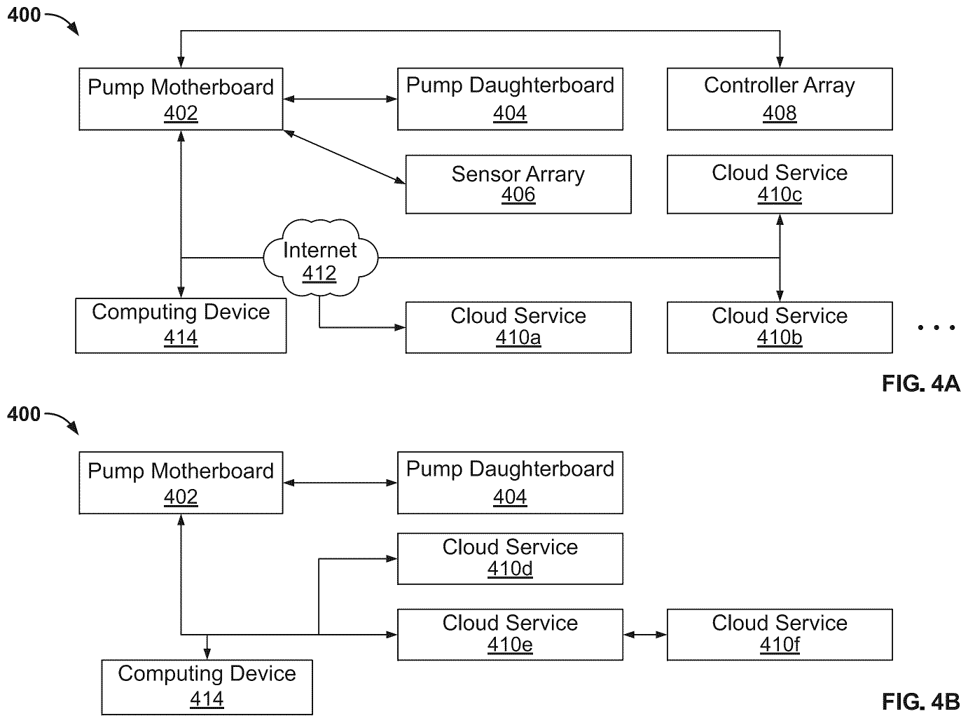

FIG. 4A is a block diagram of an example data processing system that can be associated with a bed system, including those described above (e.g., see FIGS. 1-3). The system 400 includes a pump motherboard 402 and a pump daughterboard 404. The system 400 includes a sensor array 406 having one or more sensors configured to sense physical phenomenon of the environment and/or bed, and to report sensing back to the pump motherboard 402 (e.g., for analysis). The sensor array 406 can include one or more different types of sensors, including but not limited to pressure, temperature, light, movement (e.g., motion), and audio. The system 400 also includes a controller array 408 that can include one or more controllers configured to control logic-controlled devices of the bed and/or environment (e.g., home automation devices, security systems, light systems, and other devices described in FIG. 3). The pump motherboard can be in communication with computing devices 414 and cloud services 410 over local networks (e.g., Internet 412) or otherwise as is technically appropriate.

In FIG. 4A, the pump motherboard 402 and daughterboard 404 are communicably coupled. They can be conceptually described as a center or hub of the system 400, with the other components conceptually described as spokes of the system 400. This can mean that each spoke component communicates primarily or exclusively with the pump motherboard 402. For example, a sensor of the sensor array 406 may not be configured to, or may not be able to, communicate directly with a corresponding controller. Instead, the sensor can report a sensor reading to the motherboard 402, and the motherboard 402 can determine that, in response, a controller of the controller array 408 should adjust some parameters of a logic controlled device or otherwise modify a state of one or more peripheral devices.

One advantage of a hub-and-spoke network configuration, or a star-shaped network, is a reduction in network traffic compared to, for example, a mesh network with dynamic routing. If a particular sensor generates a large, continuous stream of traffic, that traffic is transmitted over one spoke to the motherboard 402. The motherboard 402 can marshal and condense that data to a smaller data format for retransmission for storage in a cloud service 410. Additionally or alternatively, the motherboard 402 can generate a single, small, command message to be sent down a different spoke in response to the large stream. For example, if the large stream of data is a pressure reading transmitted from the sensor array 406 a few times a second, the motherboard 402 can respond with a single command message to the controller array 408 to increase the pressure in an air chamber of the bed. In this case, the single command message can be orders of magnitude smaller than the stream of pressure readings.

As another advantage, a hub-and-spoke network configuration can allow for an extensible network that accommodates components being added, removed, failing, etc. This can allow more, fewer, or different sensors in the sensor array 406, controllers in the controller array 408, computing devices 414, and/or cloud services 410. For example, if a particular sensor fails or is deprecated by a newer version, the system 400 can be configured such that only the motherboard 402 needs to be updated about the replacement sensor. This can allow product differentiation where the same motherboard 402 can support an entry level product with fewer sensors and controllers, a higher value product with more sensors and controllers, and customer personalization where a customer can add their own selected components to the system 400.

Additionally, a line of air bed products can use the system 400 with different components. In an application in which every air bed in the product line includes both a central logic unit and a pump, the motherboard 402 (and optionally the daughterboard 404) can be designed to fit within a single, universal housing. For each upgrade of the product in the product line, additional sensors, controllers, cloud services, etc., can be added. Design, manufacturing, and testing time can be reduced by designing all products in a product line from this base, compared to a product line in which each product has a bespoke logic control system.

Each of the components discussed above can be realized in a wide variety of technologies and configurations. Below, some examples of each component are discussed. Sometimes, two or more components of the system 400 can be realized in a single alternative component; some components can be realized in multiple, separate components; and/or some functionality can be provided by different components.

FIG. 4B is a block diagram showing communication paths of the system 400. As described, the motherboard 402 and daughterboard 404 may act as a hub of the system 400. When the pump daughterboard 404 communicates with cloud services 410 or other components, communications may be routed through the motherboard 402. This may allow the bed to have a single connection with the Internet 412. The computing device 414 may also have a connection to the Internet 412, possibly through the same gateway used by the bed and/or a different gateway (e.g., a cell service provider).

In FIG. 4B, cloud services 410d and 410e may be configured such that the motherboard 402 communicates with the cloud service directly (e.g., without having to use another cloud service 410 as an intermediary). Additionally or alternatively, some cloud services 410 (e.g., 410f) may only be reachable by the motherboard 402 through an intermediary cloud service (e.g., 410e). While not shown here, some cloud services 410 may be reachable either directly or indirectly by the pump motherboard 402.

Additionally, some or all of the cloud services 410 may communicate with other cloud services, including the transfer of data and/or remote function calls according to any technologically appropriate format. For example, one cloud service 410 may request a copy for another cloud service's 410 data (e.g., for purposes of backup, coordination, migration, calculations, data mining). Many cloud services 410 may also contain data that is indexed according to specific users tracked by the user account cloud 410c and/or the bed data cloud 410a. These cloud services 410 may communicate with the user account cloud 410c and/or the bed data cloud 410a when accessing data specific to a particular user or bed.

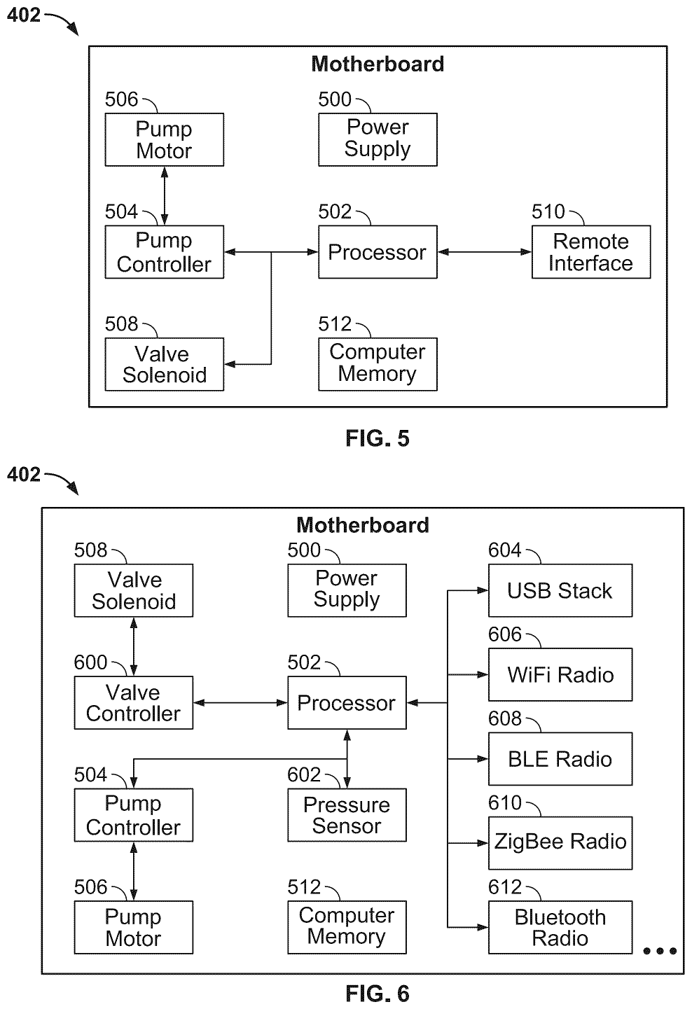

FIG. 5 is a block diagram of an example motherboard 402 in a data processing system associated with a bed system (e.g., refer to FIGS. 1-3). In this example, compared to other examples described below, this motherboard 402 consists of relatively fewer parts and can be limited to provide a relatively limited feature set.

The motherboard 402 includes a power supply 500, a processor 502, and computer memory 512. In general, the power supply 500 includes hardware used to receive electrical power from an outside source and supply it to components of the motherboard 402. The power supply may include a battery pack and/or wall outlet adapter, an AC to DC converter, a DC to AC converter, a power conditioner, a capacitor bank, and/or one or more interfaces for providing power in the current type, voltage, etc., needed by other components of the motherboard 402.

The processor 502 is generally a device for receiving input, performing logical determinations, and providing output. The processor 502 can be a central processing unit, a microprocessor, general purpose logic circuitry, application-specific integrated circuitry, a combination of these, and/or other hardware.

The memory 512 is generally one or more devices for storing data, which may include long term stable data storage (e.g., on a hard disk), short term unstable (e.g., on Random Access Memory), or any other technologically appropriate configuration.

The motherboard 402 includes a pump controller 504 and a pump motor 506. The pump controller 504 can receive commands from the processor 502 to control functioning of the pump motor 506. For example, the pump controller 504 can receive a command to increase pressure of an air chamber by 0.3 pounds per square inch (PSI). The pump controller 504, in response, engages a valve so that the pump motor 506 pumps air into the selected air chamber, and can engage the pump motor 506 for a length of time that corresponds to 0.3 PSI or until a sensor indicates that pressure has been increased by 0.3 PSI. Sometimes, the message can specify that the chamber should be inflated to a target PSI, and the pump controller 504 can engage the pump motor 506 until the target PSI is reached.

A valve solenoid 508 can control which air chamber a pump is connected to. In some cases, the solenoid 508 can be controlled by the processor 502 directly. In some cases, the solenoid 508 can be controlled by the pump controller 504.

A remote interface 510 of the motherboard 402 can allow the motherboard 402 to communicate with other components of a data processing system. For example, the motherboard 402 can be able to communicate with one or more daughterboards, with peripheral sensors, and/or with peripheral controllers through the remote interface 510. The remote interface 510 can provide any technologically appropriate communication interface, including but not limited to multiple communication interfaces such as WiFi, Bluetooth, and copper wired networks.

FIG. 6 is a block diagram of another example motherboard 402. Compared to the motherboard 402 in FIG. 5, the motherboard 402 in FIG. 6 can contain more components and provide more functionality in some applications.

This motherboard 402 can further include a valve controller 600, a pressure sensor 602, a universal serial bus (USB) stack 604, a WiFi radio 606, a Bluetooth Low Energy (BLE) radio 608, a ZigBee radio 610, a Bluetooth radio 612, and a computer memory 512.

The valve controller 600 can convert commands from the processor 502 into control signals for the valve solenoid 508. For example, the processor 502 can issue a command to the valve controller 600 to connect the pump to a particular air chamber out of a group of air chambers in an air bed. The valve controller 600 can control the position of the valve solenoid 508 so the pump is connected to the indicated air chamber.

The pressure sensor 602 can read pressure readings from one or more air chambers of the air bed. The pressure sensor 602 can also perform digital sensor conditioning. As described herein, multiple pressure sensors 602 can be included as part of the motherboard 402 or otherwise in communication with the motherboard 402.

The motherboard 402 can include a suite of network interfaces 604, 606, 608, 610, 612, etc., including but not limited to those shown in FIG. 6. These network interfaces can allow the motherboard to communicate over a wired or wireless network with any devices, including but not limited to peripheral sensors, peripheral controllers, computing devices, and devices and services connected to the Internet 412.

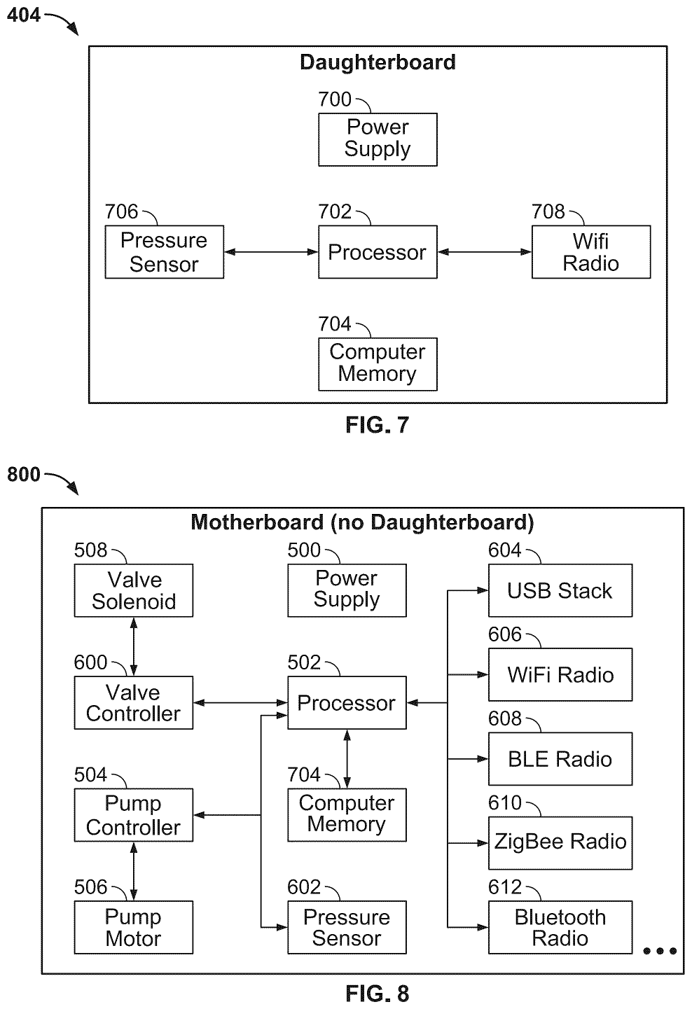

FIG. 7 is a block diagram of an example daughterboard 404 used in a data processing system associated with a bed system described herein. One or more daughterboards 404 can be connected to the motherboard 402. Some daughterboards 404 can be designed to offload particular and/or compartmentalized tasks from the motherboard 402. This can be advantageous if the particular tasks are computationally intensive, proprietary, or subject to future revisions. For example, the daughterboard 404 can be used to calculate a particular sleep data metric. This metric can be computationally intensive, and calculating the metric on the daughterboard 404 can free up resources of the motherboard 402 while the metric is calculated. The sleep metric may be subject to future revisions. To update the system 400 with the new metric, it is possible that only the daughterboard 404 calculates the metric to be replaced. In this case, the same motherboard 402 and other components can be used, saving the need to perform unit testing of additional components instead of just the daughterboard 404.

The daughterboard 404 includes a power supply 700, a processor 702, computer readable memory 704, a pressure sensor 706, and a WiFi radio 708. The processor 702 can use the pressure sensor 706 to gather information about pressure of air bed chambers. The processor 702 can perform an algorithm to calculate a sleep metric (e.g., sleep quality, bed presence, whether the user fell asleep, a heart rate, a respiration rate, movement, etc.). Sometimes, the sleep metric can be calculated from only air chamber pressure. The sleep metric can also be calculated using signals from a variety of sensors (e.g., movement, pressure, temperature, and/or audio sensors). The processor 702 can receive that data from sensors that may be internal to the daughterboard 404, accessible via the WiFi radio 708, or otherwise in communication with the processor 702. Once the sleep metric is calculated, the processor 702 can report that sleep metric to, for example, the motherboard 402. The motherboard 402 can generate instructions for outputting the sleep metric to the user or using the sleep metric to determine other user information or controls to control the bed and/or peripheral devices.

FIG. 8 is a block diagram of an example motherboard 800 with no daughterboard used in a data processing system associated with a bed system. In this example, the motherboard 800 can perform most, all, or more of the features described with reference to the motherboard 402 in FIG. 6 and the daughterboard 404 in FIG. 7.

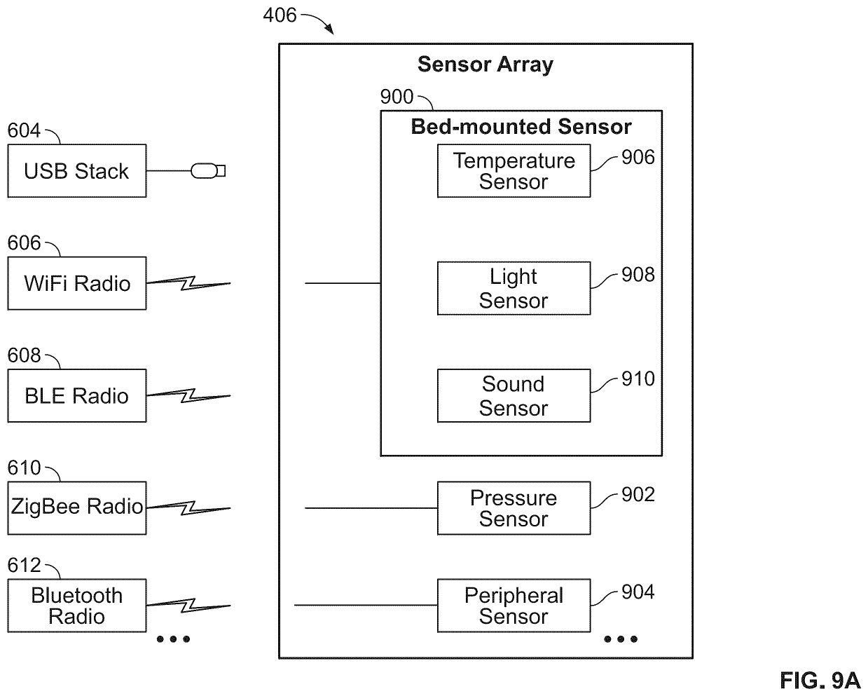

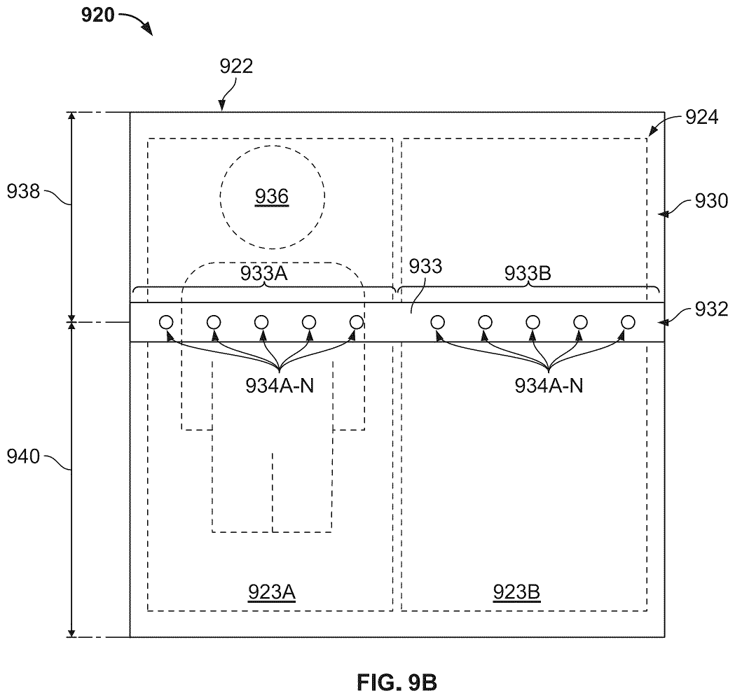

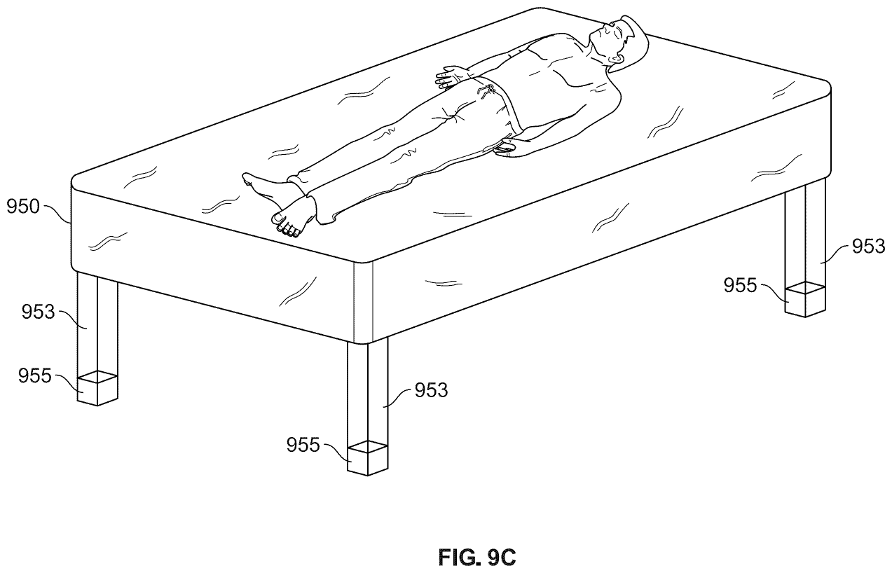

FIG. 9A is a block diagram of an example sensory array 406 used in a data processing system associated with a bed system described herein. The sensor array 406 is a conceptual grouping of some or all peripheral sensors that communicate with the motherboard 402 but are not native to the motherboard 402. The peripheral sensors 902, 904, 906, 908, 910, etc. of the sensor array 406 communicate with the motherboard 402 through one or more network interfaces 604, 606, 608, 610, and 612 of the motherboard, as is appropriate for the configuration of the particular sensor. For example, a sensor that outputs a reading over a USB cable can communicate through the USB stack 604.

Some peripheral sensors of the sensor array 406 can be bed mounted sensors 900 (e.g., temperature sensor 906, light sensor 908, sound sensor 910). The bed mounted sensors 900 can be embedded into a bed structure and sold with the bed, or later affixed to the structure (e.g., part of a pressure sensing pad that is removably installed on a top surface of the bed, part of a temperature sensing or heating pad that is removably installed on the top surface of the bed, integrated into the top surface, attached along connecting tubes between a pump and air chambers, within air chambers, attached to a headboard, attached to one or more regions of an adjustable foundation). One or more of the sensors 902 can be load cells or force sensors as described in FIG. 9C. Other sensors 902 and 904 may not be mounted to the bed and can include a pressure sensor 902 and/or peripheral sensor 904. For example, the sensors 902 and 904 can be integrated or otherwise part of a user mobile device (e.g., mobile phone, wearable device). The sensors 902 and 904 can also be part of a central controller for controlling the bed and peripheral devices. Sometimes, the sensors 902 and 904 can be part of one or more home automation devices or other peripheral devices. In some implementations, the peripheral sensors 904 can include but are not limited to light-detection-and-ranging (LiDAR), radar, and/or time-of-flight (ToF) sensors. LiDAR sensors can, for example, emit light from a laser in order to collect measurements, including but not limited to user movement and/or user biometrics. The light can be emitted from pulsed laser beams with wavelengths in a near-infrared (NIR) range. Radar sensors can use radio waves and/or microwaves and thus operate at longer wavelengths than LiDAR sensors. Radar sensors can similarly be used to detect user movement and/or user biometrics. ToF sensors can be used to determine amounts of time that it takes photons or other energy particles to travel between two points, which can be similarly used to detect user movement and/or user biometrics. One or more other peripheral sensors 904 are also possible.

Sometimes, some or all of the bed mounted sensors 900 and/or sensors 902 and 904 share networking hardware (e.g., a conduit that contains wires from each sensor, a multi-wire cable or plug that, when affixed to the motherboard 402, connect all the associated sensors with the motherboard 402). One, some, or all the sensors 902, 904, 906, 908, and 910 can sense features of a mattress (e.g., pressure, temperature, light, sound, and/or other features) and features external to the mattress. Sometimes, pressure sensor 902 can sense pressure of the mattress while some or all the sensors 902, 904, 906, 908, and 910 sense features of the mattress and/or features external to the mattress.

FIG. 9B is a schematic top view of a bed 920 having a sensor strip 932 with sensors 934A-N used in a data processing system associated with the bed 920. The bed 920 includes a mattress 922 (e.g., refer to FIG. 1). The mattress 922 can have a foam tub 930 beneath a top of the mattress 922. The foam tub 930 can have air chamber 923A and/or 923B, similar to those described herein.

The sensor strip 932 can be attached across the mattress top 924 from one lateral side to an opposing lateral side (e.g., from left to right). The sensor strip 932 can be attached proximate to a head section of the mattress 922 to measure temperature and/or humidity values around a chest area of a user 936. The sensor strip 932 can also be placed at a center point (e.g., midpoint) of the mattress 922 such that the distances 938 and 940 are equal to each other. The sensor strip 932 can be placed at other locations to capture temperature and/or humidity values at the top of the mattress 922.

The sensors 934A-N can be any one or more of the temperature sensors 906 described in FIG. 9A. The sensor strip 932 can also include a carrier strip 933 having a first strip portion 933A and a second strip portion 933B. The carrier strip 933 can be releasably attached to the foam tub layer 920 and extend between the opposite lateral ends of the foam tub 920. The sensor strip 932 can have first sensors 934A-N and second sensors 934A-N. Each of the first and second sensors 934A-N can have five sensors each. For example, a sensor strip 932 for a king or queen size mattress can have a total of ten sensors. When the user 936 is positioned on top of the mattress 922 over the air chamber 923A, the first sensors 934A-N can measure temperature and/or humidity of the mattress top 924 above the air chamber 923A. Those values can be used to, for example, determine a conditioned airflow to supply to the air chamber 923A. Temperature and/or humidity values measured by the second sensors 934A-N can be used to, for example, determine a conditioned airflow to supply to the air chamber 923B. The bed system 920 can provide for custom airflow to different portions of the mattress 922 based on body temperatures of users and/or temperatures of different portions of the mattress top 924.

Sometimes, two separate sensor strips can be attached to the mattress 922 (e.g., a first sensor strip over the air chamber 923A and a second sensor strip, separate from the first sensor strip, over the air chamber 923B). The first and second sensor strips can be attached to a center of the mattress top 924 via fastening elements, such as adhesive. The sensor strip 932 can also be easily replaced with another sensor strip. In some embodiments multiple sensor strips are used. As discussed below, in some embodiments each temperature controlled zone of the mattress may include one or more sensors, which may include sensors strips and/or other types of sensors. In some examples, one or more thermistors are used.

FIG. 9C is a schematic diagram of an example bed with force sensors 955 located at the bottom of legs 953 of the bed (e.g., in four, six, eight, or another number of legs). The force sensors 955 may also be located elsewhere on the bed with similar effect (e.g., between the legs 953 and platform 950). When a strain gauge is used as the force sensors 955, the force sensor(s) 955 can be positioned nearer centers of the legs 953. The force sensors 955 can be load cells.

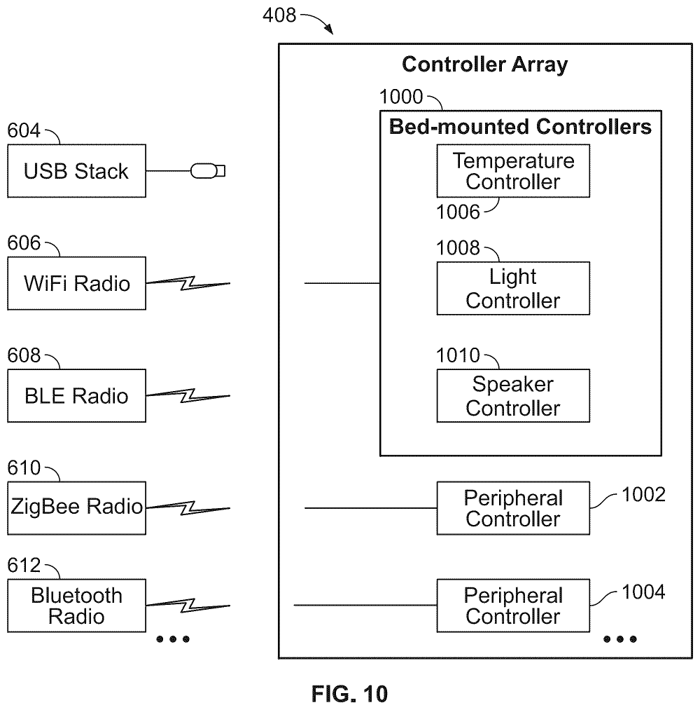

FIG. 10 is a block diagram of an example controller array 408 used in a data processing system associated with a bed system. The controller array 408 is a conceptual grouping of some or all peripheral controllers that communicate with the motherboard 402 but are not native to the motherboard 402. The peripheral controllers can communicate with the motherboard 402 through one or more of the network interfaces 604, 606, 608, 610, and 612 of the motherboard, as is appropriate for the configuration of the particular controller. Some of the controllers can be bed mounted controllers 1000, such as a temperature controller 1006, a light controller 1008, and a speaker controller 1010, as described in reference to bed-mounted sensors in FIG. 9A. Peripheral controllers 1002 and 1004 can be in communication with the motherboard 402, but optionally not mounted to the bed.

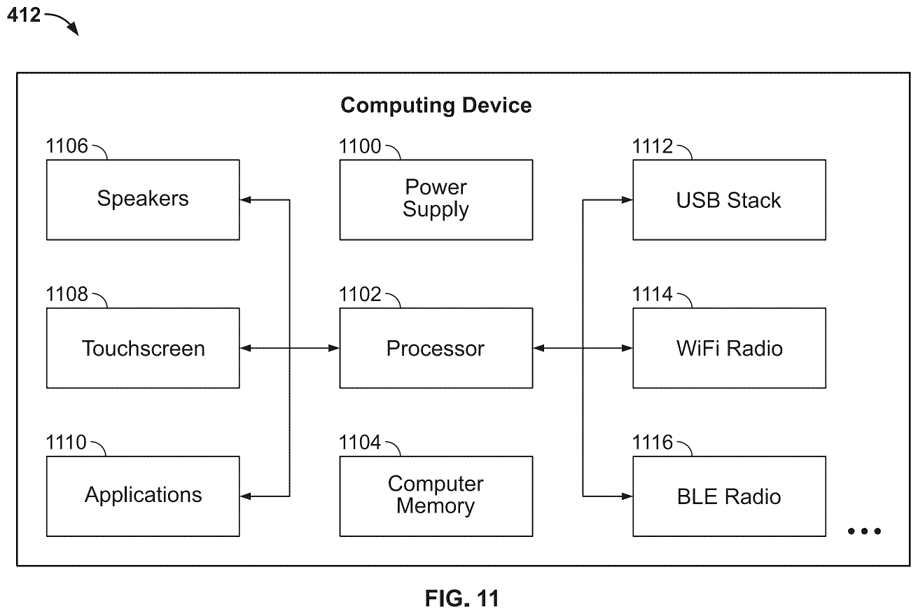

FIG. 11 is a block diagram of an example computing device 412 used in a data processing system associated with a bed system. The computing device 412 can include computing devices used by a user of a bed including but not limited to mobile computing devices (e.g., mobile phones, tablet computers, laptops, smart phones, wearable devices), desktop computers, home automation devices, and/or central controllers or other hub devices.

The computing device 412 includes a power supply 1100, a processor 1102, and computer readable memory 1104. User input and output can be transmitted by speakers 1106, a touchscreen 1108, or other not shown components (e.g., a pointing device or keyboard). The computing device 412 can run applications 1110 including, for example, applications to allow the user to interact with the system 400. These applications can allow a user to view information about the bed (e.g., sensor readings, sleep metrics), information about themselves (e.g., health conditions detected based on signals sensed at the bed), and/or configure the system 400 behavior (e.g., set desired firmness, set desired behavior for peripheral devices). The computing device 412 can be used in addition to, or to replace, the remote control 122 described above.

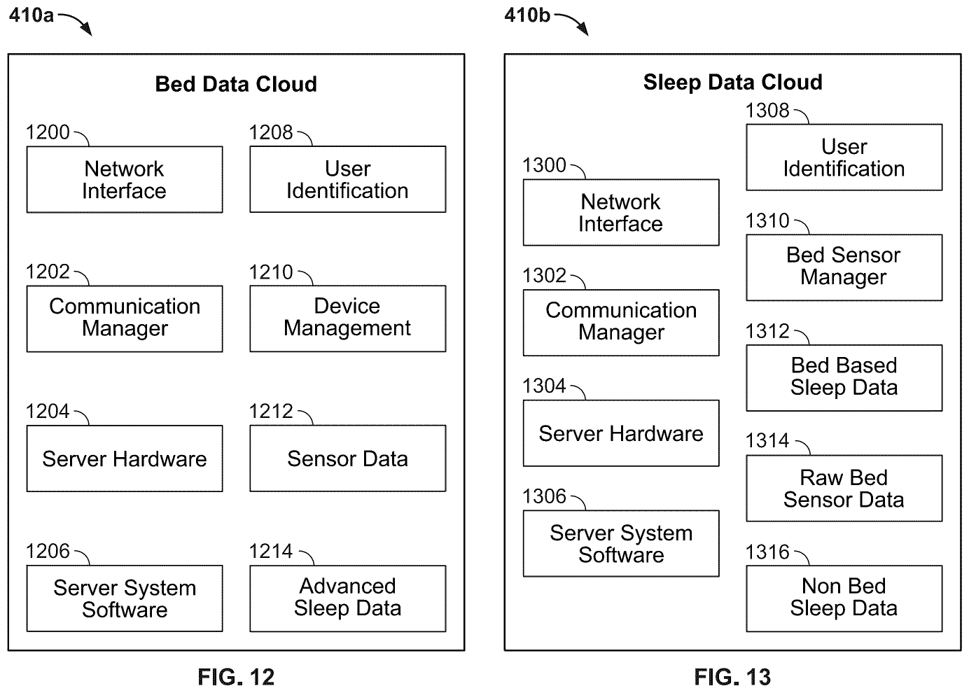

FIG. 12 is a block diagram of an example bed data cloud service 410a used in a data processing system associated with a bed system. Here, the bed data cloud service 410a is configured to collect sensor data and sleep data from a particular bed, and to match the data with one or more users that used the bed when the data was generated.

The bed data cloud service 410a includes a network interface 1200, a communication manager 1202, server hardware 1204, and server system software 1206. The bed data cloud service 410a is also shown with a user identification module 1208, a device management 1210 module, a sensor data module 1210, and an advanced sleep data module 1214. The network interface 1200 includes hardware and low level software to allow hardware devices (e.g., components of the service 410a) to communicate over networks (e.g., with each other, with other destinations over the Internet 412). The network interface 1200 can include network cards, routers, modems, and other hardware. The communication manager 1202 generally includes hardware and software that operate above the network interface 1200 such as software to initiate, maintain, and tear down network communications used by the service 410a (e.g., TCP/IP, SSL or TLS, Torrent, and other communication sessions over local or wide area networks). The communication manager 1202 can also provide load balancing and other services to other elements of the service 410a. The server hardware 1204 generally includes physical processing devices used to instantiate and maintain the service 410a. This hardware includes, but is not limited to, processors (e.g., central processing units, ASICs, graphical processers) and computer readable memory (e.g., random access memory, stable hard disks, tape backup). One or more servers can be configured into clusters, multi-computer, or datacenters that can be geographically separate or connected. The server system software 1206 generally includes software that runs on the server hardware 1204 to provide operating environments to applications and services (e.g., operating systems running on real servers, virtual machines instantiated on real servers to create many virtual servers, server level operations such as data migration, redundancy, and backup).

The user identification 1208 can include, or reference, data related to users of beds with associated data processing systems. The users may include customers, owners, or other users registered with the service 410a or another service. Each user can have a unique identifier, user credentials, contact information, billing information, demographic information, or any other technologically appropriate information.

The device manager 1210 can include, or reference, data related to beds or other products associated with data processing systems. The beds can include products sold or registered with a system associated with the service 410a. Each bed can have a unique identifier, model and/or serial number, sales information, geographic information, delivery information, a listing of associated sensors and control peripherals, etc. An index or indexes stored by the service 410a can identify users associated with beds. This index can record sales of a bed to a user, users that sleep in a bed, etc.

The sensor data 1212 can record raw or condensed sensor data recorded by beds with associated data processing systems. For example, a bed's data processing system can have temperature, pressure, motion, audio, and/or light sensors. Readings from these sensors, either in raw form or in a format generated from the raw data (e.g., sleep metrics), can be communicated by the bed's data processing system to the service 410a for storage in the sensor data 1212. An index or indexes stored by the service 410a can identify users and/or beds associated with the sensor data 1212.

The service 410a can use any of its available data (e.g., sensor data 1212) to generate advanced sleep data 1214. The advanced sleep data 1214 includes sleep metrics and other data generated from sensor readings (e.g., health information). Some of these calculations can be performed in the service 410a instead of locally on the bed's data processing system because the calculations can be computationally complex or require a large amount of memory space or processor power that may not be available on the bed's data processing system. This can help allow a bed system to operate with a relatively simple controller while being part of a system that performs relatively complex tasks and computations. However, other configurations are possible in which the service 410a is executed on the bed system. For example, the pump motherboard 402 and/or pump daughterboard 404 can contain sufficient processor and memory resources to execute the service 410a. In some cases, this can allow the service 410a to be executed redundantly, to protect against loss of network.

For example, the service 410a can retrieve one or more machine learning models from a remote data store and use those models to determine the advanced sleep data 1214. The service 410a can retrieve one or more models to determine overall sleep quality of the user based on currently detected sensor data 1212 and/or historic sensor data. The service 410a can retrieve other models to determine whether the user is snoring based on the detected sensor data 1212. The service 410a can retrieve other models to determine whether the user experiences a health condition based on the data 1212.

FIG. 13 is a block diagram of an example sleep data cloud service 410b used in a data processing system associated with a bed system. Here, the sleep data cloud service 410b is configured to record data related to users' sleep experience. The service 410b includes a network interface 1300, a communication manager 1302, server hardware 1304, and server system software 1306. The service 410b also includes a user identification module 1308, a pressure sensor manager 1310, a pressure based sleep data module 1312, a raw pressure sensor data module 1314, and a non-pressure sleep data module 1316. Sometimes, the service 410b can include a sensor manager for each sensor. The service 410b can also include a sensor manager that relates to multiple sensors in beds (e.g., a single sensor manager can relate to pressure, temperature, light, movement, and audio sensors in a bed).

The bed sensor manager 1310 can include, or reference, data related to the configuration and operation of sensors in beds such as pressure sensors, force sensors, or other sensors of a bed. This data can include an identifier of the types of sensors in a particular bed, their settings and calibration data, etc. The bed based sleep data 1312 can use raw bed sensor data 1314 to calculate sleep metrics tied to bed sensor data. For example, user presence, movements, weight change, heart rate, and breathing rate can be determined from raw bed sensor data 1314. An index or indexes stored by the service 410b can identify users associated with pressure sensors, raw pressure sensor data, and/or pressure based sleep data. The non-bed sleep data 1316 can use other sources of data to calculate sleep metrics. User-entered preferences, light sensor readings, and sound sensor readings can be used to track sleep data. User presence can also be determined from a combination of raw bed sensor data 1314 and non-bed sleep data 1316 (e.g., raw temperature data gathered from a peripheral device on a nightstand by the bed). Sometimes, bed presence can be determined using only the temperature data. Changes in temperature data can be monitored to determine bed presence or absence in a temporal interval (e.g., window of time) of a given duration. The temperature and/or pressure data can also be combined with other sensing modalities or motion sensors that reflect different forms of movement (e.g., load cells) to accurately detect user presence. Sometimes, bed presence can be determined using only the load cell data. In other instances, data from two or more sensors can be used to determine bed presence. For example, the temperature and/or pressure data can be provided as input to a bed presence classifier, which can determine user bed presence based on real-time or near real-time data collected at the bed. The classifier can be trained to differentiate the temperature data from the pressure data, identify peak values in the temperature and pressure data, and generate a bed presence indication based on correlating the peak values. The peak values can be within a threshold distance from each other to then generate an indication that the user is in the bed. An index or indexes stored by the service 410b can identify users associated with sensors and/or the data 1316.

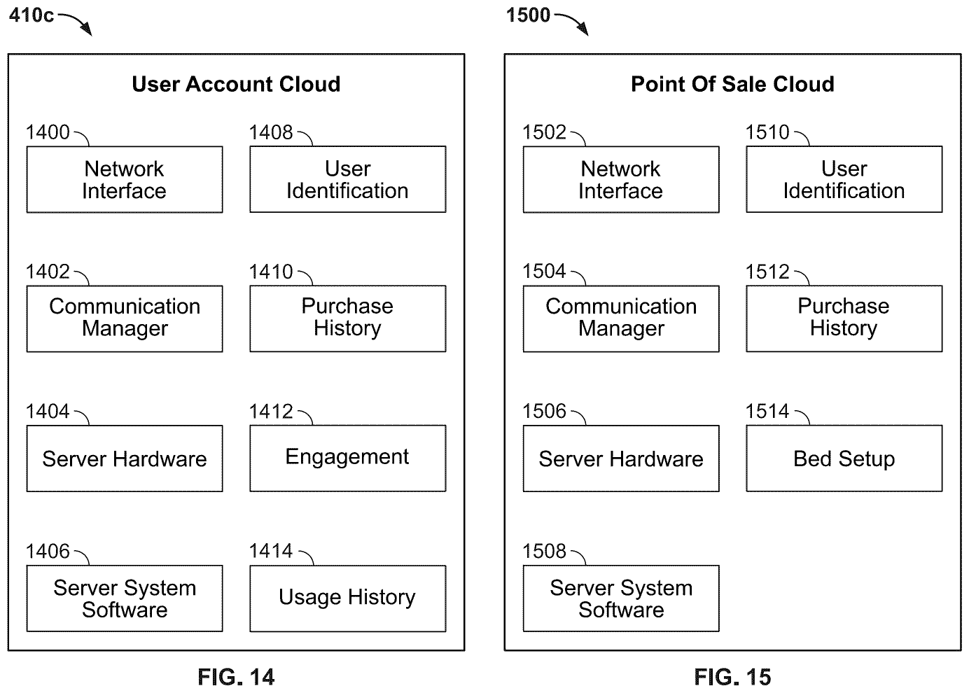

FIG. 14 is a block diagram of an example user account cloud service 410c used in a data processing system associated with a bed system. Here, the service 410c is configured to record a list of users and to identify other data related to those users. The service 410c includes a network interface 1400, a communication manager 1402, server hardware 1404, and server system software 1406. The service 410c also includes a user identification module 1408, a purchase history module 1410, an engagement module 1412, and an application usage history module 1414.

The user identification module 1408 can include, or reference, data related to users of beds with associated data processing systems, as described above. The purchase history module 1410 can include, or reference, data related to purchases by users. The purchase data can include a sale's contact information, billing information, and salesperson information associated with the user's purchase of the bed system. An index or indexes stored by the service 410c can identify users associated with a bed purchase.

The engagement module 1412 can track user interactions with the manufacturer, vendor, and/or manager of the bed/cloud services. This data can include communications (e.g., emails, service calls), data from sales (e.g., sales receipts, configuration logs), and social network interactions. The data can also include servicing, maintenance, or replacements of components of the user's bed system. The usage history module 1414 can contain data about user interactions with applications and/or remote controls of the bed. A monitoring and configuration application can be distributed to run on, for example, computing devices 412 described herein. The application can log and report user interactions for storage in the application usage history module 1414. An index or indexes stored by the service 410c can also identify users associated with each log entry. User interactions stored in the module 1414 can optionally be used to determine or predict user preferences and/or settings for the user's bed and/or peripheral devices that can improve the user's overall sleep quality.

FIG. 15 is a block diagram of an example point of sale cloud service 1500 used in a data processing system associated with a bed system. Here, the service 1500 can record data related to users' purchases, specifically purchases of bed systems described herein. The service 1500 is shown with a network interface 1502, a communication manager 1504, server hardware 1506, and server system software 1508. The service 1500 also includes a user identification module 1510, a purchase history module 1512, and a bed setup module 1514.

The purchase history module 1512 can include, or reference, data related to purchases made by users identified in the module 1510, such as data of a sale, price, and location of sale, delivery address, and configuration options selected by the users at the time of sale. The configuration options can include selections made by the user about how they wish their newly purchased beds to be set up and can include expected sleep schedule, a listing of peripheral sensors and controllers that they have or will install, etc.

The bed setup module 1514 can include, or reference, data related to installations of beds that users purchase. The bed setup data can include a date and address to which a bed is delivered, a person who accepts delivery, configuration that is applied to the bed upon delivery (e.g., firmness settings), name(s) of bed user(s), which side of the bed each user will use, etc. Data recorded in the service 1500 can be referenced by a user's bed system at later times to control functionality of the bed system and/or to send control signals to peripheral components. This can allow a salesperson to collect information from the user at the point of sale that later facilitates bed system automation. Sometimes, some or all aspects of the bed system can be automated with little or no user-entered data required after the point of sale. Sometimes, data recorded in the service 1500 can be used in connection with other, user-entered data.

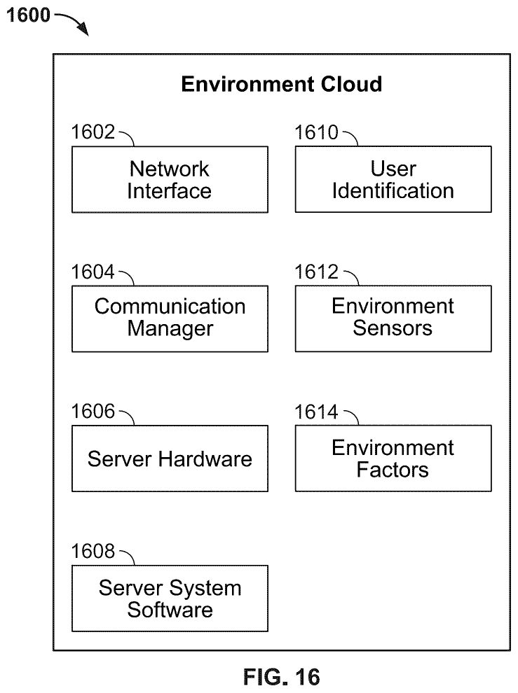

FIG. 16 is a block diagram of an example environment cloud service 1600 used in a data processing system associated with a bed system. Here, the service 1600 is configured to record data related to users' home environment. The service 1600 includes a network interface 1602, a communication manager 1604, server hardware 1606, and server system software 1608. The service 1600 also includes a user identification module 1610, an environmental sensors module 1612, and an environmental factors module 1614. The environmental sensors module 1612 can include a listing and identification of sensors that users identified in the module 1610 to have installed in and/or surrounding their bed (e.g., light, noise/audio, vibration, thermostats, movement/motion sensors). The module 1612 can also store historical readings or reports from the environmental sensors. The module 1612 can be accessed at a later time and used by one or more cloud services described herein to determine sleep quality and/or health information of the users. The environmental factors module 1614 can include reports generated based on data in the module 1612. For example, the module 1614 can generate and retain a report indicating frequency and duration of instances of increased lighting when the user is asleep based on light sensor data that is stored in the environment sensors module 1612.

In the examples discussed here, each cloud service 410 is shown with some of the same components. These same components can be partially or wholly shared between services, or they can be separate. Sometimes, each service can have separate copies of some or all the components that are the same or different in some ways. These components are provided as illustrative examples. In other examples, each cloud service can have different number, types, and styles of components that are technically possible.

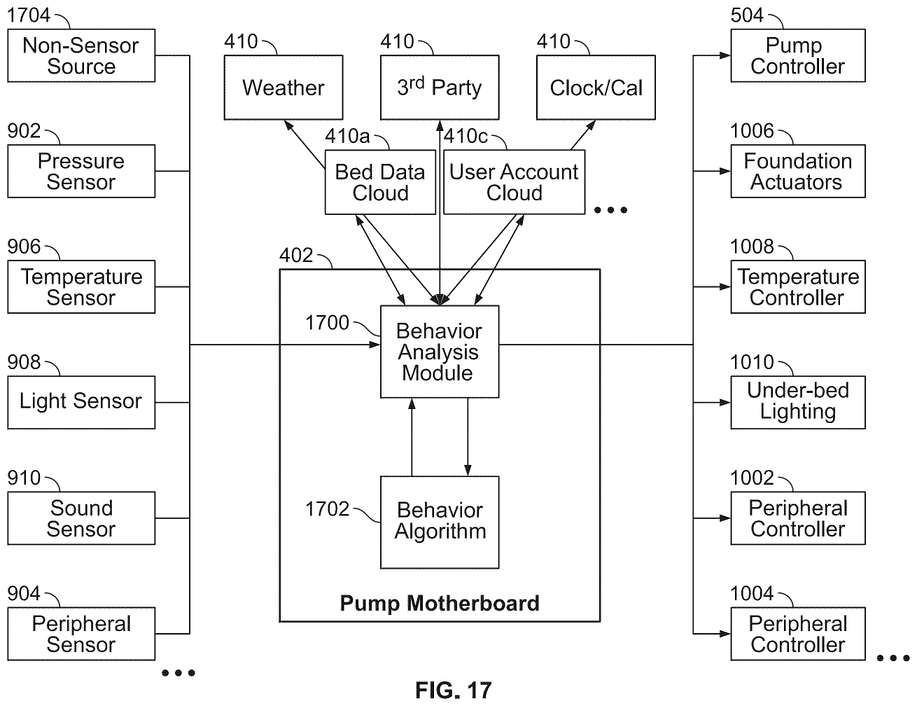

FIG. 17 is a block diagram of an example of using a data processing system associated with a bed to automate peripherals around the bed. Shown here is a behavior analysis module 1700 that runs on the motherboard 402. The behavior analysis module 1700 can be one or more software components stored on the computer memory 512 and executed by the processor 502. In general, the module 1700 can collect data from a variety of sources (e.g., sensors 902, 904, 906, 908, and/or 910, non-sensor local sources 1704, cloud data services 410a and/or 410c) and use a behavioral algorithm 1702 (e.g., machine learning model(s)) to generate actions to be taken (e.g., commands to send to peripheral controllers, data to send to cloud services, such as the bed data cloud 410a and/or the user account cloud 410c). This can be useful, for example, in tracking user behavior and automating devices in communication with the user's bed.

The module 1700 can collect data from any technologically appropriate source (e.g., sensors of the sensor array 406) to gather data about features of a bed, the bed's environment, and/or the bed's users. The data can provide the module 1700 with information about a current state of the bed's environment. For example, the module 1700 can access readings from the pressure sensor 902 to determine air chamber pressure in the bed. From this reading, and potentially other data, user presence can be determined. In another example, the module 1700 can access the light sensor 908 to detect the amount of light in the environment. The module 1700 can also access the temperature sensor 906 to detect a temperature in the environment and/or microclimates in the bed. Using this data, the module 1700 can determine whether temperature adjustments should be made to the environment and/or components of the bed to improve the user's sleep quality and overall comfort. Similarly, the module 1700 can access data from cloud services to make more accurate determinations of user sleep quality, health information, and/or control the bed and/or peripheral devices. For example, the behavior analysis module 1700 can access the bed cloud service 410a to access historical sensor data 1212 and/or advanced sleep data 1214. The module 1700 can also access a weather reporting service, a 3^{rd} party data provider (e.g., traffic and news data, emergency broadcast data, user travel data), and/or a clock and calendar service. Using data retrieved from the cloud services 410, the module 1700 can accurately determine user sleep quality, health information, and/or control of the bed and/or peripheral devices. Similarly, the module 1700 can access data from non-sensor sources 1704, such as a local clock and calendar service (e.g., a component of the motherboard 402 or of the processor 502). The module 1700 can use this information to determine, for example, times of day that the user is in bed, asleep, waking up, and/or going to bed.

The behavior analysis module 1700 can aggregate and prepare this data for use with one or more behavioral algorithms 1702 (e.g., machine learning models). The behavioral algorithms 1702 can be used to learn a user's behavior and/or to perform some action based on the state of the accessed data and/or the predicted user behavior. For example, the behavior algorithm 1702 can use available data (e.g., pressure sensor, non-sensor data, clock and calendar data) to create a model of when a user goes to bed every night. Later, the same or a different behavioral algorithm 1702 can be used to determine if an increase in air chamber pressure is likely to indicate a user going to bed and, if so, send some data to a third-party cloud service 410 and/or engage a peripheral controller 1002 or 1004, foundation actuators 1006, a temperature controller 1008, and/or an underbed lighting controller 1010.

Data described in this document can be organized into time periods that align with user behavior. For example, sensor data used as training data and for other purposes can be indexed by an associated sleep session. In some cases, sleep sessions are a period of time in which a user intends to, and does, sleep on the bed. For example, a user may go to bed at 10:00 PM on Monday, and awaken at 6:00 AM the next Tuesday by their alarm. In this case, a sleep session may be identified for this. The sleep session may be started when the user enters the bed (e.g., at 10:00 PM), when the user falls asleep (e.g., at 10:17 PM) as determined from sensor data, or at another time (e.g., Noon on Monday for a 24 hour sleep session). The sleep session may end when the user awakens (e.g., 6:00 AM), exits the bed (e.g., at 6:03 AM), or at another time (e.g., Noon on Tuesday for a 24 hour sleep session). As will be appreciated, many sleep sessions occur at night, spanning across two calendar days. However, other types of sleep sessions are possible. For example, a user that works an overnight shift, e.g., sleep from about Noon to about 8:00 PM every day, and thus their sleep session would be contained within a single calendar day. The particular delineations of the sleep sessions for a single user or a class of users can be identified based on user input (e.g., entering into a GUI their own sleep habits), automatically identified (e.g., without user input), or via another technologically appropriate process.

Here, the module 1700 and the behavioral algorithm 1702 are shown as components of the motherboard 402. Other configurations are also possible. For example, the same or a similar behavioral analysis module 1700 and/or behavioral algorithm 1702 can be run in one or more cloud services, and resulting output can be sent to the pump motherboard 402, a controller in the controller array 408, or to any other technologically appropriate recipient described throughout this document.

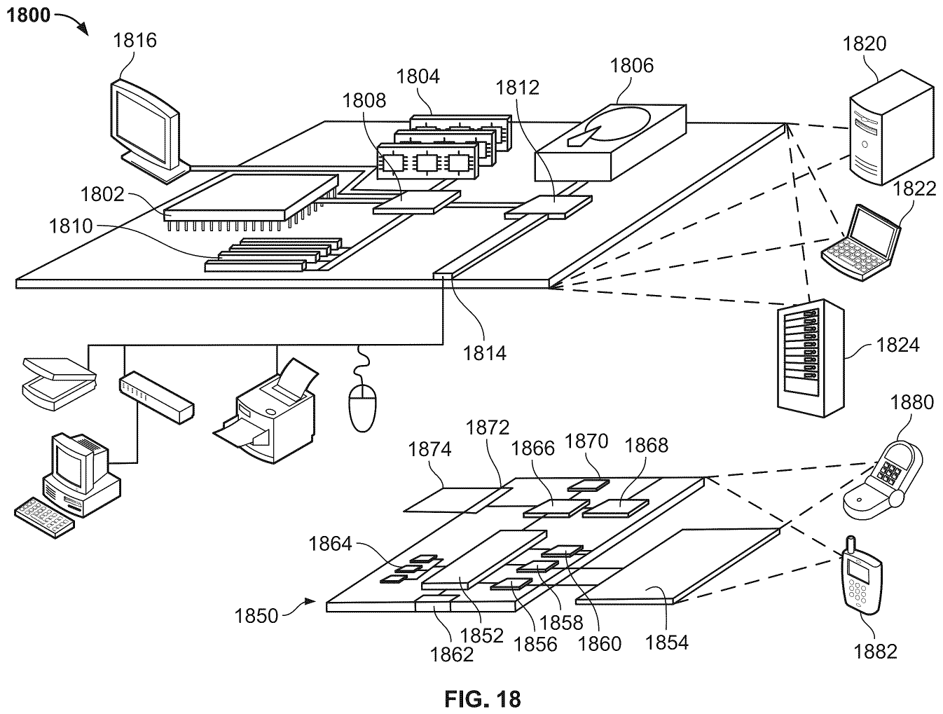

FIG. 18 shows an example of a computing device 1800 and an example of a mobile computing device that can be used to implement the techniques described here. The computing device 1800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and can be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system). The memory 1804 stores information within the computing device 1800. In some implementations, the memory 1804 is a volatile memory unit or units. In some implementations, the memory 1804 is a non-volatile memory unit or units. The memory 1804 can also be another form of computer-readable medium, such as a magnetic or optical disk. The storage device 1806 is capable of providing mass storage for the computing device 1800. In some implementations, the storage device 1806 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 1804, the storage device 1806, or memory on the processor 1802.

The high-speed interface 1808 manages bandwidth-intensive operations for the computing device 1800, while the low-speed interface 1812 manages lower bandwidth-intensive operations. Such allocation of functions is exemplary only. In some implementations, the high-speed interface 1808 is coupled to the memory 1804, the display 1816 (e.g., through a graphics processor or accelerator), and to the high-speed expansion ports 1810, which can accept various expansion cards (not shown). In the implementation, the low-speed interface 1812 is coupled to the storage device 1806 and the low-speed expansion port 1814. The low-speed expansion port 1814, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. The computing device 1800 can be implemented in a number of different forms, as shown in the figure. For example, it can be implemented as a standard server 1820, or multiple times in a group of such servers. In addition, it can be implemented in a personal computer such as a laptop computer 1822. It can also be implemented as part of a rack server system 1824. Alternatively, components from the computing device 1800 can be combined with other components in a mobile device (not shown), such as a mobile computing device 1850. Each of such devices can contain one or more of the computing device 1800 and the mobile computing device 1850, and an entire system can be made up of multiple computing devices communicating with each other. The mobile computing device 1850 includes a processor 1852, a memory 1864, an input/output device such as a display 1854, a communication interface 1866, and a transceiver 1868, among other components. The mobile computing device 1850 can also be provided with a storage device, such as a micro-drive or other device, to provide additional storage. Each of the processor 1852, the memory 1864, the display 1854, the communication interface 1866, and the transceiver 1868, are interconnected using various buses, and several of the components can be mounted on a common motherboard or in other manners as appropriate.

The processor 1852 can execute instructions within the mobile computing device 1850, including instructions stored in the memory 1864. The processor 1852 can be implemented as a chipset of chips that include separate and multiple analog and digital processors. The processor 1852 can provide, for example, for coordination of the other components of the mobile computing device 1850, such as control of user interfaces, applications run by the mobile computing device 1850, and wireless communication by the mobile computing device 1850. The processor 1852 can communicate with a user through a control interface 1858 and a display interface 1856 coupled to the display 1854. The display 1854 can be, for example, a TFT (Thin-Film-Transistor Liquid Crystal Display) display or an OLED (Organic Light Emitting Diode) display, or other appropriate display technology. The display interface 1856 can comprise appropriate circuitry for driving the display 1854 to present graphical and other information to a user. The control interface 1858 can receive commands from a user and convert them for submission to the processor 1852. In addition, an external interface 1862 can provide communication with the processor 1852, so as to enable near area communication of the mobile computing device 1850 with other devices. The external interface 1862 can provide, for example, for wired communication in some implementations, or for wireless communication in other implementations, and multiple interfaces can also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 can also be provided and connected to the mobile computing device 1850 through an expansion interface 1872, which can include, for example, a SIMM (Single In Line Memory Module) card interface. The expansion memory 1874 can provide extra storage space for the mobile computing device 1850, or can also store applications or other information for the mobile computing device 1850. Specifically, the expansion memory 1874 can include instructions to carry out or supplement the processes described above, and can include secure information also. Thus, for example, the expansion memory 1874 can be provided as a security module for the mobile computing device 1850, and can be programmed with instructions that permit secure use of the mobile computing device 1850. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 1864, the expansion memory 1874, or memory on the processor 1852. In some implementations, the computer program product can be received in a propagated signal, for example, over the transceiver 1868 or the external interface 1862.

The mobile computing device 1850 can communicate wirelessly through the communication interface 1866, which can include digital signal processing circuitry where necessary. The communication interface 1866 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1868 using a radio-frequency. In addition, short-range communication can occur, such as using a Bluetooth, WiFi, or other such transceiver (not shown). In addition, a GPS (Global Positioning System) receiver module 1870 can provide additional navigation- and location-related wireless data to the mobile computing device 1850, which can be used as appropriate by applications running on the mobile computing device 1850. The mobile computing device 1850 can also communicate audibly using an audio codec 1860, which can receive spoken information from a user and convert it to usable digital information. The audio codec 1860 can likewise generate audible sound for a user, such as through a speaker, e.g., in a handset of the mobile computing device 1850. Such sound can include sound from voice telephone calls, can include recorded sound (e.g., voice messages, music files, etc.) and can also include sound generated by applications operating on the mobile computing device 1850. The mobile computing device 1850 can be implemented in a number of different forms, as shown in the figure. For example, it can be implemented as a cellular telephone 1880. It can also be implemented as part of a smart-phone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. The computing system can include clients and servers. A client and server are generally remote from each other and typically interact through a communication network. The relationship of client and server arises by virtue of computer programs running on the respective computers and having a client-server relationship to each other.

### Multi-Zone Climate Control

In some examples, a bed system is configured to provide multiple individually controllable temperature zones at a sleep surface of the bed system (e.g., at a top surface of a mattress). Each temperature zone can be activated to target individual body regions with active heating or cooling. In some examples, the temperature in each zone can be controlled to provide targeted heating, cooling, or a combination of heating and cooling to a portion of the sleep surface of the bed that corresponds to an expected region of a user's body on the sleep surface. The heating can occur through either conductive heating, convective heating (e.g., forced air) or one or more combinations thereof. In some examples, conductive heating includes fluid heating (e.g., moving warm fluid through tubes in the bed). Similarly, the temperature zones can be cooled using convective cooling (e.g., with ambient or conditioned air) conductive cooling, such as fluid cooling (moving cool water or other fluid through tubes in the bed). As discussed in more detail below, the number and arrangement of temperature zones with active heating and/or cooling can vary. In some examples, the arrangement of temperature zones is customizable. For example, the arrangement of temperature zones may be customized at the time or manufacturing or the heating elements may be configured such that an end user can move the heating elements. In some examples, a user selects a number of temperature controlled zones and/or an arrangement of temperature control zones while purchasing the mattress and the mattress is assembled according to the user's selections. In some examples, a user can access and move the heating elements to a desired arrangement.

Many of the examples are described with multi-layered foam mattresses. However, mattresses including other materials can also be used. Examples of materials including one or more coil springs, air chambers, spacer materials, and/or other suitable materials can be used for the mattress.

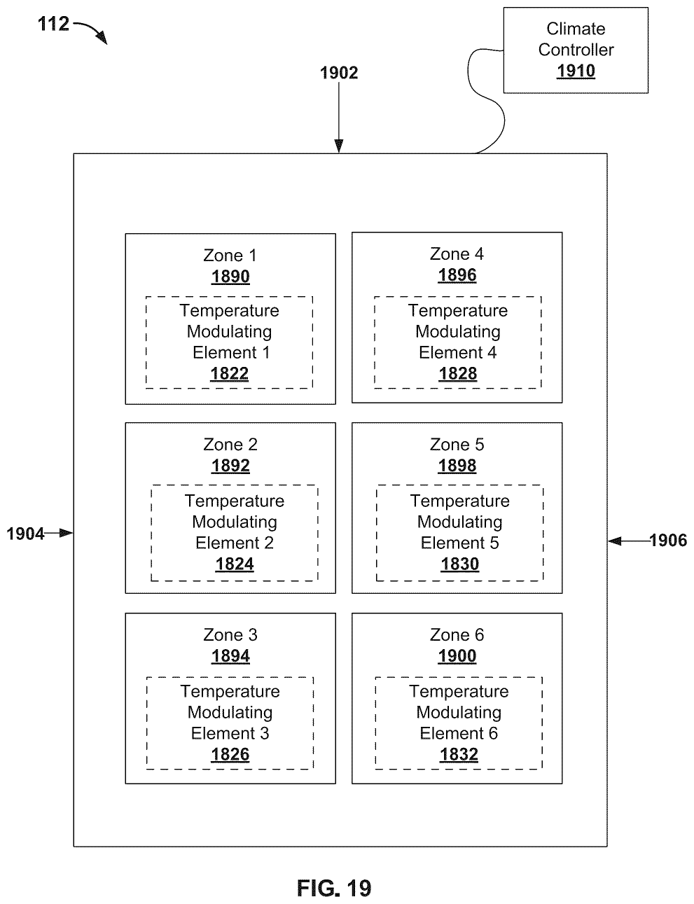

FIG. 19 illustrates an example bed 112 with multiple temperature zones (1890-1900). In the example shown, each of the multiple temperature zones provide heat to one or more users positioned on the bed 112 using a corresponding temperature modulating element (1822-1832). In some examples, each temperature modulating element 1822-1832 includes a cooling element, a heating element, or both a heating element and cooling element. In some examples, each temperature modulating element 1822-1832 is a single unit that can provide heating and cooling to a sleep surface of the bed 112. In some examples, the bed provides cooling and/or heating to one or more users positioned on the bed 112 at each of the multi temperature zones (1890-1900).

In the example shown, the bed 112 includes six temperature zones including temperature zone 1 1890, temperature zone 2 1892, and temperature zone 3 1894 on a first side 1904 of the bed 112 and temperature zone 4 1896, temperature zone 5 1898, and temperature zone 6 1900 on a second side 1906 of the bed. In the example shown, each of the temperature zones 1890-1900 include a corresponding temperature modulating element from the temperature modulating elements 1822-1832. The temperature modulating elements 1822-1832 are controlled by the climate controller 1910.

In some implementations, one or more of the temperature zones 1890-1900 can include one or more sub-zones within each temperature zone. For example, a temperature zone may include two sub-zones for targeting a left or right shoulder. In some examples, the entire bed can be cooled or heated and within the bed system individual regions can be targeted (e.g., regions corresponding to a back or shoulder of the user). For example, the entire bed may be cooled by drawing or pushing air from the sleep surface at the same time heat is applied at one or more of the temperature zones 1890-1900. In some examples, temperature zones may overlap. For example, a cooling zone may encompass two or more heating zones. Various other arrangements of overlapping heating and cooling zones can be implemented.

In some examples, the temperature modulating elements 1822-1832 include conductive heating elements. In some of these implementations, the heating elements are positioned under a comfort layer of the bed 112. In some of these examples, the comfort layer is a layer of foam. In other of these implementations, the heating elements can be embedded in the cover of the bed 112. In some implementations, the heating elements are positioned on top of the cover. For example, the one or more heating elements can be part of a secondary attachment pad that is placed on top of the mattress. The heating elements can be embedded in a foam comfort layer, on top of the foam cover layer, attached to the side of the cover, or on top of the cover, or combinations thereof. In some examples, the heating elements includes at least one heating unit and multiple fans to push heated air to a sleeper surface of the bed. In some examples, the heating elements are part of a fluid heating system (e.g., by moving warm water through different tubes in the bed corresponding to the different zones). In some examples, the heating elements can include different combinations of types of heating elements.

In some examples, the temperature modulating elements 1822-1832 include corresponding cooling elements. Conductive or convective cooling technologies can be used. In some examples, cooling and heating elements are included in the same unit.

Some examples include combinations of conductive heating elements and forced air elements. For example, the heating elements may be positioned such that there remains an open space between the heating element and the surrounding mattress layers to enable air flow. The open space allows for the integration of an active air flow system to deliver air to either heat or cool the sleep surface depending on a setting. In some examples, the heating elements are constructed using a breathable fabric/material to allow air to flow through the heating element. In some examples, pushed or pulled air flow can travel between or through the temperature zones to provide a cooling effect at the sleep surface of the bed 112. In some examples, this includes moving air through an open space in the mattress and/or through slot openings in the heating element that allows air to pass. In some examples, porous foam is used to allow for airflow through the bed 112. In some examples, the foam includes regions of increased porosity or ventilation to increase the ability for air to travel through the foam. In some examples, a sleeper can choose which temperature zones (1890-1900) they want heated and which zones they want cooled throughout different phases of the night. In some examples, sensors collect sleep data and train a model to automatically adjust the temperature zones to promote sleep. For example, heat can be applied near a neck region and a foot region to promote deep sleep.

The bed 112 can be configured for a first user on the first side 1904 and a second user on the second side 1906. In these examples, each temperature zone is configured to target different regions of one of the first user's body or the second user's body. For example, temperature zone 1 1890 can target an upper body region of the first user (e.g., targeting the upper back and shoulders of the first user), temperature zone 2 1892 can target a mid-body region of the first user (e.g., lower back, hips, and upper legs of the first user), and temperature zone 3 1894 can target a lower body region of the first user (e.g., knees, lower legs, and feet of the first user). Similarly, temperature zone 4 1896 can target an upper body region of the second user, temperature zone 5 1898 can target a mid-body region of the second user, and temperature zone 6 1900 can target a lower body region of the second user. In the example shown, the top portion adjacent to the top side 1902 of the bed 112 does not include the temperature zone (e.g., the portion of the bed where a user may place their head or a pillow). However, other examples may include a temperature zone that targets a head region of the users. In some examples, the temperature zones can be configured to be more or less targeted. For example, the temperature zones can be configured to just target a left shoulder or a right shoulder.

Other examples can include different arrangements of multiple temperature zones. For example, a bed can be designed for a single user and include two or more temperature zones. In another example, the bed can be designed with ten or more temperatures for each user to specifically target areas (e.g., a temperature zone to target a left shoulder of a user). Similarly, in the example shown each of the temperature zones 1890-1900 are the same size. However, in other examples, the temperature zones 1890-1900 can be different sizes (e.g., a smaller zone to target the shoulder region, a larger zone to target the mid-body region, and a medium sized zone to target the feet and legs). Other combinations, shapes, and arrangements are possible. In some examples, a user can customize the arrangement for their needs. For example, a user can determine which areas to position heating elements to provide a desired therapeutic treatment.

In some examples, the temperature modulating elements 1822-1832 are positioned within different layers depending on the region of the corresponding temperature zone 1890-1900. For example, temperature modulating elements 1826 and temperature modulating 1832 can be positioned at a layer closer to the sleeper surface as compared to the temperature modulating 1822, 1824, 1828, and 1830. That is, a shallow depth of the temperature modulating element 1832 may impact a sleeper's comfort less significantly at the user's feet (as compared to the other temperature modulating positioned near the expected upper and mid body regions of a user) so less foam may be needed between the heating element and the sleep surface. Other reasons including temperature modulating element durability and thermal impact of the temperature modulating technology may impact the depth of the temperature modulating elements 1822-1832.

The climate controller 1910 is configured to activate the temperature modulating elements 1822-1832 corresponding to the temperature zones 1890-1900. In some examples, the climate controller 1910 is configured to receive commands from a user device to activate/deactivate specific temperature modulating elements 1822-1832. In some examples, the climate controller 1910 is included within the control box 124 and can be controlled with the remote control 122 shown in FIGS. 1 and 2 with additional wiring to provide power to the temperature modulating elements 1822-1832. In some examples, the temperature modulating elements 1822-1832 are used to adjust the temperature of the corresponding temperature zone from an ambient temperature to approximately 100 degrees Fahrenheit. In other examples, the control can be set to limit the temperature provided to a different temperature such as 90 degrees Fahrenheit, 98 degrees Fahrenheit, 104 degrees Fahrenheit 106 degrees Fahrenheit, 110 degrees Fahrenheit, or other predetermined threshold temperatures. In some examples, the temperature is limited based on standard safety regulations or guidelines. In some examples, the temperature is limited by a temperature required or desired to provide a therapeutic treatment.

In some examples, the individually controllable temperature zones (1890-1900) are modulated to provide a therapeutic effect to a user. In some of these examples, the duration and routine of the heating and/or cooling can be adjusted to provide a desired therapeutic treatment. For example, heating treatment can be applied for twenty minutes followed by a cooling treatment being applied for twenty minutes before a second heating treatment is applied for another twenty minutes. Other durations and routines can be programmed to achieve the desired effect. In some examples, a user can adjust the routine and the duration of each treatment can be to provide a desired therapeutic effect. In some examples, the bed includes an adjustable base and the therapeutic routine includes raising or lowering different portions of the bed to provide a desired therapeutic effect. In some examples, the bed 112 includes a message feature which can be utilized in a therapeutic routine with or without the temperature modulation and the adjustment to the foundation of the bed.

The temperature modulating elements 1822-1832 can be designed and positioned in a manner that provides comfort to a user on the sleep surface of the bed 112. In some examples, the heating elements 1822-1832 are made of a fabric material that is flexible and therefore is comfortable to a user on the sleep surface. In some examples, the temperature modulating elements 1822-1832 are positioned underneath one or more layers of foam to enhance the comfort at the sleep surface of the bed 112. In some examples, the temperature modulating elements 1822-1832 may be positioned depending on an expected position of a sleeper on the mattress surface. For example, the temperature modulating element positioned near a user's feet is less likely to impact a sleeper's comfort as compared to a temperature modulating element at the sleeper's shoulders. Accordingly, the heater at the sleeper's feet may be positioned closer to the sleep surface of the bed than the temperature modulating element at the sleeper's shoulders.

In some examples, the bed 112 includes multiple heat zones that overlap one or more cooling zones. In some examples, each temperature zone 1890-1900 includes a heat zone over a corresponding cooling zone. In some examples, a heating element and a cooling element in the same zone can be activated at the same time to provide a desired effect to a user at the sleep surface. In some examples, the climate controller 1910 ensures that only one of the heating element or the cooling element in the same zone are activated at a given time. In some of these examples, the cooling element includes a fan that is configured to push and/or draw air from the sleeper surface and the controller prevents the fan from being activated while the heating element is activated as part of a fire protection mechanism. In some examples, the cooling element is a fan which is able to push air through and/or around the heating element. In some examples, additional sensors are used to control the and monitor the temperature inside and around the mattress when both, or one of, the heating element and fan are activated.

In some examples, each temperature modulating element 1822-1832 includes a temperature sensor (such as a thermistor) and corresponding closed loop circuitry to control the temperature modulating element. In some of these examples, when the temperature modulating element includes a heating element, the control circuitry is configured to drive the heating element to reach a set temperature. In some examples, the control circuitry includes safety mechanisms to shut down or limit the heating element when the temperature exceeds a threshold. Other safety mechanisms can be used. In some examples, the climate controller 1910 is used to monitor and shutdown the heating elements. In some examples, each of the heating elements include a first thermistor that operates with a closed loop control circuitry that controls the heating element to a set temperature and a second thermistor that operates with safety closed loop circuitry to provide a safety mechanism and/or shutdown mechanism.

In some examples, the multiple temperature zones use forced air heating, forced air cooling, or forced air cooling and heating. In some examples, one or more fans are used to provide heated, conditioned, ambient air, or any combination thereof to any combination of the temperature zones 1890-1900.

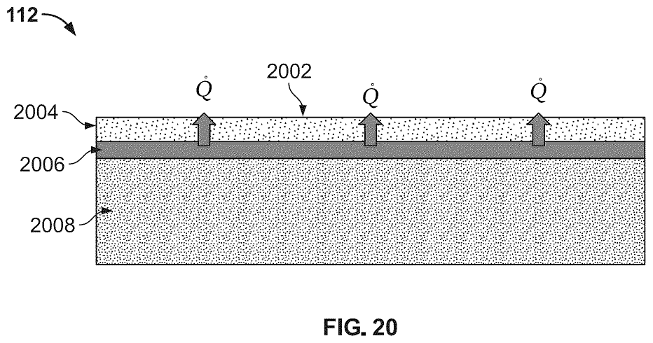

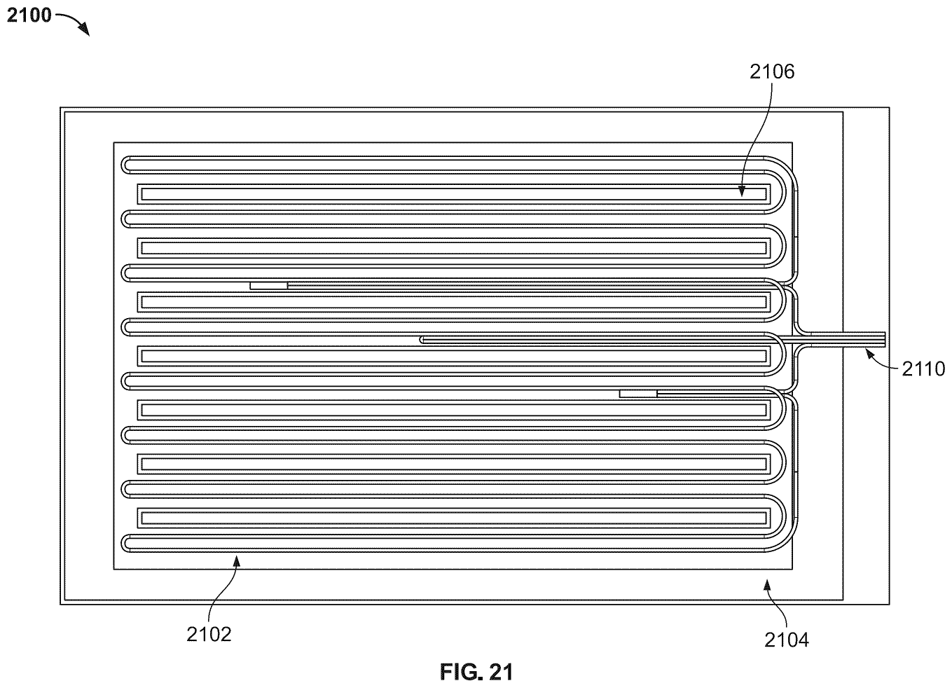

FIG. 20 illustrates a cross section view of an example bed 112 providing multiple temperature zones. In the example shown, the heat generation layer 2006 is positioned under a comfort layer 2004. The heat generating layer 2004 can include resistive electrical heaters or thermoelectric devices. The heat generation layer 2004 can include multiple heating elements (e.g., such as the heating element 2100 shown in FIG. 21) to provide heat to the individual temperature zones (e.g., such as the temperature zones 1890-1900 shown in FIG. 19). The heat generation layer 2006 is in direct contact with the comfort layer 2004 to promote heat to transfer to the sleep surface 2002 (e.g., the top surface of the comfort layer 2004 or on top of a mattress cover that at least partially surrounds the top surface of the comfort layer 2004) while maintaining the comfort of the sleep surface 2002.

In some examples, the comfort layer 2004 is made of a foam material. In some examples, the comfort layer 2004 is made of a polyurethane foam that allows for quick and efficient heat transfer from the heat generation layer 2006. The comfort layer 2004 can be constructed with numerous materials that enable and/or promote heat conduction to the sleep surface 2002 or to promote heat loss from the sleeper surface via passive cooling. Some implementations include an air distribution layer in fluid communication with a fan to provide active cooling by pushing or drawing air from the sleep surface 2002. The comfort layer 2004 layer can have holes that allow the air in the space to be warmed and passed to the sleeper through convection. The construction of the comfort layer 2004 can also consist of a single or multiple layers of foam. The density, thermal conductivity (e.g., through use of special additives such a nanoTek Ceramic), and airflow properties of the comfort layer 2004 can vary to provide a faster response time or increase in heating efficiency at the sleep surface 2002. Other materials, such as one or more coil springs, air chambers, spacer materials, and/or other suitable materials can be used for the comfort layer 2004.

The comfort/support layer(s) 2008 include one or more additional layers designed to provide the additional structure of the mattress and promote comfort. In some examples, the bed also includes air chambers. As discussed above, these layers can include multiple foam layers or layers made of different materials, such as one or more coil springs, air chambers, spacer materials, and/or other suitable materials.

FIG. 21 illustrates an example heating element 2100. The heating element 2100 includes a resistive wire 2102 that emits heat when a current is applied to the resistive wire 2102. In the example shown, the resistive wire 2102 is flexible and positioned to traverses across the heating element 2100 multiple times to increase the amount of heat emitted from the heating element 2100 in a given region, define the area the heat is emitted from the heating element 2100, and to increase the speed that the heat is transferred from the heating element 2100 to the sleep surface. The resistive wire 2102 is integrated (e.g., embedded, sealed, or laminated) with a semi-rigid material (e.g., ardmel) that maintains the heating element in a relatively flat shape (to avoid unintentional cross over that could result in a hot spot) while providing flexibility so as to not be uncomfortable (or even noticeable) to a user at the sleep surface. The rigidity of the material ensures safety of the heating element (e.g., by making it difficult or impossible for the heating element 2100 to roll causing a hotspot within the bed). In the example shown, the semi-rigid material defines a rectangular shape. In some examples, the rigid material is ardmel. The heating element can be formed in different shapes including squares, circles, triangles, ovals, rhombuses, or combinations thereof.

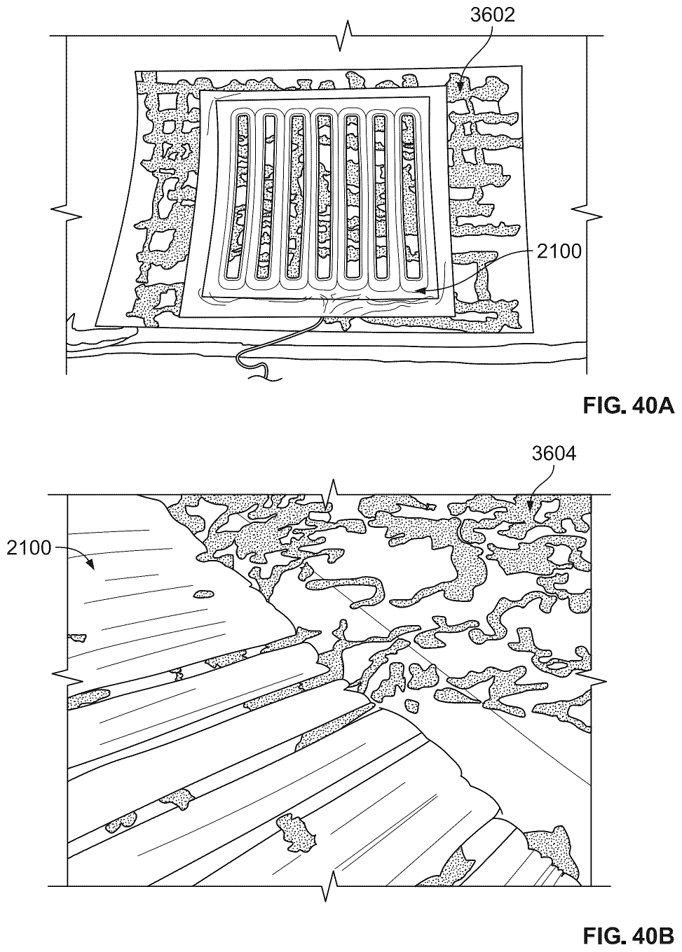

In the example shown, the heating element 2100 includes slots 2106. In some examples, the slots 2106 provide openings through heating element 2100 and can make the heating element 2100 more flexible thereby improving comfort of the bed. In some examples, the additional flexibility improves the comfort thereby allowing for the use of a thinner comfort layer 2004 between the sleep surface and the heating element 2100. In one non-limiting example, a one inch comfort layer 2004 can be used because of the additional flexibility instead of a two inch comfort layer 2004. The thinner comfort layer 2004 can allow for faster and more efficient heating of the temperature zones at the sleep surface 2002. In some examples, the slots 2106 allow air flow for a lower layer in the bed (e.g., an air distribution layer connected to a fan configured to push air to the sleeper surface or to draw air from the sleeper surface). This can also be used to allow the bed to provide both cooling and heating at the sleeper surface. In some examples, forced air is used with the heating element 2100 to increase the speed of heating the sleep surface 2002. In some examples, the heating element 2100 is embedded between two layers of foam and the slots 2106 to allow for foam-to-foam adhesion of two layers of foam in the slots 2106, for example as shown in FIGS. 40A-B. The foam to foam adhesion between the slots 2106 provides further structure which reduces or eliminates the risk of the resistive wire 2102 overlapping and causing a hotspot.

In some examples, the heating element 2100 includes an over current/voltage detector and is configured to automatically stop the current applied to the resistive wire 2102 when overvoltage and/or over current is detected. In some examples, the heating element 2100 is configured to automatically shut off power if wires cross. In some examples, the heating element 2100 includes a temperature sensor (such as a thermistor) and is configured to automatically shut off if the detected temperature exceeds a threshold temperature.

The heating element 2100 includes a connector 2110 configured to attach the resistive wire 2102 to a power source. The power source via the connector 2110 to apply power to the resistive wire 2102 to generate heat.

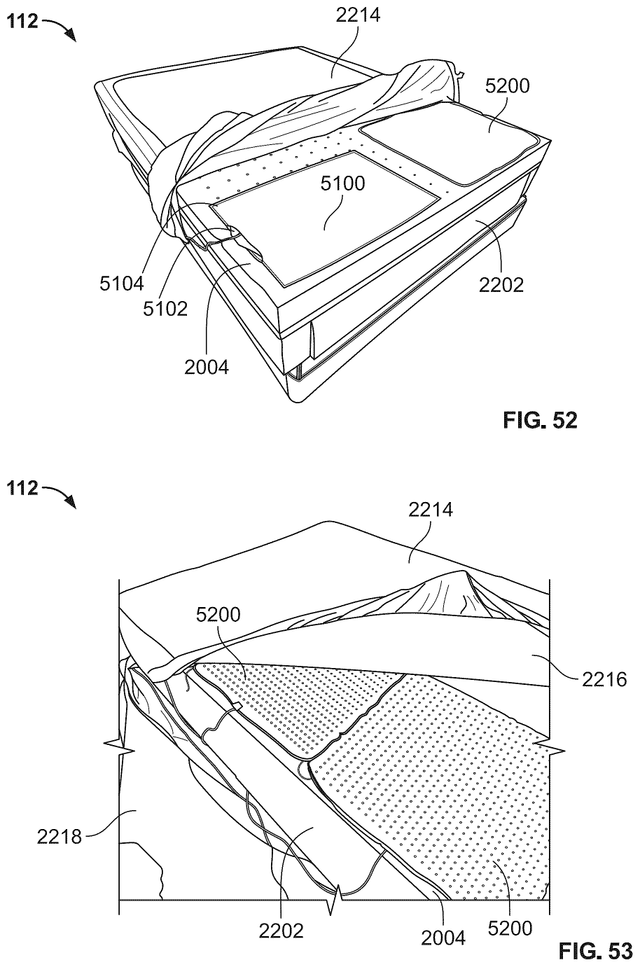

In some embodiments, the heating element 2100 can be substantially accordion-shaped. For example, the resistive wire 2102 can have multiple parallel segments each attached by a curved segment. In some examples, the semi-rigid material includes at least one open slot between a first parallel segment of the resistive wire and an adjacent second parallel segment of the resistive wire. In some examples, the resistive wire 2102 traverses across the heating element 2100 twice between each of the slots 2106. Any suitable shape for heating element 2100 may be used. Various protection materials placed over the heating elements may be used to provide a fire resistive effect (e.g., flame resistant (FR) cap 2214 illustrated in FIGS. 52-53).

In some examples, the heating element 2100 includes a current detector to detect a current in the resistive wire. The heating element 2100 stops applying power to the resistive wire when the current detected in the resistive wire exceeds a shutdown current threshold. For example, the heating element 2100 can use a controller to stop applying power to the restive wire, switch to stop the current, or a circuit breaker.

In some examples, the heating element 2100 includes a voltage detector configured to detect a voltage across at least a portion of the resistive wire 2102. The heating element 2100 can halt the application of power to the resistive wire 2102 when the voltage detected across the resistive wire 2102 exceeds a shutdown voltage threshold. For example, a controller can be used to stop applying power to the resistive wire 2102, switch to stop the current through the resistive wire 2102, or a circuit breaker.

In some examples, the heating element 2100 includes a temperature sensor. The heating element 2100 can stop applying power or reduce the amount of power applied to the resistive wire 2102 when a temperature detected at the temperature sensor exceeds a shutdown temperature threshold. For example, a controller can be used to stop or reduce the power applied to the resistive wire 2102, switch to stop the current through the resistive wire 2102, or a circuit breaker.

In some examples, a different conductive material is used instead of the resistive wire 2102. For example, a conductive carbon material could be used. In some examples, busbar material is used.

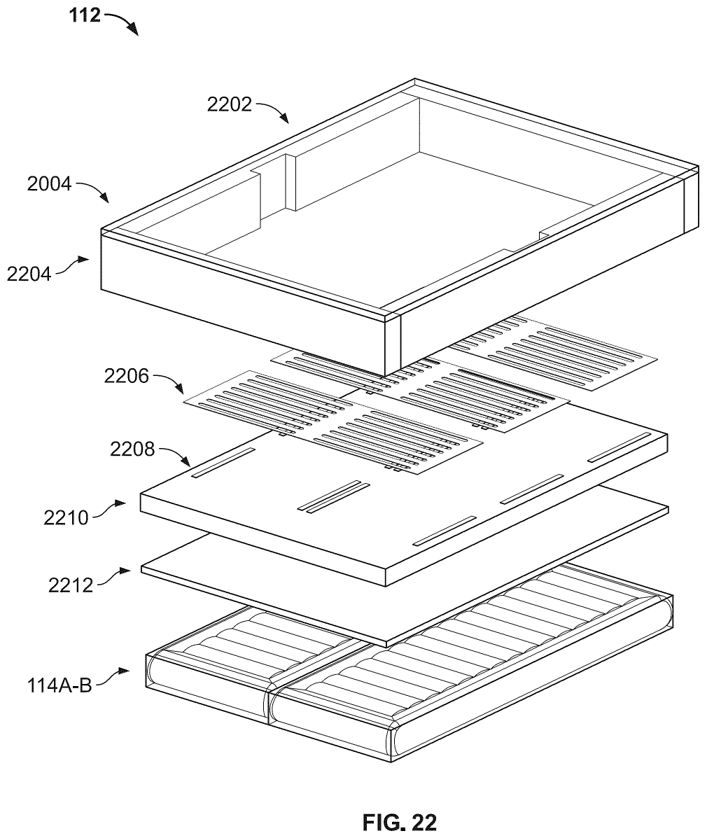

FIG. 22 illustrates an example bed 112 with multiple heating elements 2206. The bed 112 can be part of the bed system 100 illustrated in FIG. 1. The bed 112 can be configured with other bed systems and/or mattresses described herein.

The bed 112 may include a foam tub assembly 2202. The foam tub assembly 2202 (sometimes referred to as a foam tub assembly layer) includes a comfort layer 2004 and rail foam 2204. The rail foam 2204 can include a head rail, a foot rail, in addition to first and second side rails. In the example shown, the comfort layer 2004 is attached directly to the rail foam 2204. In some examples, the comfort layer 2004 may be attached to a support layer. The comfort layer 2004 provides a sleep surface (typically indirectly with at least a mattress cover between the top surface of the comfort layer 2004 and the user). The foam tub assembly 2202 can house the air chambers 114A and 114B, the support layer 2212 and an inner comfort layer 2210 (as part of a comfort/support layer), and heating elements 2206. The heating elements 2206 are part of a heat generation layer that provides multiple independent temperature zones at the sleep surface. Other materials, such as one or more coil springs, air chambers, spacer materials, and/or other suitable materials can be used for at least one of the comfort layer 2004, the rail foam 2204, inner comfort layer 2210, support layer 2212, and the air chambers 114A-B. In some examples, the bed 112 does not include perimeter rails and the materials of the bed travel to the edge of the bed 112 to provide the structure of the bed 112.

In the example shown, the heating elements 2206 are positioned to provide conductive heat through the comfort layer 2004 to the sleep surface. For example, this is shown in FIG. 20. The heating elements 2206 are attached to the inner comfort layer 2210 via hook and loop connectors 2208. In some examples, the heating element 2206 is attached to the comfort layer 2004. The heating element 2206 can be attached, in different embodiments to either side of either the comfort layer 2004 or the inner comfort layer 2210 via an adhesive, sleeve, or other connector. The bed 112 can have a modular design that can accommodate different preferences based on the specific bed model and application. For example, the thickness of the comfort layer 2004 at the sleeper surface can vary from 0.25″ to 4″ depending on the application and surface heat required. The heating elements 2206 are installed in the inside of the foam tub assembly 2202 while the tub is upside down and between the inner comfort layer 2210 and the comfort layer 2004 for a consistent, complete surface layer of foam with no gaps or separation points which could interrupt sleeper comfort.

In the example shown, the heating elements 2206 are configured to have a zone at the feet, hips, and shoulders regions (e.g., as shown in FIG. 19). However, other arrangements can also be used. For example, any number of heating elements 2206 on one or both sleep sides of the bed 112. For example, some implementations can include a single heating element for two sleepers feet (e.g., across the entire foot region of the sleep surface) and individual heating elements for each user's hips and shoulders. In some examples, the temperature zones are different for each user (e.g., one arrangement of heating elements 2206 for a first user on a first side of the bed 112 and another arrangement of heating elements 2206 for a second user on a second side of the bed 112. For example, the first user can have a heating element 2206 at the shoulder region and foot region and the second user can only have a heating element 2206 at the foot region.

The heating elements 2206 can be attached to the inner comfort layer 2210 via hook and loop (e.g., hook and loop connectors 2208), adhesive, laminate or other methods. The hook and loop connectors 2208 allow the heating elements 2206 to be removed or serviced without damaging the foam. The hook and loop connectors 2208 also allows the heating element 2206 to be moved and shifted within the system based on user preferences. For example, a side rail or comfort layer could be removed to allow the user to access and move the heating elements 2206.

In some examples, the thickness of the inner comfort layer 2210 can vary from 0.25″ to 12″ depending on the application. The support layer 2212 is added to provide a consistent feel to the surface of the sleeper at different air chamber 114A-B pressures. In some examples, the bed 112 allows for customization and the ability to have it assembled or disassembled for either service or manufacturing purposes.

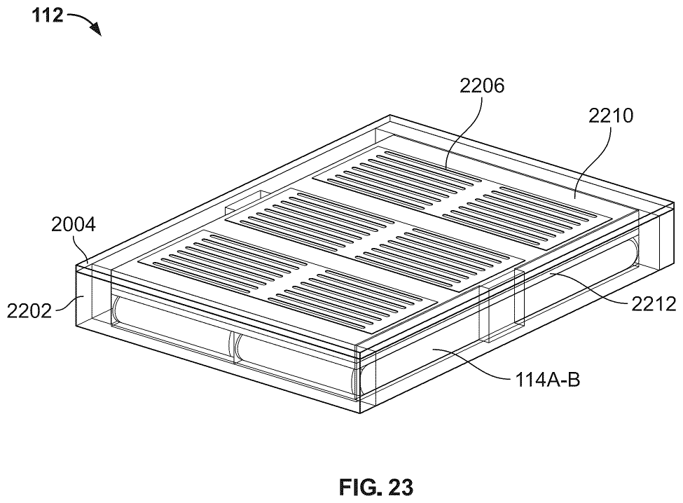

FIG. 23 illustrates the example of the bed 112 shown in FIG. 22 assembled. The bed 112 can be configured with other bed systems and/or mattresses described herein. As discussed above, in some examples the bed 112 allows for customizable heating elements which can be added or removed for the bed. In the example shown, the bed includes air chambers 114A-B, support layer 2212, heating elements 2206, an inner comfort layer 2210, comfort layer 2004, and a foam tub assembly 2202. In some examples, the bed can further include other components disclosed herein. Similarly, some of the components shown in FIG. 23 are not included in some implementations. For example, some implementations may not include the air chambers 114A-B and/or the foam tub assembly 2202.

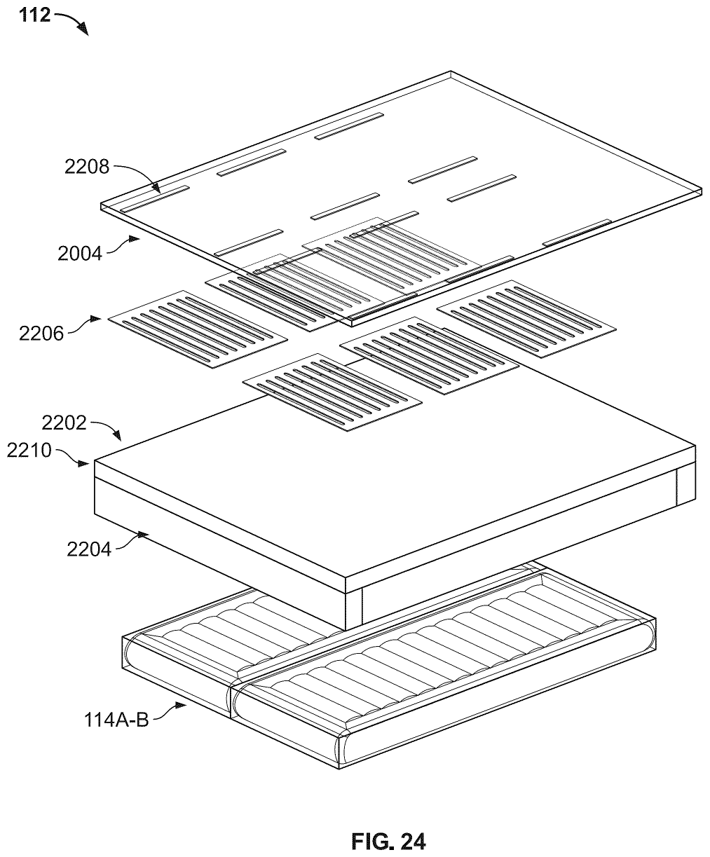

FIG. 24 illustrates another example bed 112 with multiple heating elements 2206. The bed 112 can be configured with other bed systems and/or mattresses described herein. In this example, the heating elements 2206 are attached to the comfort layer 2004 via the hook and loop connectors 2208. The heating elements 2206 provide conductive heat through the comfort layer 2004 to the sleep surface. In the example shown, the inner comfort layer 2210 is attached to the rail foam 2204 and the comfort layer 2004 is attached to the inner comfort layer 2210. In some examples, this allows easier access to the heater elements 2206 for maintenance, replacement, or customization.

The bed 112 includes a comfort layer 2004 with hook and loop connectors 2208 (or other connectors) that allows for the heating elements 2206 to be attached on the underside of the comfort layer 2004. In some examples, the heating elements 2206 can be attached to the inner comfort layer 2210. The bed 112 also includes a heat distribution layer with heating elements 2206 (configured to provide multiple individual temperature zones at the sleep surface). The bed 112 includes a foam tub assembly 2202 including an inner comfort layer 2210 connected to rail foam 2204, and air chambers 114A-B. In the example shown, the comfort layer 2004 attaches to the inner comfort layer 2210.

In some examples, the bed 112 allows for a modular design and full customization of the temperature zones by either adding or removing heating elements 2206 for different applications. In this implementation, the heating elements can be accessed from the top surface of the bed 112 (e.g., the sleep surface). In some examples, the heating elements are pre-attached to the comfort layer 2004 or applied during the manufacturing process while installing the comfort layer 2004. The comfort layer 2004 on the sleep surface can vary in thickness and properties depending on the application (e.g., the required heat at the sleeper surface). In some examples, the heating elements are instead attached to the inner comfort layer 2210.

In the example shown, the comfort layer 2004 is attached to the inner comfort layer 2210 and the inner comfort layer 2210 is attached to the rail foam 2204. In some examples, this allows the comfort layer 2004 to be removed to access the heating elements 2206. In some examples, the process for manufacturing the bed 112 includes attaching the inner comfort layer 2210 to the rail foam 2204 while the bed is upside down and the comfort layer 2004 and heating elements 2206 are installed while the mattress is upright.

FIG. 25 illustrates an example bed 112 with multiple heating elements 2506. The bed 112 can be configured with other bed systems and/or mattresses described herein. In the example shown, the bed 112 is upside down for illustrative purposes. The bed 112 includes a support layer 2212, thermal insert 2504, heating elements 2206, head comfort layer 2508, comfort layer 2004, rail foam 2204, and thermal insert comfort foam 2514.

In this example, the heating elements 2206 are included in heater sub-assembly layers 2506A and 2506B. The heater sub-assembly layers 2506A-B include comfort foam at least partially enclosing the heating elements 2206. In the example shown, the heater sub-assembly layer 2506A is positioned to target an upper body/shoulder region of the sleeper users and the heater sub-assembly layer 2506B is positioned to target a lower body region of the sleeper users.

The bed 112 includes a thermal insert 2504 configured to circulate air through the bed 112. The air can be ambient, conditioned or heated. The thermal insert 2504 is configured to interface with one or more fans 2510. In the example shown, the one or more fans are integrated within rail foam 2204 of the bed 112 at 2510. However, the fan 2510 can be positioned in other areas of the bed 112 or can be a unit of the bed system that is separate from the bed 112.

The head comfort layer 2508 and the thermal insert comfort foam 2514 are designed and positioned to enhance the comfort experienced by a user at the sleep surface. The head comfort layer 2508 and the thermal insert comfort foam 2514 can be designed to maintain a flat surface between the different layers of the bed 112.

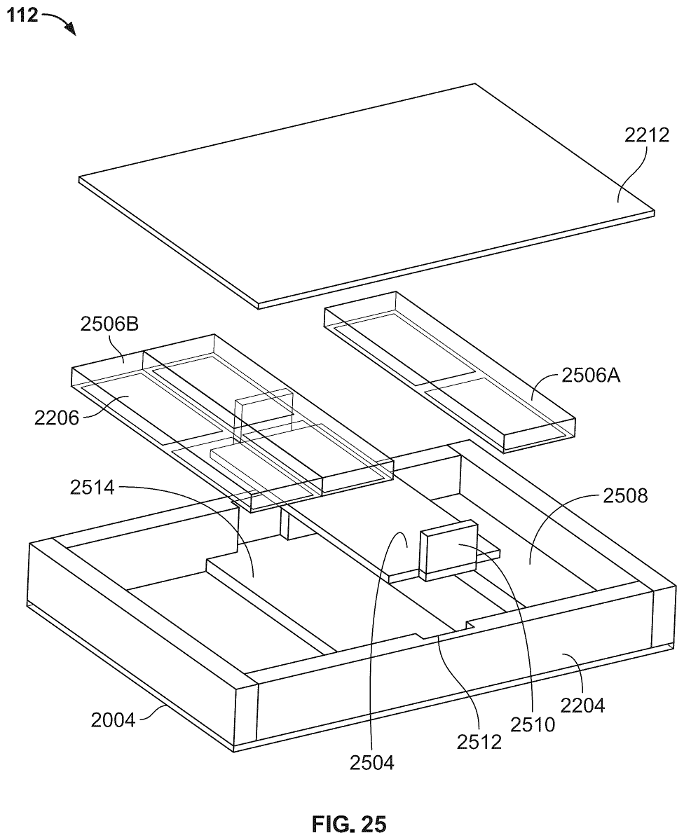

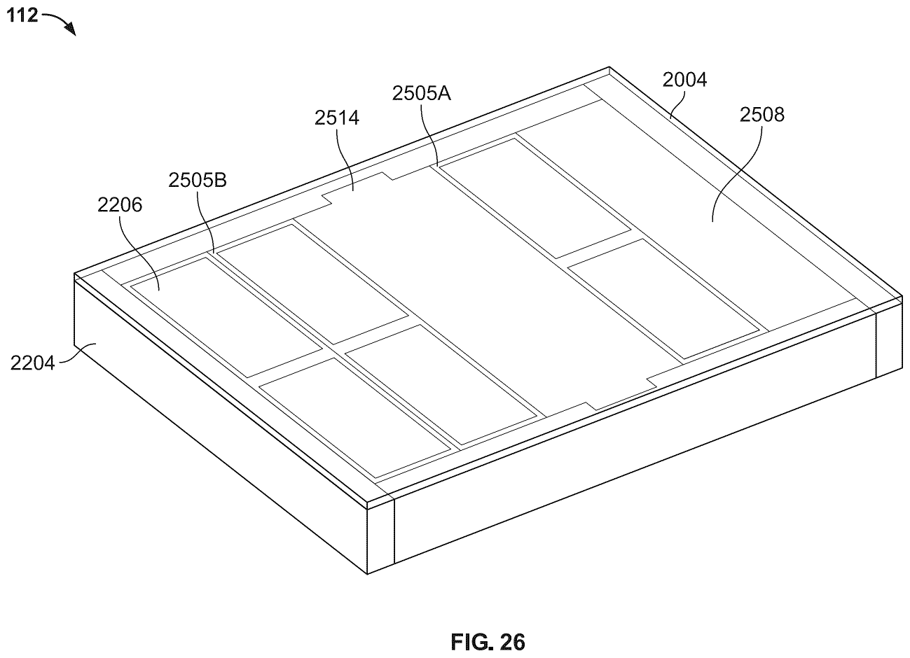

FIG. 26 illustrates the example of the bed 112 shown in FIG. 25 assembled. The bed 112 can be configured with other bed systems and/or mattresses described herein. In some examples, the bed 112 can include additional elements. In some examples, the bed 112 may not include all of the elements shown in FIG. 26. For example, some embodiments may not include the rail foam 2204.

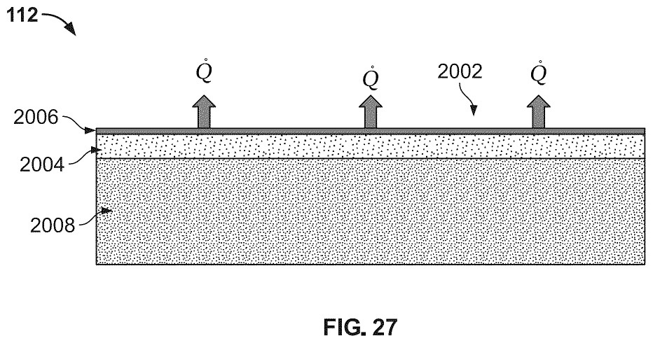

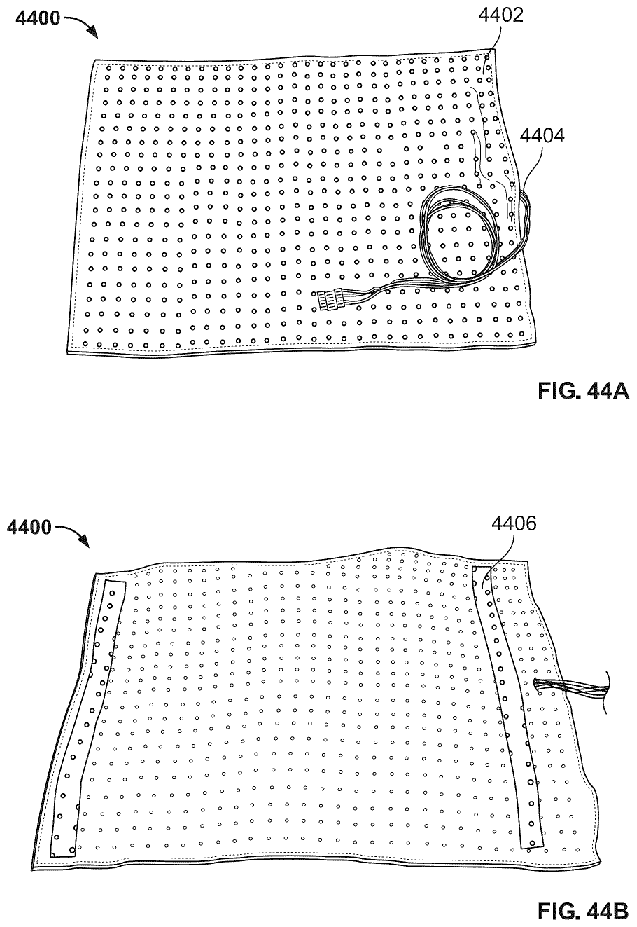

FIG. 27 illustrates a cross section view of an example bed 112 with multiple temperature zones. In this example, the heat generation layer 2006 is positioned on top of the comfort layer 2004. In some of these examples, the heat generation layer 2006 is placed above the comfort layer 2004 and beneath a cover (not shown) of the bed. The cover may include additional material to provide additional comfort to the sleep surface of the bed 112. In some of these examples, heating elements are integrated into a fabric sleeve or layer that are positioned directly on top of the comfort layer 2004. In other examples, the heating elements are attached to the cover of the bed 112. In some of these examples, the heating elements are sewn to the cover or the cover includes a pocket to receive the heating elements. In some examples, the heating elements are made of a flexible fabric material. For example, as illustrated and described in reference to FIGS. 44A-48.

In some examples, the heating elements are positioned in a foam pocket within the comfort layer 2004. For example, the comfort layer 2004 can include two layers of foam that are attached to each other with an adhesive or hook and loop connectors. In some examples, the two layers can be 1 inch, half an inch, three quarters of an inch or other combinations and/or other thicknesses. The adhesive or the hook and loop connectors are applied to the two foam layers such that multiple pockets are formed, where each pocket is shaped to receive a heating element. After the heating elements are positioned in the pockets the entire comfort layer 2004 can be laminated to the surface of the foam.

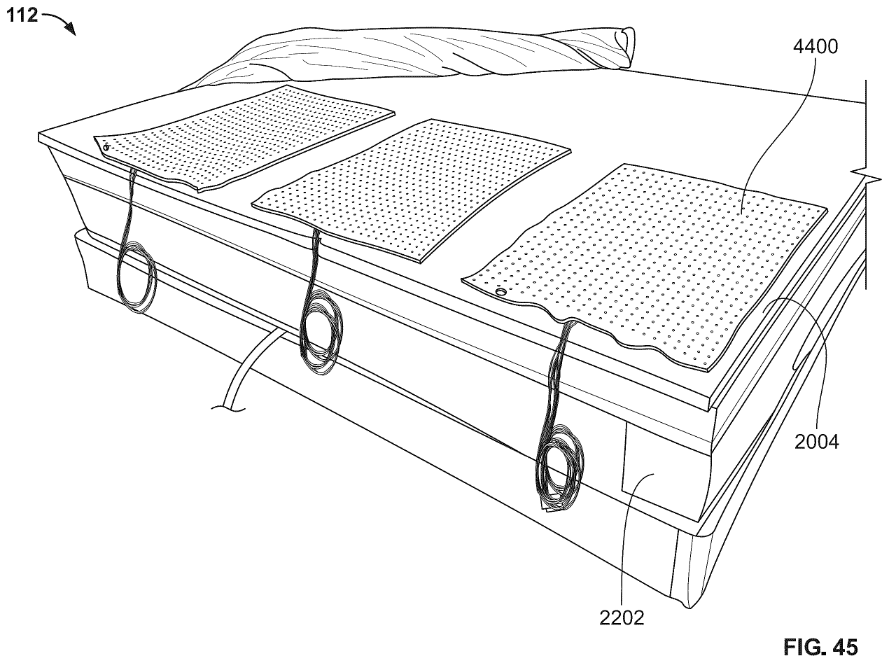

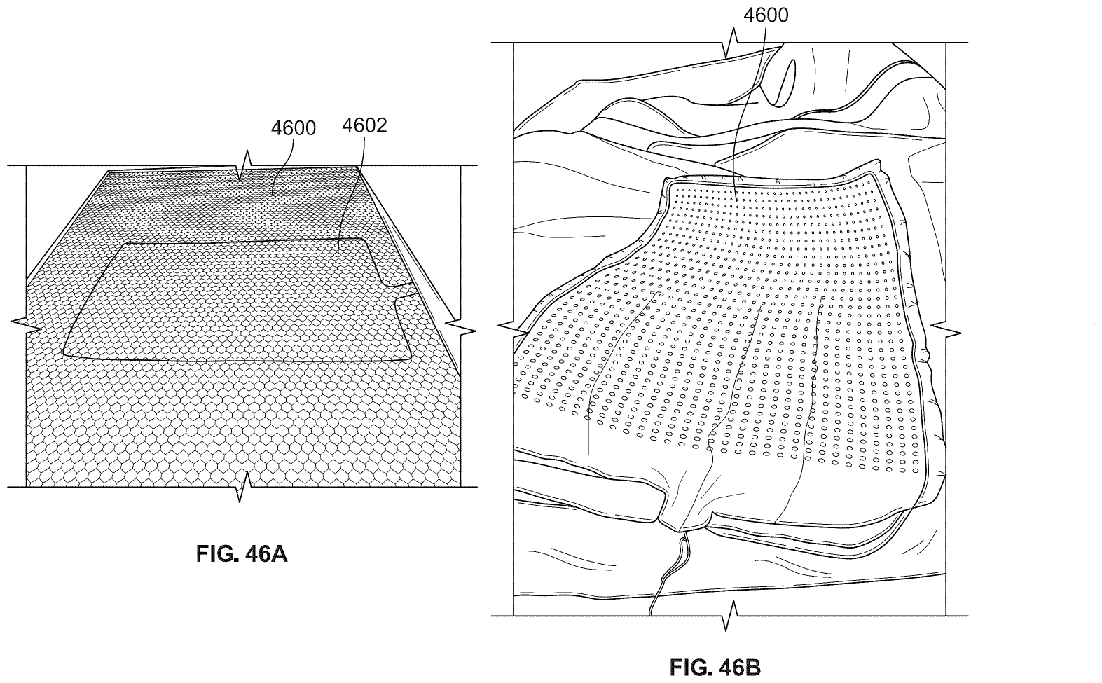

FIG. 28 illustrates an example bed 112 with multiple heating elements 2206. The bed 112 can be configured with other bed systems and/or mattresses described herein. The heating elements 2206 are integrated in the mattress cover 2802 (e.g., as shown in FIGS. 46A-B) that surrounds a foam tub assembly 2202 comprising a comfort layer 2004 and rail foam 2204. In some examples, the cover 2802 includes pockets on the inside to receive the heating elements 2206. The heating elements 2206 can be attached to the mattress cover 2802 using other attachment mechanisms such as adhesives, sewn, hook and loop connectors, other removable or permanent attachment mechanisms. In some examples, the mattress cover 2802 includes a thin layer of foam at least partially in between the layer where the heating elements 2206 are attached at the sleep surface to provide enhanced comfort. In some examples, the mattress cover 2802 includes a quilted pattern on the sleep surface. The arrangement of the heating elements 2206 can be customized and can be configured to allow the heating elements to be removed (e.g., for maintenance or replacement). The cover 2802 can be placed over any type of mattress. In some examples, the heating elements 2206 are made of a fabric material with attached conductive wiring (e.g., as shown in FIGS. 44A-48). In some examples, the wiring is attached to the fabric using ultrasonic welding.

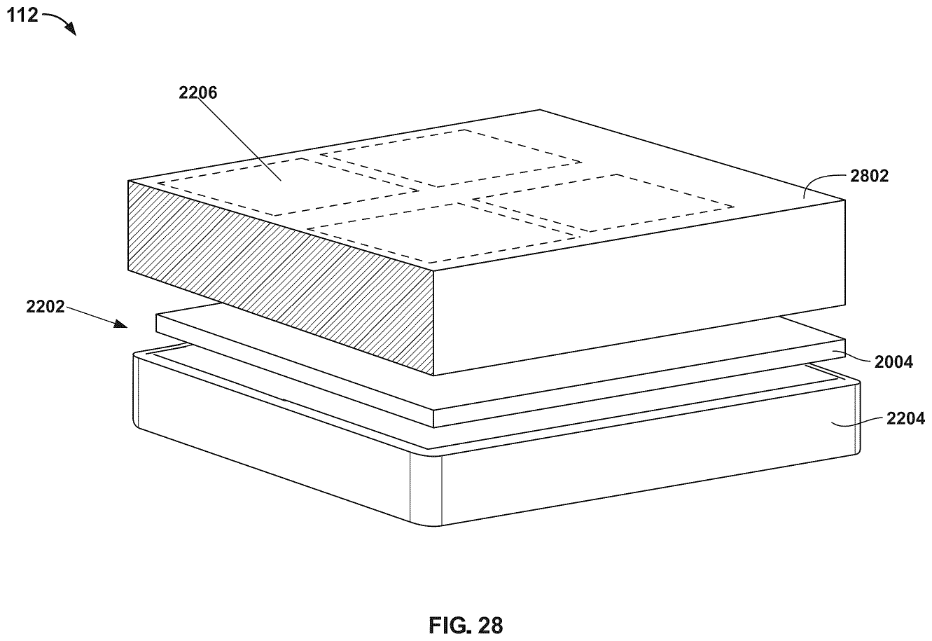

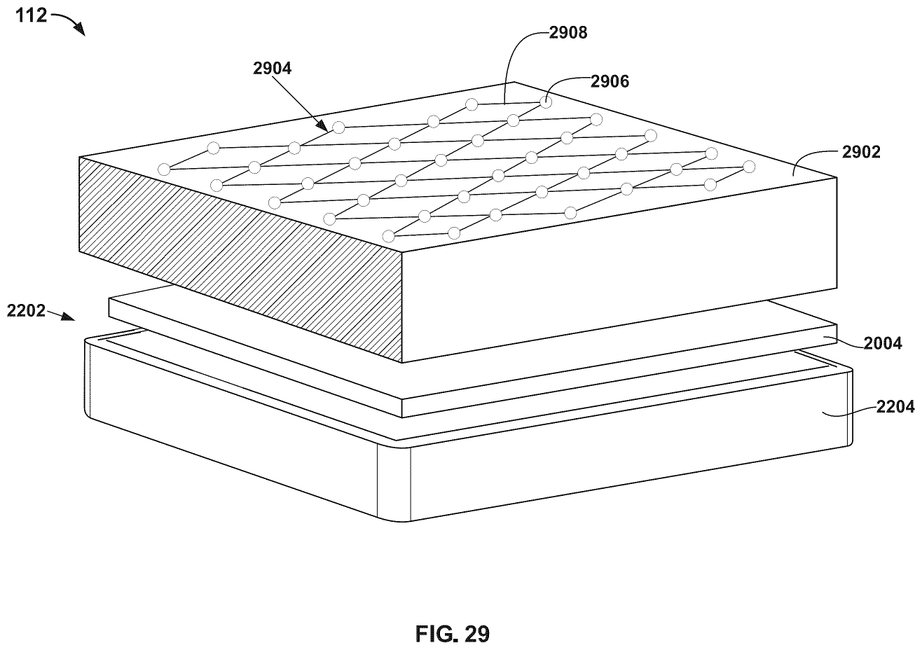

FIG. 29 illustrates an example bed 112 with a heating device 2904 configured to activate individual heating elements at different regions of a sleep surface. The heating device 2904 includes wires 2908 attaching a plurality of heating elements 2906. In some examples, the wire and heating elements are arranged and connected in a net like shape to cover a portion of the sleep surface of a bed. In some examples, each heating element 2906 can be individually activated. For example, a user can indicate with inputs on the app which regions they would like to heat (e.g., by a drawing a shape over a virtual mattress or the system may automatically select which inputs to activate based on an input indicating a heating effect desired by the user. In other examples, heating elements in adjacent regions are grouped and each group of heating elements are collectively activated. In some examples, the wires 2908 and the heating elements 2906 are attached to the cover 2902 using ultrasonic welding.

In some examples, the mattress cover 2902 includes a fabric and multiple heating wires embedded in the fabric of the mattress cover 2902 or attached using another technique. Each heating wire of the plurality of heating wires is configured to be individually activated by applying power to the heating wire to generate heat. In some examples, the multiple heating wires are ultrasonically welded to the mattress cover. In some examples, any combination of the plurality of heating wires can be activated at a given time.

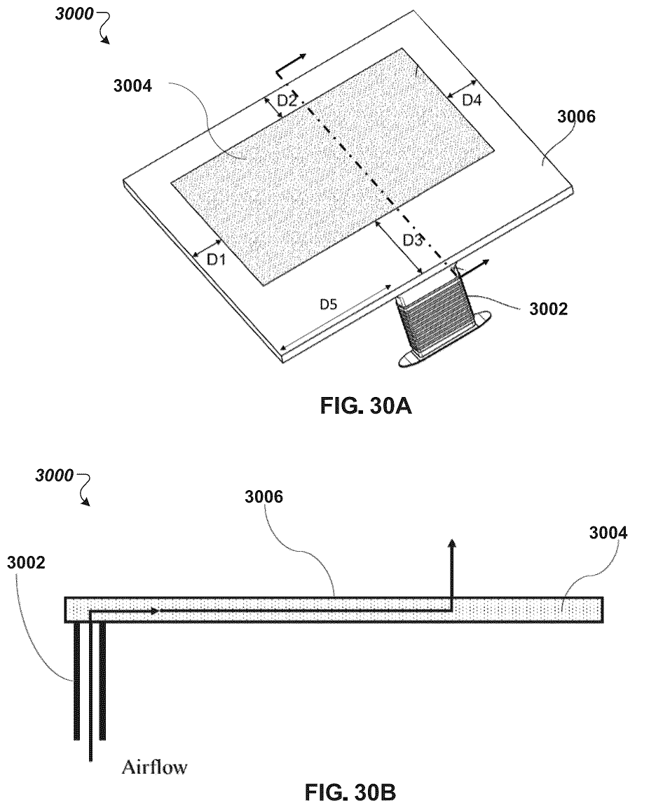

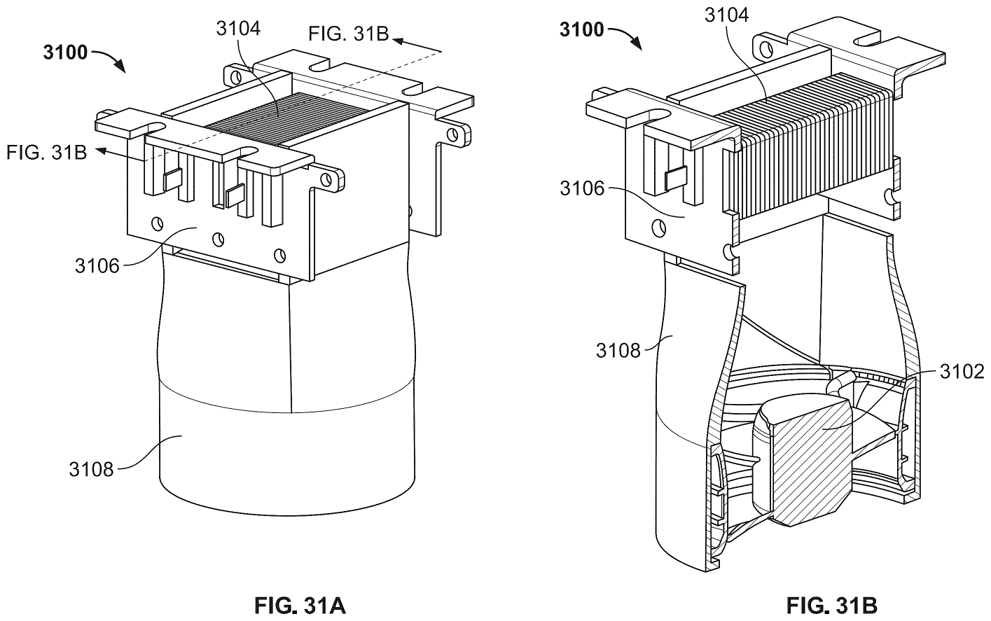

FIGS. 30A-31B relate to an example bed system with multiple temperature zones which uses multiple fan sub-assemblies 3100 to provide temperature control for multiple temperature zones at the sleep surface. In this example bed system, the bed includes an air distribution layer with multiple thermal inserts 3000 configured to distribute air through a sleeper surface of the bed. An example of a thermal insert 3000 is illustrated in FIG. 30A-B. Each thermal insert is in fluid communication with a fan sub-assembly 3100. An example of a fan sub-assembly 3100 is illustrated in FIGS. 31A-B. The fan sub-assembly 3100 is able to provide heating or cooling to the zones above to the connected thermal insert 3000.

As discussed above, each zone can be independently heated and/or cooled. The top layer of the bed can be a polyurethane foam with varying thickness options. In some examples, the top layer of the foam is heated using forced convective heating or convective heating combined with conductive heating. The bed includes an integrated distribution layer to deliver heated air to the sleeping surface. In some examples, the total thickness of the distribution layer can be between half an inch and four inches depending on the application. The distribution can be other thicknesses in other examples.

FIG. 30A illustrates an example thermal insert 3000. Multiple thermal inserts are integrated in the distribution layer to provide multiple independent temperature zones. The thermal insert 3000 includes a thermal duct 3002 that directs airflow to/from the fan sub-assembly.

The thermal insert 3000 also includes breathable layer 3004 constructed of a low pressure drop material. In some examples, the breathable layer 3004 can be constructed of materials having airflow of greater than 30 CFM per ASTM D737.

The thermal insert also includes an impermeable layer 3006. For example, the impermeable 3006 layer should consist of a thin material with a Permeability of less than 10.0 CFM per ASTM D737. The impermeable layer 3006 has an opening directed on the top side, which allows air to be directed to the surface of the bed (e.g., as shown in FIG. 30B).

The dimensions D1-D4 define the opening. Dimension D1-D4 can be shaped to provide non-overlapping temperature zones on the top surface of the bed. The thermal duct 3002 provides a flexible attachment point between the bed and the base. The thermal duct 3002 can be constructed of a soft, flexible material, such as silicon or other similar material. In some examples, the thermal duct 3002 is placed in a cutout of the foam side rail. The dimension D5 can be adjusted to provide connection to the base without interfering with articulating functions.

FIG. 30B illustrates a cross section view of the example thermal insert 3000 shown in FIG. 30A. FIG. 30B also illustrates the air flow through the thermal insert 3000.

FIG. 31A illustrates an example fan sub-assembly 3100. FIG. 31B illustrates a cross section view of the example fan sub-assembly 3100 shown in FIG. 31A. The fan sub-assembly 3100 includes a fan 3102, a heater 3104, an attachment bracket 3106, and forced air unit housing 3108. The fan 3102 is configured to pull or push air through the connected thermal insert. The heater 3104 heats the air being pushed through the thermal insert. In some examples, the fan sub-assembly 3100 cools the sleep surface of the bed by having the heater 3104 in a non-activate state and activating the fan 3102 to push ambient temperature air (or conditioned air) to the sleeper surface to lower the temperature at the sleeper surface. The attachment bracket attaches the force air unit 3100 to the base of the bed system and/or bed. In some examples, the fan sub-assembly 3100 is configured to be controlled by a climate controller. In some examples, the fan sub-assembly 3100 units are mounted on the bed such that the fan sub-assembly 3100 units are integrated with the mattress.

Referring to FIGS. 30A-31B, in some examples, the bed includes thermal conductivity enhanced foams that allow for faster heating response. In some examples, a support layer uses a material that increases thermal resistivity of the support layer or promotes the transfer of heat to the sleeping surface.

Some implementations include a conductive and convective combination heating system. In some of these examples, a resistive layer is located within the comfort layers and an active fan sub-assemblies are used to force the heat to the desired sleep surface regions. In some examples, forced air is used to more quickly modulate a temperature at the surface of the mattress. In some examples, the heat generation layer is located deeper in the comfort layers to minimize any impact to comfort. In some examples, the system is decoupled from a base/foundation of the bed. For example, the heating element and fans could all be located within the mattress and not require the attachment/ducting with the base.

There may also be a combination of sensors within the sleep system to monitor the conditions and react accordingly with thermal interaction (e.g., to either heat or cool a particular temperature zone on the sleep surface.

In some examples, the bed is associated with a base that can be adjusted to move the bed in different positions. In some of these examples, six independent fan sub-assemblies are attached to the base underneath the deck of the base. In some examples, each fan sub-assemblies includes an axial non-reversible (or reversible) fan, a 400 W positive thermal coefficient (PTC) heater, housing for the heater and fan and a bracket for attaching the fan sub-assemblies to the base.

In some examples, the heating module can attach to the underside of the base decking. A thermal plenum can attach to the top side of the deck and provides a connection point between the thermal duct and the fan sub-assembly. Each fan sub-assembly can be attached to the base adjacent from the side of the bed (e.g., by four inches) and at the midpoint of the six independent zones (e.g., as shown in FIG. 19). The fan sub-assembly modules can be designed such that they are completely hidden by the railing of the bed. In some examples, air exiting the fan sub-assemblies and fan speed of the fan sub-assemblies is controlled by a single control system.

In some examples, the heating and/or cooling is controlled via a centralized control system. In some examples, heater output (and fan speeds) are indirectly selected by the user setting a sleep surface temperature.

Some examples of materials that can be used in the construction of the bed include foam layers (including a multilayer foam only mattress), a mattress with pocketed coils, springs and textile top layer.

In some examples, the thermal inserts attach to the base along the edge of the bed at the side rail. Alternatively, this could be routed through various other locations in the bed where a cavity could be formed to pass the tube through from the thermal layer to the base. For example, a chamber can be created that allows the hose to pass through the middle of an air chamber.

The temperature zones can be modified to be different from those shown in FIG. 19. For example, different sized zones, number of zones, and location of temperature zones be implemented for many reasons including to accommodate different therapeutic needs. Smaller zones could also target specific areas on the body such as knees, hips, shoulders, etc. In some examples, smaller zones can be used to achieve higher temperatures which could aid in short term hyperthermal therapies.

The use of convective heating allows for the possibility of heated zones and cooled zones. When cooling is desired, the heater would not be powered allowing air to cool the microclimate of the bed. This capability would provide a wide range of thermal comfort solutions from users that are too cold and users that sleep hot. The control system could adapt automatically based on biometric signals to either heat or cool the zones. In some examples, one or more zones are set to heat while other zones are set to cool. For example, one zone can be set to heat a user's shoulders while another zone is set to cool the user. This can allow a user to target a desired area with heat from a first zone while maintaining an overall comfortable temperature because of a cooling effect from one or more other zones.

In the description of the forced convection heating system, it is stated that each zone has a single heater and fan which exhausts directly into the air distribution layer. However, the base could be configured to have a single fan and heater which could be coupled to a manifold to direct heated air into the desired zones. This single fan, heater and manifold concept could be applicable to only two zones or as many as the bed zones included in the bed.

The heating technology can include positive thermal coefficient heaters, thermoelectric heating and cooling elements, embedded heaters within the bed, reversible thermochemical reactions, carbon filled polymers, resistive wire assemblies, transfer of heated or cooled liquid. etc.

In some examples, increasing the number of heated zones allows for targeted body warming thereby: (1) improving user experience and the possibility of targeted therapy for conditions which may be mitigated through the use of thermal therapy, and shortening the heating response time (e.g., reducing time to target temperature) allowing for immediate relief either to climatic conditions or desired therapeutic uses. In some examples, the reversible fan allows for increased cooling areas in the bed. The multiple temperature zones allow for more individualized thermal comfort, adjustable temperature in all zones. Some examples allow for the separation of the bed and fan sub-assemblies from the base/foundation. The focused thermal interactions provided via the multiple temperature zones can be used to optimize sleep quality.

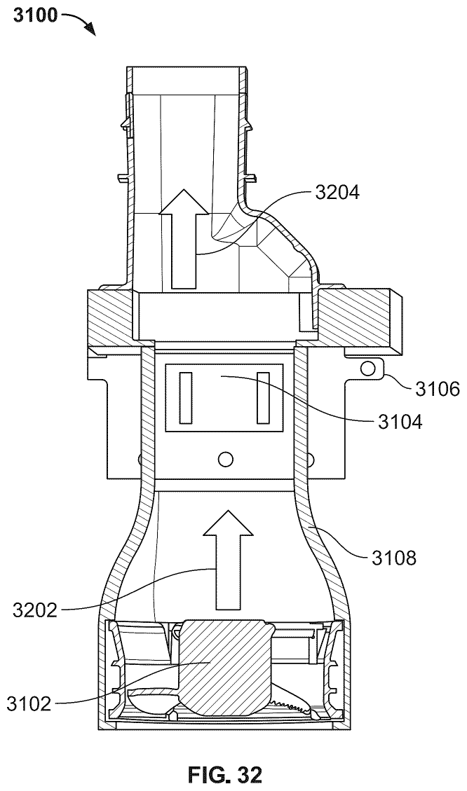

FIG. 32 illustrates airflow through the fan sub-assembly of FIGS. 31A-B. In the example shown, ambient temperature air 3202 is pushed by the fan 3102 through the heater 3104 to push heated air 3204 through an air distribution layer in the mattress.

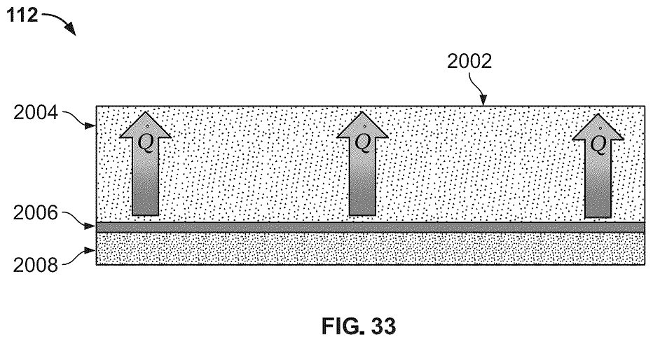

FIG. 33 illustrates a cross section view of an example bed 112 with multiple temperature zones. The example shown includes comfort layer 2004, heat generation layer 2005, and a support layer 2008. The heat generation layer 2006 can include one or more thermal inserts that push heated air from a fan sub-assembly through the comfort layer 2004 to the sleep surface 2002. In some examples, one or more sub-fan assemblies are mounted to the support layer 2008 and are connected to corresponding thermal inserts by a thermal duct that passes through the support layer 2008.

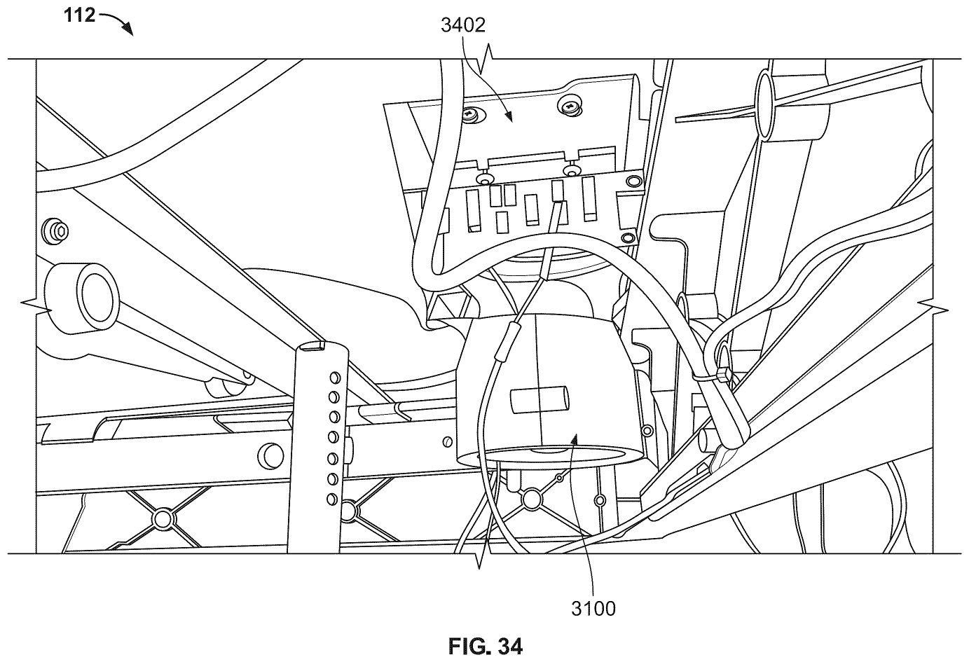

FIG. 34 illustrates the fan sub-assembly 3104 mounted to a bed 112. In some examples, the fan sub-assembly 3104 is mounted to a support layer of the mattress via a bracket 3402. In some examples, the sub fan-assembly 3402 is positioned such that the sub fan-assembly 3402 is not visible when the bed 112 is placed on a base. For example, the side rails of the base may extend further from the base of the bed 112 than the fan sub-assembly 3100.

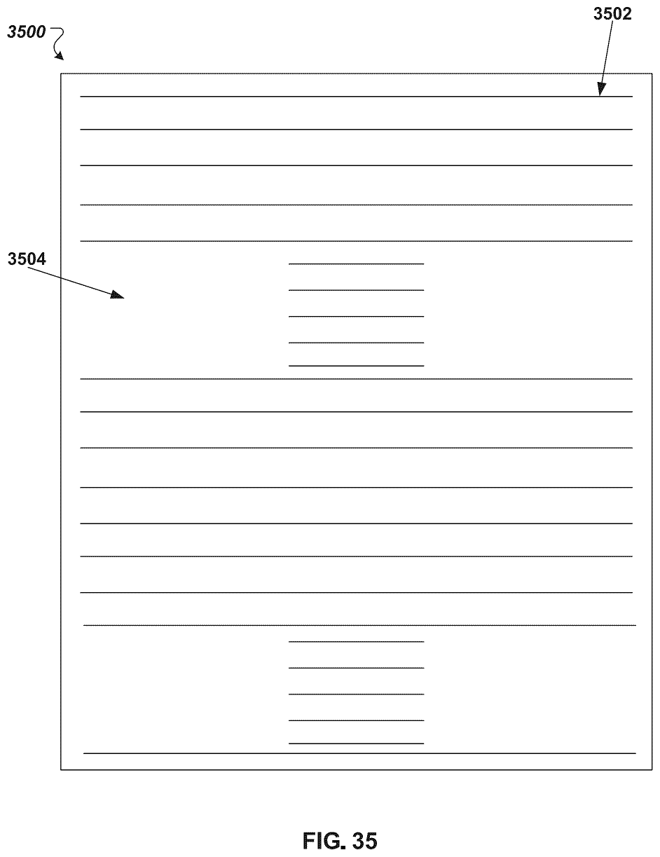

Referring to the climate controlled bed with the conductive heating element 2100, FIG. 35 illustrates an adhesive applied to a foam layer 3500 of a mattress to form pockets 3504 to receive multiple heating elements 2100. The lined regions 3502 on the foam layer 3500 illustrate where an adhesive is applied. Another foam layer is placed on the foam layer 3500 to create multiple pockets 3504. The heating elements 2100 are positioned in the pockets 3504. In some examples, the heating elements 2100 can be removed from the pockets 3504. In some examples, this allows the heating elements 2100 to be serviced or replaced. In some examples, the heating elements 2100 would utilize an additional attachment mechanism (e.g., hook and loop connectors, adhesive) within the pockets 3504.

FIG. 36 illustrates a heating element 2100 (e.g., the heating element 2100 shown in FIG. 21) installed in between a first foam sub-layer 3602 and a second foam sub-layer 3604. In some examples, the first foam sub-layer 3602 is the comfort layer 2004 and the second foam sub-layer is the inner comfort layer 2210 shown in FIGS. 22-23 or as shown in FIG. 24. In other examples, the first foam sub-layer 3602 and the second foam sub-layer 3604 together make up the comfort layer 2004 shown in FIGS. 22-23 or as shown in FIG. 24. In some examples, the first foam sub-layer 3602 and the second foam sub-layer 3604 together make up the inner comfort layer 2210 shown in FIGS. 22-23 or as shown in FIG. 24.

In one example, a mattress includes first and second zones. The mattress can also include a foam tub including: a first comfort sub-layer (e.g., form sub-layer 3602) and perimeter rails attached to a bottom of the first comfort sub-layer and a second comfort sub-layer (e.g., foam sub-layer 3604) removably positioned below the bottom of the first comfort sub-layer and inside of the perimeter rails. In this example, a first heating element 2100 is positioned in the first zone between the first comfort sub-layer (e.g., form sub-layer 3602) and the second comfort sub-layer (e.g., foam sub-layer 3604) and a second heating element is positioned in the second zone between the first comfort sub-layer (e.g., foam sub-layer 3604) and the second comfort sub-layer (e.g., foam sub-layer 3604).

In some examples, the first foam sub-layer 3602 may be laminated to the second foam sub-layer 3604 with the adhesive shown in FIG. 35. The first foam sub-layer 3602 and second foam sub-layer 3604 can then be attached (using an adhesive or Velcro) to the top of a foam tub with rails or the rails can be directly attached to one of the first foam sub-layer 3602 or the second foam sub-layer 3604.

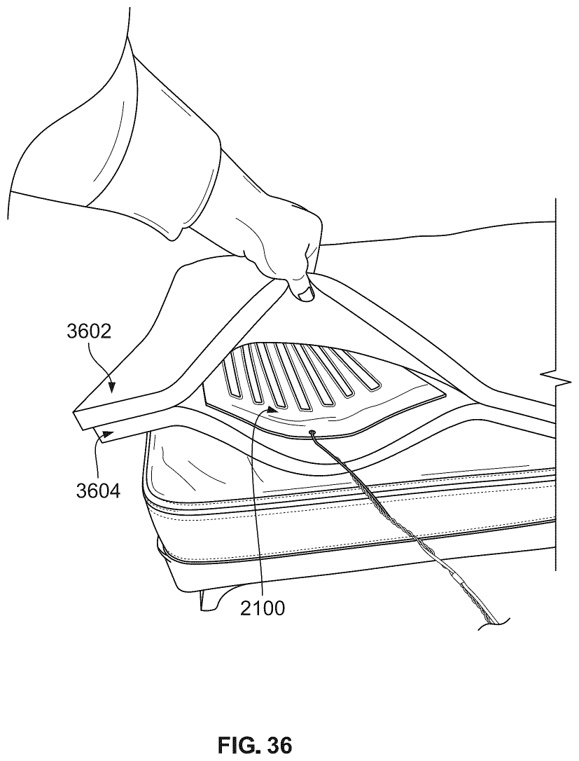

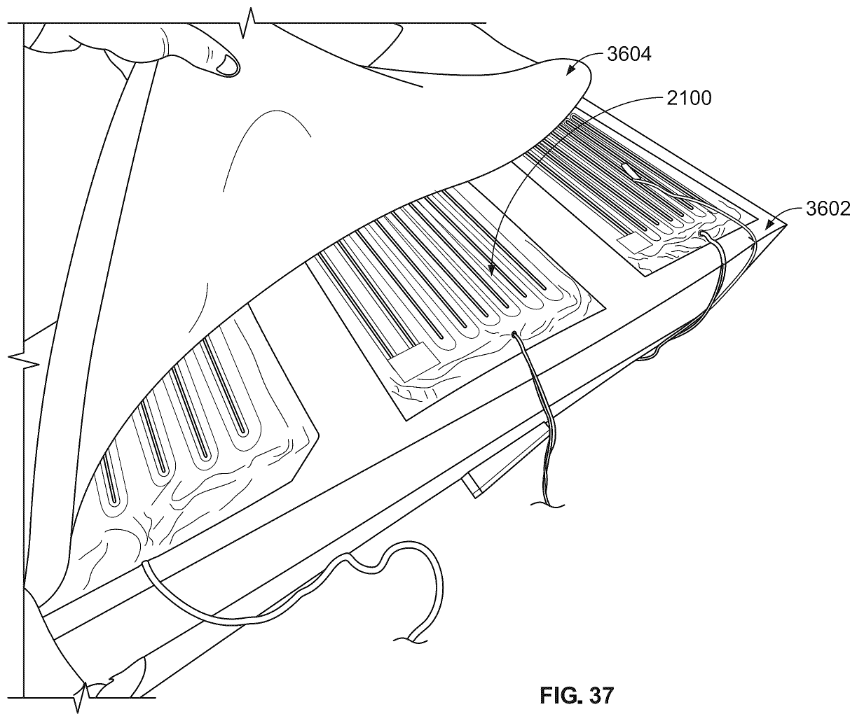

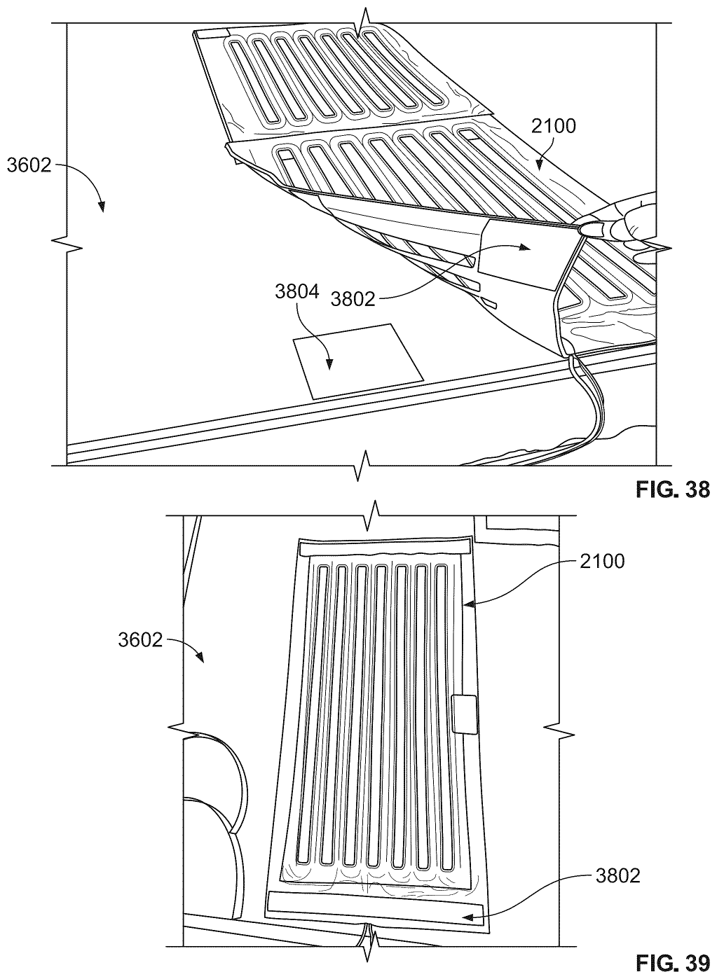

FIG. 37 illustrates the heating elements 2100 installed in between a first foam sub-layer 3602 (e.g., the inner comfort layer 2210 described herein) and a second foam sub-layer 3604 (e.g., the comfort layer 2004 described herein). In the example shown, the heating elements 2100 are positioned on the first foam sub-layer 3602. In some examples, the heating elements 2100 are attached to the first foam sub-layer 3602 via hook and loop connectors (e.g., as shown in FIG. 38 or FIG. 39). In some examples, an adhesive may be applied to attach the heating elements 2100 to the first foam sub-layer 3602 and the second foam sub-layer 3604 (e.g., as shown in FIGS. 40A-40B). In some examples, the heating elements 2100 maintain their position between the first foam sub-layer 3602 and the second foam sub-layer 3604 from friction and the force between the layers applied by the construction of the mattress.

FIG. 38 illustrates the heating element 2100 with a hook and loop connector 3802 to attach to a first foam sub-layer 3602. In the example shown, a hook and loop connectors 3802 are attached (e.g., via an adhesive) to each corner of the heating element 2100. In this example, a corresponding hook and loop connector 3804 is attached (e.g., via an adhesive) to the first foam sub-layer 3602 to connect and position the heating element 2100.

FIG. 39 illustrates a heating element 2100 with a hook and loop connector 3902 to attach to a first foam sub-layer 3602. In the example shown, a hook and loop connector 3802 is attached (e.g., via an adhesive) to opposite sides of the heating element. In this example, a corresponding hook and loop connector (not shown) is positioned on the first foam layer 3602 to connect and position the heating element 2100.

FIG. 40A-40B illustrates a heating element 2100 attached to a first foam sub-layer 3602 and a second foam sub-layer 3604 via an adhesive. In the example shown, an adhesive is applied on a top side of the first foam sub-layer 3602 and a bottom side of the second foam sub-layer 3604. In the example shown, the heating element 2100 is placed on the first foam layer and attached via the adhesive. Next, the second foam layer is placed on top of the first foam sub-layer 3602 and the heating element 2100 to form a bond with the heating element 2100 and the top layer of the first foam sub-layer 3602. In some examples, slots in the heating element 2100 allow for foam to foam adhesive, thereby reducing the risk of crossing the conductive wire in the heating element 2100 thereby decreasing the risk of a generating a hot spot in the mattress.

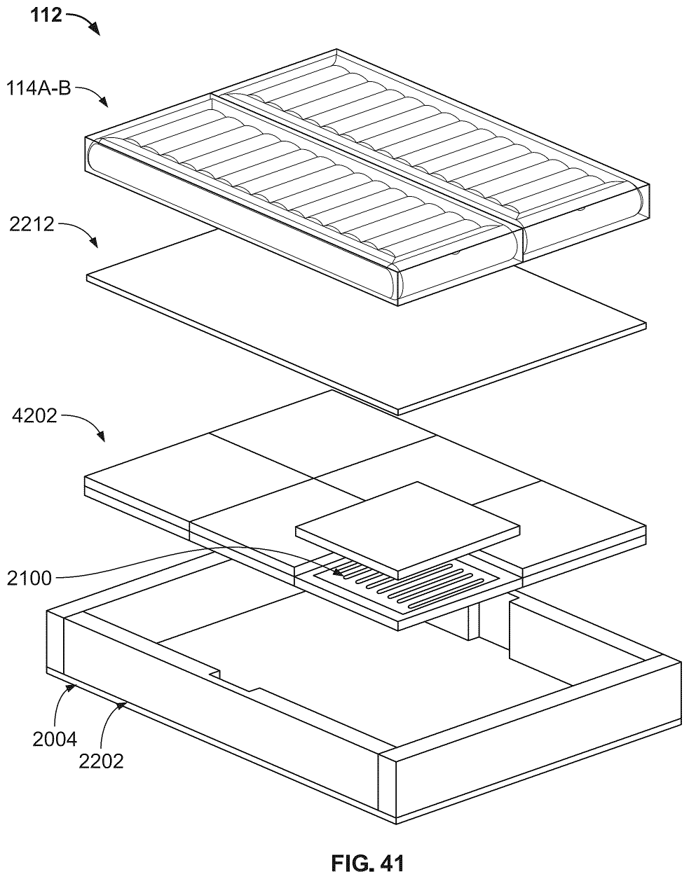

FIG. 41 illustrates an example bed 112 with multiple heating elements. In the example shown, the bed 112 is upside down for illustrative purposes. The bed 112 includes air chambers 114A-B, support layer 2212, individual heater sub-assemblies 4202, heating elements 2100, and a foam tub assembly 2202. However, other arrangements are also possible. For example, some examples may not include the air chambers 114A-B and/or the foam tub assembly 2202.

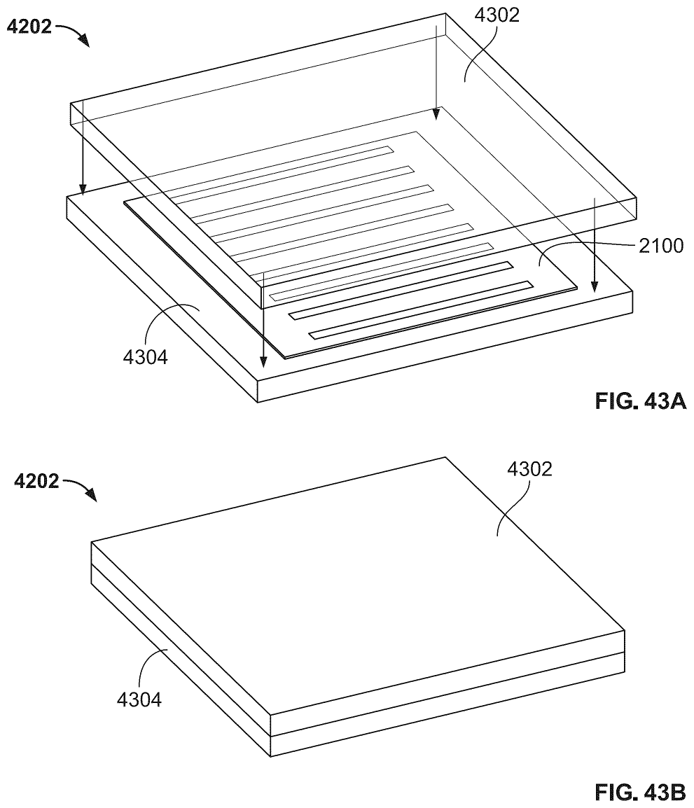

The individual heater sub-assemblies 4202 can each individually be removed. In some examples, this allows a heater sub-assembly to 4202 to be replaced when the corresponding heating element fails. In some examples, this allows a user to access the heating element 2100 for maintenance of the heating element. An example of the individual heater sub-assemblies is illustrated and described in reference to FIGS. 43A-B.

In some implementations, a top comfort layer 2004 of the foam tub assembly 2202 can detach from the perimeter rails of the foam tub assembly 2202 to provide access to the individual heater sub-assemblies 4202. In some implementations, the support layer 2212 can be removed from the foam tub assembly 2202 to provide access to the individual heaters sub-assemblies 4202. In some implementations, one or more of the perimeter rails of the foam tub assembly 2202 (e.g., a head rail, foot rail, right side rail, left side rail, or any combination thereof) can be removed to allow a user to access the individual heater sub-assemblies 4204.

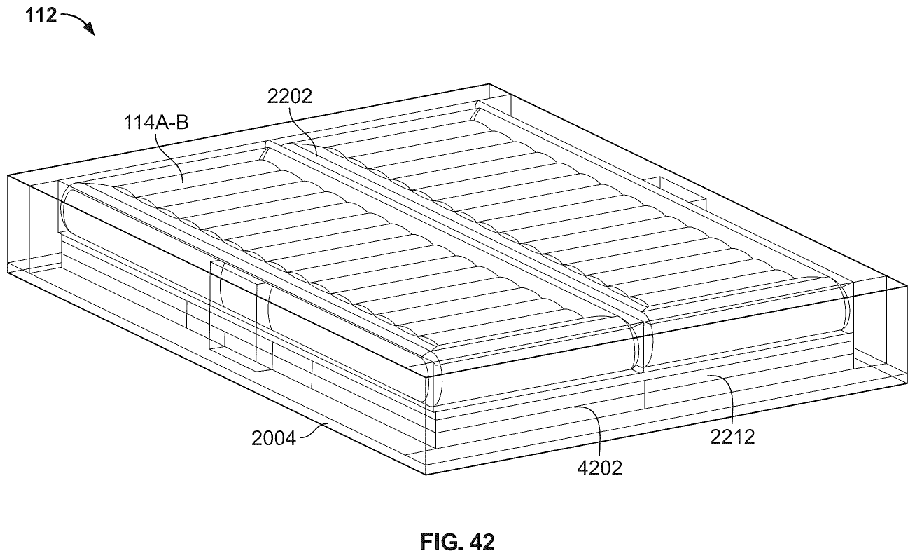

FIG. 42 illustrates the example of the bed 112 shown in FIG. 41 assembled. In the example shown, the bed includes air chambers 114A-B, support layer 2212, individual heater sub-assemblies 4202, a comfort layer 2004, and a foam tub assembly 2202. In some examples, the bed can further include other components disclosed herein. Similarly, some of the components shown in FIG. 42 are not included in other implementations. For example, some implementations may not include the air chambers 114A-B and/or the foam tub assembly 2202.

FIGS. 43A-B illustrate an example individual heater sub-assembly 4202. The example individual heater sub-assembly 4202 includes a top layer 4302 and a bottom layer 4304. In some examples, the top layer 4302 and the bottom layer 4304 are made of a foam material. The individual heater sub-assembly 42024 also includes a heating element 2100. The heating element is positioned between the top layer 4302 and the bottom layer 4304. In some examples, the top layer 4302 is laminated to the bottom layer 4304 to secure the heating element 2100 in position, as shown in FIG. 43B. In some examples, the heating element 2100 as described herein, include slots which allow for foam to foam adhesion between the slots, to provide further structure to the heating element 2100 to prevent the resistive wire in the heating element 2100 from crossing causing a hot spot.

FIG. 44A illustrates a top side of an example heating element 4400. The heating element 4400 includes a fabric material 4402 that is soft and flexible to allow the heating element 4400 to be placed close to the sleeper surface without negatively impacting the comfort of the sleeper surface. The heating element 4400 includes conductive wiring ultrasonically welded to the fabric material 4402 and configured to emit conductive heat when a current is applied through the conductive wiring. The conductive wiring is receiving a current via the wire harness 4404. In some examples, the heating element 4400 is attached to a top surface of a comfort layer and underneath a cover of a mattress (e.g., as shown in FIG. 45). In some implementations, the heating element 4400 can be embedded within the cover of the mattress. For example, the heating element 4400 can be positioned in a pocket of the mattress cover as shown in FIGS. 46A-B. In some implementations, the heating element 4400 extends across the entire top surface of a comfort layer of the mattress. In some implementations, a first heating element 4400 covers a first side of the mattress (e.g., for use by a first user) and a second heating element covers a second side of the mattress (e.g., for use by a second user). As discussed, the fabric material 4402 is flexible and can be located at or near the sleep surface of the mattress to provide a heating stimulus to a user while maintaining a comfortable sleep surface. The heater 4400 can alternatively be positioned in other layers of the mattress including in analogous implementation described for the heating element 2100 herein.

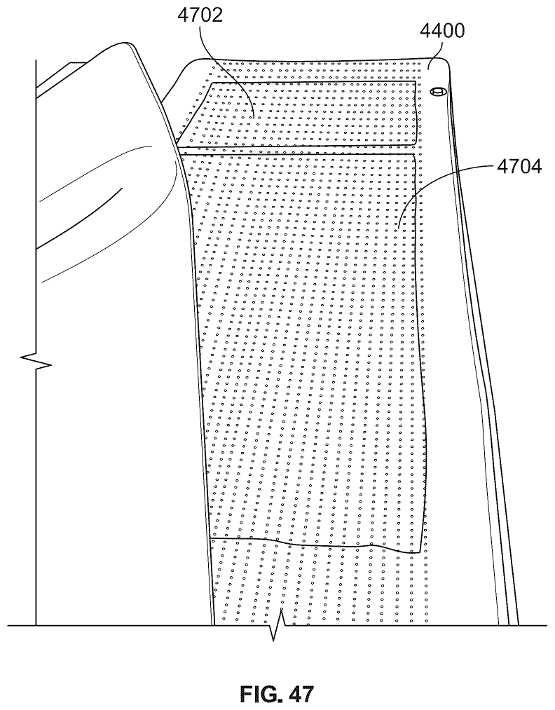

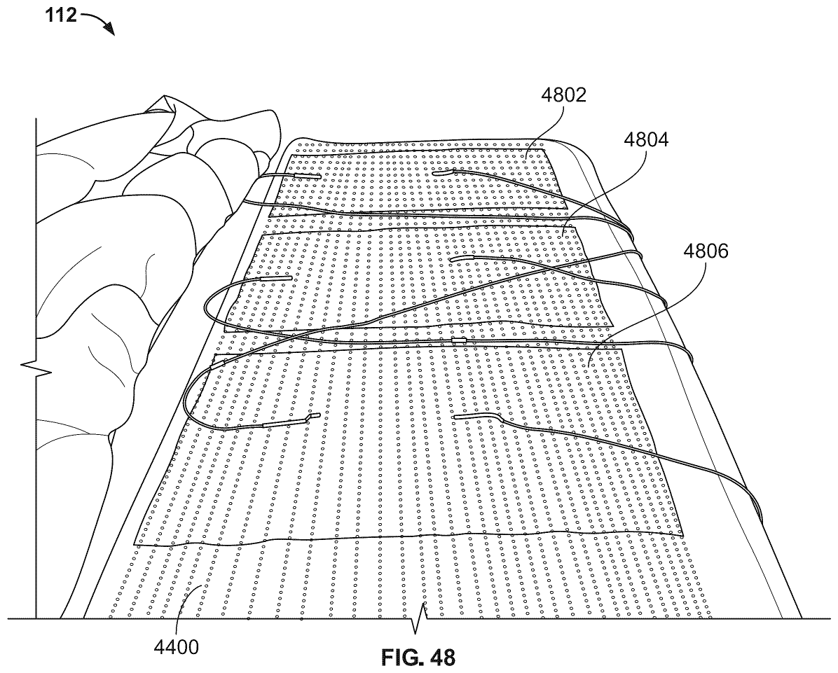

In some implementations, the conductive wiring in the heating element 4400 is configured to provide heat at multiple independently controlled temperature zones (e.g., as shown in FIG. 19). In some of these implementations, the first heating element may extend across a top surface of a comfort layer in a mattress. In some implementations, a mattress includes a first heating element 4400 that extends across a first side of the mattress to provide heat to a first user and a second heating element 4400 that extends across the second side of the mattress to provide heat to a second user. In some of these examples, each of the first heating element 4400 and the second heating element 4400 can be configured with conductive wiring that provides multiple independently controlled temperature zones. Examples of such beds are illustrated and described in reference to FIGS. 47 and 48.

FIG. 44B illustrates a bottom side of an example heating element 4400. In the example shown, the heating element 4400 includes a hook and loop connector to attach to a top surface of a comfort layer of the mattress (e.g., as shown in FIG. 45). In some implementations, the heating element is attached to the surface of the comfort layer via other means, such as using adhesive, laminate, a pocket housing the heating element, by sewing the heating element to the top surface of the comfort layer, or other connector.

FIG. 45 illustrates an example bed 112 with multiple heating elements 4400. The bed 112 includes a foam tub assembly 2202, a comfort layer 2004, and multiple heating elements 4400. In the example shown, the heating elements 4400 are attached to a top surface of a comfort layer 2004 of the bed. The heating elements 4400 can be attached to the comfort layer 2004 via a connector, such as a hook and loop connector, adhesive, laminate, by being sewn to the comfort layer 2004, or another connector. In some examples, the bed 112 includes a mattress cover (not shown). In some examples, the mattress cover includes a quilted panel that provides additional comfort to the sleeper surface of the bed 112.

FIGS. 46A-B illustrate an example mattress cover 4600 with an embedded heating element (e.g., the heating element shown in FIGS. 44A-B). A pocket 4602 sewn into the mattress cover is configured to house the heating element. While the example shown includes only one pocket 4602, the mattress cover 4600 can have any number of pockets each configured to house an individual heating element. In some examples, each side of the mattress includes three pockets housing three heating elements to provide six temperature controlled zones on the mattress (e.g., as shown in FIG. 19).

FIG. 47 illustrates an example bed 112 with a heating element 4400 providing multiple temperature controlled zones (4702, 4704). In some examples, the heating element 4400 is made of a fabric embedding conductive material that is arranged to provide the multiple temperature controlled zones (4702, 4704). The multiple temperature controlled zones (4702, 4704) can be each independently controllable. In some examples, the bed includes a mattress cover. In some examples, the mattress cover includes a quilted panel that provides additional comfort to the sleeper surface of the bed.

In some examples, the heating element 4400 includes a single thermistor positioned at or near the center of the heating element 4400. In other examples, as shown in FIG. 48, each of the multiple temperature controlled zones (4802, 4804, 4806) includes a thermistor to control the wiring in the corresponding temperature controlled zone to reach a desired setpoint (e.g., via a closed loop circuit). In some examples, the thermistor is also used with a shutdown mechanism when a threshold temperature is exceeded.

FIG. 48 illustrates an example bed 112 with a heating element 4400 providing multiple temperature controlled zones (4802, 4804, 4806). In some examples, the heating element 4400 is made of a fabric embedding conductive material that is arranged to provide the multiple temperature controlled zones (4802, 4804, 4806). The multiple temperature controlled zones (4802, 4804, 4806) can be each independently controllable. In some examples, the bed includes a mattress cover. In some examples, the mattress cover includes a quilted panel that provides additional comfort to the sleeper surface of the bed.

In some examples, the bed includes one or more foam layers and the heating element 4400 is attached to a top surface of a top foam layer (e.g., the comfort layer 2004 described herein). In some examples, the bed includes a first heating element on a first side of the bed and a second heating element on a second side of the bed. In other examples, the heating element extends across the entire or almost the entire top surface of the top foam layer. In some of these examples, the heating element 4400 is configured to provide three temperature zones on the first side of the bed and three temperature zones on the second side of the bed. However, the heating element 4400 can be configured to provide any number of heating zones on one or both sides of the bed 112.

In some examples, the heating element 4400 is attached to the top foam layer using hook and loop connectors. In some examples, the heating element 4400 is attached to the top foam layer using a laminate. Other adhesives can be used in addition to or instead of hook and loop connectors and laminates.

In some examples, the heating element 4400 can be attached to a top surface of any type of bed. In some of these examples, a mattress cover is configured to cover the heating element 4400 and provide additional comfort to a user. In some of these examples, the cover is a quilted panel. In other examples, the heating element 4400 is embedded in the mattress cover. The mattress cover can include additional material to provide enhanced comfort to a user.

In some examples, the heating element 4400 includes a single thermistor positioned at or near the center of the heating element 4400. In other examples, each of the multiple temperature controlled zones (4802, 4804, 4806) includes a thermistor to control the wiring in the corresponding temperature controlled zone to reach a desired setpoint (e.g., via a closed loop circuit). In some examples, the thermistor is also used with a shutdown mechanism when a threshold temperature is exceeded.

Some embodiments include a mattress having first and second zones, where the mattress includes (i) a first layer includes a first cushioning material in a first zone and a first heater in a second zone and (ii) a second layer, positioned below the first layer, includes a second heater in the first zone and a second cushioning material in the second zone. In some examples, the mattress defines a first sleep area sized to support a first user and the first and second zones are both positioned in the first sleep area. In some examples, the mattress defines a first sleep area sized to support a first user and a second sleep area sized to support a second user, where the first and second zones are both positioned in the first sleep area and not in the second sleep area. In some examples, the first heater is positioned vertically higher than the second heater and offset from the second heater such that the first heater is not directly above the second heater.

Some embodiments include a mattress having first and second zones. The mattress can include a foam tub with a first comfort layer and perimeter rails attached to a bottom of the first comfort layer, a second comfort layer removably positioned above a top of the first comfort layer, a first heater in the first zone between the first comfort layer and the second comfort layer, and a second heater in the second zone between the first comfort layer and the second comfort layer. Some examples include a mattress cover enclosing the foam tub, the second comfort later, and the first and second heaters.

Some embodiments include a system including a bed having a mattress, the mattress including a first side for a first sleeper user, the first side including two or more first side temperature modulating elements, a second side for a second sleeper user, the second side including two or more second side temperature modulating elements, and a climate controller configured to individually control the two or more first side temperature modulating elements and the two or more second side temperature modulating elements. In some examples, the two or more first side temperature modulating elements and the two or more second side temperature modulating elements include at least one conductive heating element and at least one forced air unit. In some examples, the at least one forced air unit is configured to cool at least a portion of a sleep surface of the mattress. In some examples, the at least one forced air unit includes a heater to heat air the at least one forced air unit distributes to a sleep surface of the mattress.

Some embodiments include a system including a mattress having two or more heating elements and a climate controller configured to individually control the two or more heating elements, wherein the two or more heating elements are configured to be inserted and removed from the mattress to customize arrangement of the two or more heating elements.

In some examples, a busbar heater using conductive fabric can be implemented to provide one or more temperature controlled zones in a mattress. In some of these examples, electric current is passed through the busbar and into the conductive fabric. The fabric can contain numerous conductive materials such as carbon or graphite that allow it to conduct heat. In some examples, the fabric or busbar is created using conductive ink. In some examples, the busbar heater is used in combination with one or more forced convection heating elements to provide hot air to the surface of the mattress.

In some examples, one or more heating pads (e.g., resistive heating pads) are used to provide multiple temperature controlled zones on a surface of the mattress. In some examples, the heating pads are used in combination with one or more forced convection heating elements to provide hot air to the surface of the mattress.

In some embodiments, a bed includes two or more temperature controlled zones per side of the bed system. For example, the bed can include two to three resistive heating elements per side. In some examples, one or more of the temperature zones are overlapping. In some embodiments, heating and cooling can be provided at the same time to prevent the user from overheating. In some examples, a user can select specific/customize zones for heating. In some examples, the heating elements are replaceable within the bed. In some examples, the heating elements can be moved by a user. Some examples include a center thermistor positioned on or near a resistive wire to track and drive to a temperature setpoint. Some examples include thermostats in series and a controller configured to shut down sections if they exceed a temperature.

Advantages of the systems disclosed herein include targeted heat to a sleep that feels cold in a specific area, enhancing the comfort of a sleep environment; quick temperature adjustment to specific zones, provide therapeutic heat to specific areas, ability modulating a sleeper's environment to promote improved sleep (for example, heating and cooling can be used to create an environment that induces certain sleep stages). In some examples, the systems can provide a thermal heat alarm to gently heat or cool an environment to wake a sleeper.

The foregoing detailed description and some embodiments have been given for clarity of understanding only. No unnecessary limitations are to be understood therefrom. It will be apparent to those skilled in the art that many changes can be made in the embodiments described without departing from the scope of the invention. For example, a different order and type of operations may be used to generate classifiers. Additionally, a bed system may aggregate output from classifiers in different ways. Thus, the scope of the present invention should not be limited to the exact details and structures described herein, but rather by the structures described by the language of the claims, and the equivalents of those structures. Any feature or characteristic described with respect to any of the above embodiments can be incorporated individually or in combination with any other feature or characteristic, and are presented in the above order and combinations for clarity only.

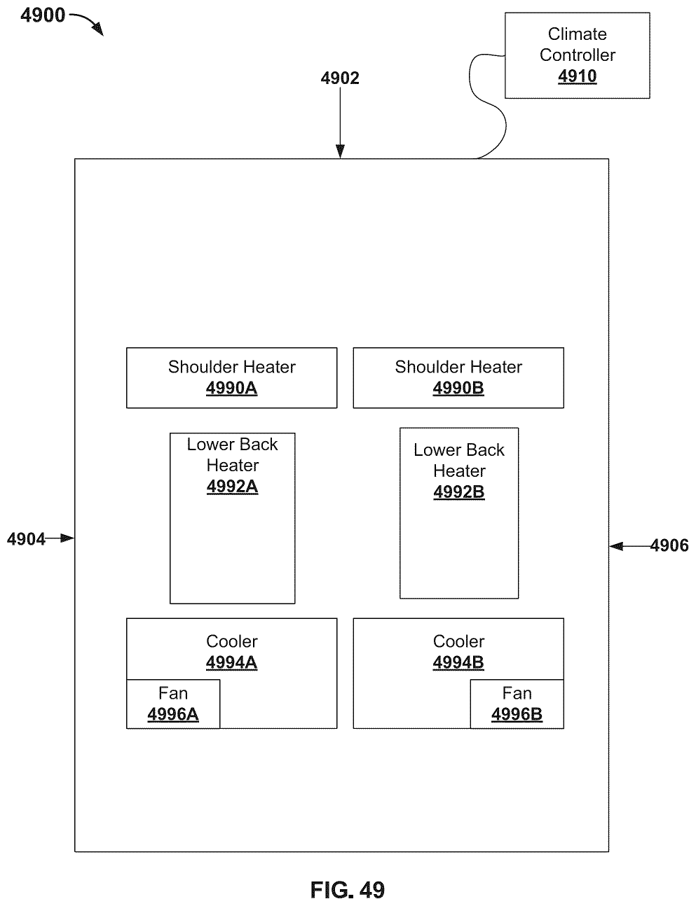

FIG. 49 illustrates an example bed 4900 with multiple temperature zones (4990A-4996B). The bed 4900 can be similar to and include features of one, more than one, or all of the example beds described above. For just one example, the bed 4900 can include features described with respect to the bed 112 shown and described with respect to FIG. 19.

The bed 4900 can include a mattress 4902 having a first side 4904 configured to support a first user and a second side 4906 configured to support a second user. The bed 4900 can include at least one climate controller 4910 configured for controlling temperature of the bed 4900 by providing therapeutic heating to one or more users at one or more particular locations while simultaneously cooling a microclimate of the user.

For example, the first side 4904 of the mattress 4902 can include a shoulder heater 4990A (or multiple shoulder heaters), a lower back heater 4992A (or multiple lower back heaters), and a cooler 4994A (or multiple coolers). The heaters 4990A and 4992A can be part of a heating system positioned at locations configured to align with the user's shoulders and/or back (e.g. lower back). The heaters 4990A and 4992A can provide therapeutic heating to portions of the user that are in need of heating or that can benefit from heating. The heaters 4990A and 4992A can, in some cases, be selectively operated to heat only one, more than one, or several locations on the user.

In some embodiments, when one or more of the heaters 4990A and 4990B desirably heat one or more portions of the user (e.g. to provide therapeutic treatment of the one or more portions) the heaters 4990A and 4990B can also increase overall temperature of the microclimate of the user, which can be undesirable. Accordingly, the cooler 4994A can be activated to cool the microclimate of the user. In some embodiments, the cooler 4994 can include a cooling pad positioned at locations configured to align with the user's hips, the user's thighs, or both the hips and thighs of the user. A fan 4996A can be connected to the cooling pad (e.g. connected via a hose or connected directly) to draw air from the microclimate, through the cooling pad, and out through the fan 4996A. When the user is in bed with a blanket, sheet, and/or comforter on top of the user, operation of the cooler 4994 can draw air from the microclimate. Air can flow along one or more paths of least resistance, which in some cases, would include at least some air flow from a location near a user's head, into the microclimate between the comforter (or blanket, sheet, etc.) along the user's torso, and past the user's hips and/or thighs into the pad of the cooler 4994. Thus the cooler 4994A can cool the microclimate including the user's shoulders and back by drawing air at the location proximate the user's hips and/or thighs, such that the microclimate is cooled at the same time as providing therapeutic heating via the heater 4990A and/or the heater 4992B.

In some embodiments, the bed 4900 can be a two-person bed configured for use by two users. For example, the second side 4906 of the mattress 4902 can include a second set of devices, including one or more shoulder heaters 4990B, one or more lower back heaters 4992B, and one or more coolers 4994B with a cooling pad and a fan 4996B. The shoulder heater 4990B, lower back heater 4992B, and coolers 4994B can be operated on the second side 4906 in a manner similar to that of similar structure on the first side 4906. This can allow the bed 4900 to provide therapeutic heating to one user without providing therapeutic heating to the other user, or optionally, providing therapeutic heating to both users as desirable for each user's individual needs. The microclimate of each user can be cooled to provide a comfortable sleeping environment with less or no undesirable overheating.

In some embodiments, the bed 4900 can be a single bed for a single user.

The controller 4910 can be similar to other controllers described above. In some cases, the controller 4910 can include one or more heating controllers and one or more cooling controllers. In some cases, a single controller can operate all heating and cooling functions.

The heaters 4990A, 4990B, 4992A, and 4992B can be similar to other heating systems described above. In some embodiments, the heaters 4990A, 4990B, 4992A, and 4992B can be resistance heaters, such as resistive wire heaters. In some embodiments, the heaters 4990A, 4990B, 4992A, and 4992B can include structure that is the same or similar to the heating element 2100 (shown and described with respect to FIG. 21 among others), the heating elements 2206 (shown and described with respect to FIG. 22 among others), the heating element 4400 (shown and described with respect to FIGS. 44A-47).

The coolers 4994A and 4994B can be similar to other cooling systems described above. In some embodiments, the coolers 4994A and 4994B can be air cooled systems that cool with ambient air drawn through the coolers 4994A and 4994B. In some embodiments, the coolers 4994A and 4994B can include structure that is the same or similar to the thermal inserts 3000 and fan sub-assemblies 3100 (shown and described with respect to FIGS. 30A-32). In other embodiments, the coolers 4994A and 4994B can include other inserts, fans, and/or other structure suitable for the application.

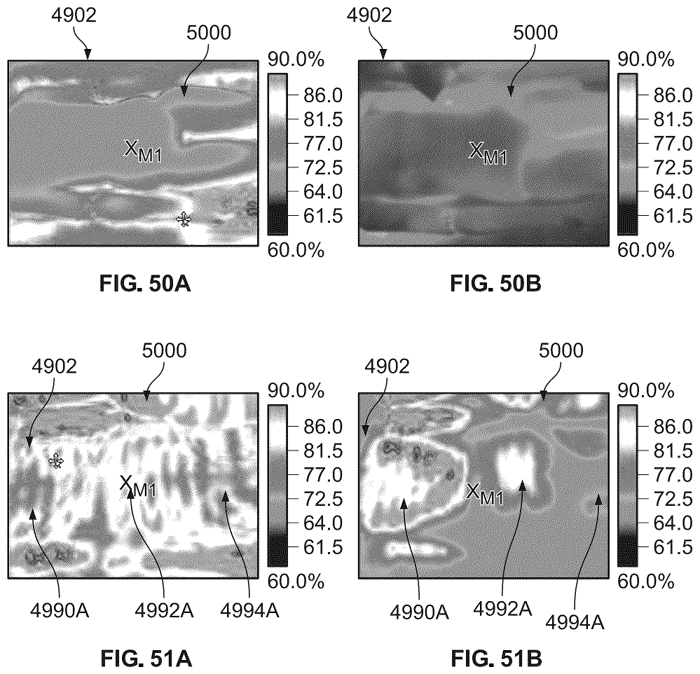

In some embodiments, the heaters 4990A, 4990B, 4992A, and 4992B and the coolers 4994A and 4994B can be positioned in other locations suitable for providing therapeutic heating and simultaneous cooling of a user. In various embodiment, a bed can be configured to therapeutically heat one or more locations of a user while simultaneously cooling portions of the user, including the one or more locations of the user that are therapeutically heated, via a cooling system positioned at another location of the user that is away from the one or more locations of the user that are therapeutically heated. FIGS. 50A-50B and 51A-51B show thermal imaging testing of the mattress 4902 with a test mannequin 5000 positioned thereon. The mattress 4902 was tested with the test mannequin 5000 positioned thereon and a blanket (not shown) placed over the top. The test was first run with the heaters 4990A and 4992A operating but without the cooler 4994A operating. The test was second run with the heaters 4990A and 4992A and the cooler 4994A operating.

FIG. 50A shows the first test of the mattress 4902 and the mannequin 5000 immediately after the blanket was removed. As shown in FIG. 50A, most of the microclimate around the mannequin 5000 is warm (e.g. 77-90 degrees Fahrenheit).

FIG. 51A shows the first test of the mattress 4902 and the mannequin 5000 after the blanket was removed and the mannequin 5000 was rolled to the side. This shows temperature of the mattress 4902 under the mannequin 5000. As shown in FIG. 51A, most of the mattress 4902 under the mannequin 5000 is warm (e.g. 77-90 degrees Fahrenheit) and a bottom of the mannequin 5000 is also warm (e.g. 77-90 degrees Fahrenheit). This first test was run with the heaters 4990A and 4992A operating but without the cooler 4994A operating.

FIG. 50B shows the second test of the mattress 4902 and the mannequin 5000 immediately after the blanket (not shown) was removed. As shown in FIG. 51A, most of the microclimate around the mannequin 5000 is cool (e.g. 68-72 degrees Fahrenheit). The cooler 4994A can cool microclimate around the mannequin 5000 in shoulder and torso areas even though the cooler 4994A is placed proximate a hip area (not at shoulder and back areas).

FIG. 51B shows the second test of the mattress 4902 and the mannequin 5000 after the blanket was removed and the mannequin 5000 was rolled to the side. This shows temperature of the mattress 4902 under the mannequin 5000. As shown in FIG. 51B, the mattress 4902 can be seen distinctly warm (e.g. 77-90 degrees Fahrenheit) in two locations corresponding to the shoulders and lower back of the mannequin 5000 and yet the mattress 4902 is cooler (e.g. 68-72 degrees Fahrenheit) at other locations. Notably, shoulder and lower back regions of the mannequin 5000 are also warm (e.g. 77-90 degrees Fahrenheit). This second test was run with each of the heaters 4990A and 4992A and the cooler 4994A operating. This test data from both tests tends to show that the bed 4900 can provide therapeutic heating to one or more users at one or more particular locations while simultaneously cooling a microclimate of the user.

FIG. 52 illustrates an example bed 112 with a first heating element 5100 and a second heating element 5200. Like previous examples, the bed 112 can include a tub assembly 2202 (optionally made from foam) and a comfort layer 2004. In some examples, the bed 112 can also include a flame resistant (FR) cap 2214 (or other fire protecting material, such as an FR sock) placed over or around the heating elements 5100 and 5200, the tub assembly 2202, and/or the comfort layer 2004. The FR cap 2214 can be configured to provide a fire resistive effect to reduce transmission of fire into or out of the bed 112, or a mattress associated with the bed 112. At least one of the heating elements 5100 and 5200, in any combination or number, can be attached to a surface of the comfort layer 2004 in some examples. In other examples, the heating elements 5100 and 5200 can be at least partially integrated within the comfort layer 2004, for example as a pocket sewn into the comfort layer 2004 to house the heating elements 5100 and 5200). In some embodiments, a different number of heating elements 5100 and 5200 in a suitable arrangement, pattern, and/or configuration can be used for a given geometry of the bed 112. For example, a plurality of heating elements 5100 and/or 5200 can be dispersed across a top surface of the comfort layer 2004 in some examples. In other examples, a single heating element 5100 and/or 5200 can be used with the bed 112, or a number of heating elements 5100 and/or 5200 can be used.

While FIG. 52 illustrates a single heating element 5100 and a single heating element 5200, it should be understood that bed 112 can include a number of heating elements 5100 alone, a number of heating elements 5200 alone, or a combination of heating elements 5100 and 5200 in any suitable number and arrangement. In some examples, a number of heating elements 5100 and/or a number of heating elements 5200 can be positioned in the location where the FR cap 2214 is illustrated on the bed 112 in FIG. 52 (additionally or alternatively to their presently illustrated locations in FIG. 52). In some examples, a combination of heating elements 5100 and 5200 in any suitable number and arrangement can be used for multi-zone heating where a user's shoulders and/or hips are heated by a number of heating elements 5200, and a user's feet are heated by a number of heating elements 5100. Other user body parts may additionally or alternatively be heated by at least one heating element 5100 and/or at least one heating element 5200 in other examples.

The heating element 5100 can include a heater 5102 positioned within an envelope 5104. The envelope 5104 can be coupled to a surface of the comfort layer 2004 using lamination or another coupling mechanism (e.g., hook-and-loop fasteners, tape, direct integration with the comfort layer 2004 to form a unitary structure). In some examples, the envelope 5104 can have a rectangular shape configured to be positioned proximate to an end of the bed 112, such as an end where a user places their feet and/or legs. The envelope 5104 can define other shapes and can be positioned in other regions around the bed 112 in other examples. In some examples, the heating element 5100 can be configured to generate heat independently of other heating elements included with the bed 112 (e.g., heating element 5200). The heating element 5100 can also be configured to generate heat concurrently with one or more other heating elements, such as heating element 5200, to provide multi-zone heating across the bed 112.

The second heating element 5200 can include a heater integrated with a heater cover that can be coupled to a surface of the comfort layer 2004. Unlike heating element 5100, the second heating element 5200 does not require a separate envelope structure to contain the heater in some examples. Rather, the heater and the heater cover can be integrated as a unitary structure that is attachable to the comfort layer 2004. In some examples, the heating element 5200 can include stitching, wrapping, and/or padding provided around one or more peripheral edges of the heating element 5200. The stitching, wrapping, and/or padding can be used to attach separate top and bottom layers of the heating element 5200. In other examples, the heating element 5200 can include one or more heating wires interspersed throughout the heater cover, which may be configured as a single piece of material (e.g., fabric) in some examples. In some examples, the heater cover can comprise a flexible material. The heating element 5200 can have a rectangular shape in some examples, or different shapes in other examples (e.g., circular, triangular, other regular or irregular polygonal shapes). Heating element 5200 can be positioned proximate to an end of the bed 112 (the same end or a separate end as heating element 5100) where a user can place their feet, legs, or other bodily parts. In other examples, the heating element 5200 can be positioned proximate to a center portion of the comfort layer 2004, between opposing ends of the bed 112.

Heating element 5200 can be configured to generate heat independently of other heating elements included with the bed 112 in some examples (e.g., heating element 5100). In such examples or others, the heating element 5200 can be configured to generate heat concurrently with one or more other heating elements, such as heating element 5100, to provide multi-zone heating across the bed 112. The heating element 5200 can be adjustable between independent heat generation and concurrent heat generation, for example using a controller. The controller can be operated by a user or operated automatically based on a number of schedules, patterns, and/or configurations of heat generation (at least some of which may be predetermined in some examples). This enables users to customize heat generation to fit their needs and preferences.

FIG. 53 illustrates an example bed 112 with a number of heating elements 5200 each having a heater and a heater cover integrated as a unitary structure (e.g., a single heating element 5200, three heating elements 5200, or any other suitable number of heating elements 5200). The number of heating elements 5200 can be placed across a top surface of a comfort layer 2004, with the comfort layer 2004 positioned above a tub assembly 2202 of the bed 112. In some examples, multi-zone heat can be provided using a number of heating elements 5200 placed in one or more zones or areas along the bed 112 (e.g., a first zone for a user's shoulders, a second zone for a user's hips, and a third zone for a user's feet). The bed 112 can include an alternative version of the FR cap 2214 (or other fire protective material) defining a top, outward-facing surface opposite a bottom, inward-facing surface relative to the bed 112. The bed 112 can further include a comfort layer 2216, which can be relatively thick and can be made from foam in some examples. The comfort layer 2216 can be coupled to the bottom, inward-facing surface using lamination or another coupling mechanism (e.g., hook-and-loop fasteners, tape, integration with the FR cap 2214 to form a unitary structure). In use, the FR cap 2214 and the comfort layer 2216, which together form a foam-laminated FR cap, can be positioned over the number of heating elements 5200 and across the comfort layer 2004 and/or the tub assembly 2202. In some examples, the foam-laminated FR cap may wrap around at least one side of the bed 112, which can be one or more sides of the comfort layer 2004 and/or the tub assembly 2202. The foam-laminated FR cap may be coupled to one or more sides of the bed 112 using, for example, one or more friction surfaces, at least one strap, elastic, at least one hook-and-loop fastener, at least one zipper, and/or at least one snap connection.

The comfort layer 2216 can provide extra thickness to the bed 112 which can yield enhanced comfort for users when laying down or otherwise occupying the bed 112. Additionally, integrating the comfort layer 2216 with the FR cap 2214 can combine two components into one structure that can be removably coupled to the bed 112. Some examples of the bed 112 always require a FR cap 2214 positioned over or against the number of heating elements 5200. In such examples, integrating the comfort layer 2216 with the FR cap 2214 enables users or manufacturers to leverage an existing, required component rather than adding a new layer of material over the bed 112. This can reduce the number of components associated with the bed 112, while still maintaining safe heat generation and user comfort during use.

Still referring to FIG. 53, the bed 112 can further include a mattress cover 2218 configured to at least partially surround a top surface and one or more side surfaces of the FR cap 2214. While the illustrated mattress cover 2218 is shown on the ground next to the bed 112, it should be understood that the cover 2218 can be placed over and around the FR cap 2214, the comfort layer 2004, and the tub assembly 2202 in some examples. The mattress cover 2218 can provide a sleep surface for users of the bed 112, with the comfort layer 2004 adding additional cushioning support during use. In some examples, the mattress cover 2218 can comprise a quilted panel or pattern configured to provide additional comfort to users of the bed 112. The mattress cover 2218 can thus be removably positioned over a top surface of the FR cap 2214 and the comfort layer 2216, indirectly over the number of heating elements 5200, and over one or more side surfaces of the FR cap 2214, the comfort layer 2004, and/or the tub assembly 2202. In some examples, the mattress cover 2218 can wrap around a bottom surface of the bed 112, such as a bottom surface of the comfort layer 2004 or the tub assembly 2202, or a portion of the FR cap 2214 that is wrapped around such bottom surfaces. The mattress cover 2218 can thus encompass all or a portion of the components that it wraps around along the bed 112.

In some examples, the components of bed 112 can be arranged with the mattress cover 2218 on top, followed by the FR cap 2214, followed by the comfort layer 2216, followed by a number of heating elements 5200 attached to a top of the tub assembly 2202. In some examples, the components of bed 112 can be arranged with the mattress cover 2218 on top, followed by the FR cap 2214, followed by the comfort layer 2216, followed by a number of heating elements 5200 attached to a bottom of the comfort layer 2216, which are provided above the tub assembly 2202. In some examples, the components of bed 112 can be arranged with the mattress cover 2218 on top, followed by the comfort layer 2216 laminated to a top of the FR cap 2214, followed by a number of heating elements 5200 attached to a top of the tub assembly 2202. In some examples, the components of bed 112 can be arranged with the mattress cover 2218 on top, followed by the comfort layer 2216 laminated to a top of the FR cap 2214, followed by a number of heating elements 5200 attached to a bottom of the FR cap 2214. Other suitable arrangements of components are also contemplated for some other examples.

A number of embodiments of the inventions have been described. Nevertheless, it will be understood that various modifications can be made without departing from the spirit and scope of the invention. For example, in some embodiments the bed need not include adjustable air chambers. Moreover, in some embodiments various components of the foundation 600 can be shaped differently than as illustrated. Furthermore, in some embodiments, elements can be positioned in different locations than as illustrated, such as positioning heaters at different locations configured to provide therapeutic heat to specific areas of a user (e.g. spine, feet, wrists, elbows, muscles, etc.). Additionally, different aspects of the different embodiments of foundations, mattresses, and other bed system components described above can be combined while other aspects as suitable for the application. Accordingly, other embodiments are within the scope of the following claims.

What is claimed is:

1. A heating element configured to be installed in a bed, the heating element comprising:
a resistive wire sealed in a semi-rigid material, where the resistive wire is shaped within the semi-rigid material to include multiple parallel segments each attached by a curved segment; and
a connector configured to attach the resistive wire to a power source, wherein the resistive wire is configured to generate heat when power from the power source is applied to the resistive wire.

2. The heating element of claim 1, wherein the semi-rigid material includes at least one open slot between a first parallel segment of the resistive wire and an adjacent second parallel segment of the resistive wire.

3. The heating element of claim 2, wherein the at least one open slot includes two or more open slots and one or more parallel segments of the resistive wire are positioned between each of the two or more open slots.

4. The heating element of claim 1, wherein the resistive wire forms substantially an accordion shape.

5. The heating element of claim 1, wherein the heating element is flat and flexible.

6. The heating element of claim 1, wherein the semi-rigid material defines a rectangular shape.

7. The heating element of claim 1, wherein the heating element includes one or more open slots and the heating element is configured to be installed between two layers of foam in a mattress with an adhesive applied to provide a foam to foam bond between the two layers of foam within the one or more open slots.

8. The heating element of claim 1, wherein the heating element includes a first open slot and a second open slot, the first open slot being adjacent to the second open slot, wherein two parallel segments of resistive wire are positioned between the first open slot and the second open slot.

9. The heating element of claim 1, further comprising a current detector configured to detect a current in the resistive wire,
wherein the heating element stops applying power to the resistive wire when the current detected in the resistive wire exceeds a shutdown current threshold.

10. The heating element of claim 1, further comprising a voltage detector configured to detect a voltage across at least a portion of the resistive wire,
wherein the heating element stops applying power to the resistive wire when the voltage detected across the at least the portion the resistive wire exceeds a shutdown voltage threshold.

11. The heating element of claim 1, further comprising a temperature sensor.

12. The heating element of claim 11, wherein the power to the heating element is controlled to stop applying power to the resistive wire when a temperature detected at the temperature sensor exceeds a shutdown temperature threshold.

13. The heating element of claim 11, wherein the power to the heating element is controlled to maintain a desired temperature at the temperature sensor.

14. The heating element of claim 1, wherein the semi-rigid material is configured as an envelope that defines an opening on a peripheral edge for receiving the resistive wire.

15. The heating element of claim 1, wherein the semi-rigid material and the resistive wire are provided as a unitary structure.

16. The heating element of claim 1, wherein the semi-rigid material does not include an opening on a peripheral edge for receiving the resistive wire.

17. A heating element configured to be installed in a bed, the heating element comprising:
a conductive heating element; and
a connector configured to attach the conductive heating element to a power source, wherein the conductive heating element is configured to generate heat when power from the power source is applied to the conductive heating element.

18. The heating element of claim 17, wherein the conductive heating element is sealed in a semi-rigid material.

19. The heating element of claim 17, wherein the conductive heating element is flat and flexible.

20. The heating element of claim 17, wherein the power to the conductive heating element is controlled to stop applying power to the conductive heating element when a temperature exceeds a shutdown temperature threshold.
